(19) United States
(12) Patent Application Publication
(10) Pub. No.: US 2026/0175133 A1
(43) Pub. Date: Jun. 25, 2026

(54) NON-TRANSITORY COMPUTER READABLE MEDIUM, INFORMATION PROCESSING METHOD, INFORMATION PROCESSING SYSTEM, AND GAME APPARATUS

(71) Applicant: CYGAMES, INC., Tokyo (JP)

(72) Inventors: Shogo Aizawa, Tokyo (JP); Kazuki Shimada, Tokyo (JP); Yuki Tamura, Tokyo (JP); Nobushige Takahashi, Tokyo (JP); Masato Nishi, Tokyo (JP)

(73) Assignee: CYGAMES, INC., Tokyo (JP)

(21) Appl. No.: 19/542,177

(22) Filed: Feb. 17, 2026

Related U.S. Application Data
(63) Continuation of application No. PCT/JP2024/026503, filed on Jul. 24, 2024.

(30) Foreign Application Priority Data
Aug. 21, 2023 (JP) 2023-134146

(51) Int. Cl. A63F 13/69; A63F 13/533; A63F 13/58; A63F 13/825

(52) U.S. Cl. CPC A63F 13/69; A63F 13/533; A63F 13/58; A63F 13/825

(57) ABSTRACT

Provided is a non-transitory computer readable medium storing a program that causes a computer to execute: processing of associating an assist character with a first command; processing of receiving an operation by a player for selecting a command from among the plurality of types of commands and acquiring information corresponding to the command selected by a player; processing of updating a first nurture parameter associated with a nurture target character in a case where information corresponding to the first command is acquired; processing of updating a first assist parameter associated with the assist character according to a predetermined update condition; processing of enabling a second command in a case where the assist character with the first assist parameter that has reached a predetermined value exists; and processing of updating the first nurture parameter in a case where information corresponding to the enabled second command is acquired.

### CROSS REFERENCE TO RELATED APPLICATIONS

This application is a continuation application of International Application No. PCT/JP2024/026503, filed on Jul. 24, 2024, which claims priority to Japanese Patent Application No. 2023-134146, filed on Aug. 21, 2023, the entire contents of which are incorporated by reference herein.

### BACKGROUND ART

### Technical Field

The present invention relates to an information processing program, an information processing method, an information processing system, and a game apparatus.

As described in Patent Document 1, a game is known in which whether or not an event occurs is determined through a lottery, and when an event occurs, whether or not a success occurs is determined through a lottery.

### CITATION LIST

### Patent Literature

Patent Document 1: JP 6392439 B

### SUMMARY OF INVENTION

### Technical Problem

In the game as described above, whether or not an event occurs and whether or not a success occurs are determined through a lottery. Thus, there is a problem in that if luck is a large factor and the game lacks the strategic performance required from players, this may cause a reduction in the player's motivation to play the game.

An object of the present invention is to provide an information processing program, an information processing method, an information processing system, and a game apparatus that can motivate a player to play the game by improving the strategic performance.

### Solution to Problem

To solve the problem described above, an information processing program causes a computer to execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

The information processing program may further causes a computer to execute:
processing of associating the assist character with the first assist parameter that has reached a predetermined value with the second command, wherein
the processing of updating the first nurture parameter in a case where information corresponding to the second command is acquired may include updating the first nurture parameter based on the first nurture parameter and a second assist parameter associated with the assist character.

The second command may be a command for designating a match between the nurture target character and the assist character associated with the second command,
the information processing program may further causes a computer to execute:
processing of determining a winning probability for the nurture target character to win based on the first nurture parameter and the second assist parameter, and
processing of determining whether the nurture target character wins or loses based on the winning probability in a case where information corresponding to the second command is acquired, and
the processing of updating the first nurture parameter in a case where information corresponding to the second command is acquired may include updating the first nurture parameter based on whether the nurture target character wins or loses.

The information processing program may further cause a computer to execute:
processing of associating the assist character with the first assist parameter that has reached a predetermined value with the second command, wherein
the processing of updating the first nurture parameter in a case where information corresponding to the second command is acquired may include updating the first nurture parameter based on a second nurture parameter associated with the nurture target character.

The second command may be a command for designating a match between the nurture target character and the assist character associated with the second command,
the information processing program may further cause a computer to execute:
processing of determining a winning probability for the nurture target character to win based on the second nurture parameter, and
processing of determining whether the nurture target character wins or loses based on the winning probability in a case where information corresponding to the second command is acquired, and
the processing of updating the first nurture parameter in a case where information corresponding to the second command is acquired may include updating the first nurture parameter based on whether the nurture target character wins or loses.

The assist character may be associated with a reward, and
the information processing program may further cause a computer to execute:
processing of giving the reward to the nurture target character in a case where the nurture target character wins against the assist character.

The processing of associating the assist character to the second command may include enabling a plurality of the assist characters with the first assist parameter that has reached the predetermined value to be associated with the second command,
the information processing program may further cause a computer to execute:
processing of determining whether or not a special state occurs in a case where one or more of a predetermined number of the assist characters are associated with the second command, and
at least one of the winning probability or the reward may become more advantageous in a case where the special state has occurred, compared to when the special state has not occurred.

The processing of associating the assist character to the second command may include enabling a plurality of the assist characters with the first assist parameter that has reached the predetermined value to be associated with the second command,
the information processing program may further cause a computer to execute:
processing of determining whether or not a special state occurs in a case where one or more of a predetermined number of the assist characters are associated with the second command, and
an update value of the first nurture parameter may become more advantageous in a case where the special state has occurred, compared to when the special state has not occurred.

The information processing program may further cause a computer to execute:
processing of performing a success determination of the action of the nurture target character corresponding to the first command selected by a player, wherein
the processing of updating the first nurture parameter in a case where information corresponding to the first command is acquired may include updating the first nurture parameter based on a result of the success determination.

In order to solve the problem described above, an information processing method executed by one or more computers includes:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

In order to solve the problems described above, an information processing system includes:
one or more computers, wherein the one or more computers execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

In order to solve the problems described above, a game apparatus includes:
one or more computers, wherein the one or more computers execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

### Effects of Disclosure

According to the present invention, the motivation of the players to play can be improved by improving the strategic performance.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an option setting screen. FIG. 3C is a diagram for describing an example of a profile setting screen.

FIG. 4 is a diagram for describing a rough progression flow of a nurture game.

FIG. 5A is a diagram for describing an example of a scenario initial additional value data. FIG. 5B is a diagram for describing an example of a scenario initial upper limit value data. FIG. 5C is a diagram for describing an example of a scenario event additional value data.

FIG. 6A is a diagram for describing a nurture target character selection screen. FIG. 6B is a first diagram for describing a character detail screen. FIG. 6C is a second diagram for describing the character detail screen.

FIG. 7A is a diagram for describing an ability parameter (initial value) table. FIG. 7B is a diagram for describing an aptitude parameter (initial value) table.

FIG. 7C is a diagram for describing skills. FIG. 7D is a diagram for describing exclusive events.

FIG. 8 is a diagram for describing a character strengthening screen.

FIG. 9A is a first diagram for describing an inheritance character selection screen. FIG. 9B is a first diagram for describing a nurtured character list screen.

FIG. 9C is a second diagram for describing the inheritance character selection screen. FIG. 9D is a third diagram for describing the inheritance character selection screen.

FIG. 10 is a diagram for describing an inheritance system.

FIG. 11 is a diagram for describing factor information.

FIG. 12A is a diagram for describing an effectiveness of a basic ability factor. FIG. 12B is a diagram for describing an effectiveness of a character factor.

FIG. 13A is a diagram for describing a determination target for compatibility, and FIG. 13B is a diagram for describing a determination item for compatibility.

FIG. 14A is a first diagram for describing a support card organization screen. FIG. 14B is a diagram for describing a support card selection screen. FIG. 14C is a second diagram for describing the support card organization screen.

FIG. 15A is a diagram for describing a support card table. FIG. 15B is a diagram for describing support effects. FIG. 15C is a diagram for describing base skills. FIG. 15D is a diagram for describing support events.

FIG. 16A is a diagram for describing a final confirmation screen. FIG. 16B is a diagram for describing a preset selection screen.

FIG. 17A is a diagram for describing the types of characters. FIG. 17B is a diagram for describing member IDs.

FIG. 18 is a diagram for describing selection items in each turn.

FIG. 19 is a diagram for describing a top screen.

FIG. 20 is a first diagram for describing a training screen.

FIG. 21A is a second diagram for describing the training screen. FIG. 21B is a third diagram for describing the training screen. FIG. 21C is a diagram for describing a training result notification screen. FIG. 21D is a diagram for describing an event screen.

FIG. 22 is a diagram for describing an SS match information dialog.

FIG. 23 is a diagram for describing a team member dialog.

FIG. 24 is a fourth diagram for describing the training screen.

FIG. 25 is a diagram for describing an SS match provisional selection screen.

FIG. 26A is a diagram for describing a calculation formula for winning probability. FIG. 26B is a diagram for describing an energy addition value.

FIG. 27A is a first diagram for describing a race selection screen. FIG. 27B is a diagram for describing a race start screen. FIG. 27C is a first diagram for describing a race result screen. FIG. 27D is a second diagram for describing the race result screen.

FIG. 28 is a diagram for describing challenges faced in interleague representative races and special races.

FIG. 29 is a diagram for describing overseas aptitude.

FIG. 30 is a diagram for describing an overseas aptitude acquisition screen.

FIG. 31 is a diagram for describing an acquisition condition list dialog.

FIG. 32 is a diagram for describing an effect list dialog.

FIG. 33 is a diagram for describing a rough flow of turn-start processing.

FIG. 34 is a diagram for describing the arrangement ratio for training items.

FIG. 35 is a diagram for describing an SSS match activation lottery.

FIG. 36 is a diagram for describing training levels.

FIG. 37A is a diagram for describing a fixed increase value (speed). FIG. 37B is a diagram for describing a fixed increase value table (power).

FIG. 38A is a diagram for describing a nurture completion screen. FIG. 38B is a second diagram for describing the nurture completion screen. FIG. 38C is a third diagram for describing the nurture completion screen.

FIG. 39 is a diagram for describing a configuration of a memory in the player terminal and a function as a computer.

FIG. 40 is a diagram for describing a configuration of a memory in the server and a function as a computer.

FIG. 41 is a sequence diagram for describing processing of the player terminal and the server related to the nurture game.

FIG. 42 is a flowchart for describing preparation stage processing in the player terminal.

FIG. 43 is a flowchart for describing preparation stage processing in the server.

FIG. 44 is a flowchart for describing nurture stage processing in the server.

FIG. 45 is a flowchart for describing turn-start processing in the server.

FIG. 46 is a flowchart for describing SS match information determination processing in the server.

FIG. 47 is a flowchart for describing SSS match activation lottery processing in the server.

FIG. 48 is a flowchart for describing nurture stage processing in the player terminal.

FIG. 49 is a flowchart for describing overseas aptitude-related processing in the player terminal.

FIG. 50 is a flowchart for describing selection command reception processing in the server.

FIG. 51 is a flowchart for describing race execution processing in the server.

FIG. 52 is a flowchart for describing result information reception processing in the player terminal.

FIG. 53 is a flowchart for describing nurture game end processing in the server.

### DESCRIPTION OF EMBODIMENTS

Hereinafter, an aspect of an embodiment of the present invention will be described in detail with reference to the accompanying drawings. Numerical values and the like indicated in the embodiment are merely examples for facilitating understanding, and do not limit the present invention unless otherwise specified. In this description and the drawings, elements having substantially the same function and configuration are denoted by the same reference numerals, and redundant description thereof will be omitted, and elements not directly relating to the present invention will not be illustrated.

### Overall Configuration of Information Processing System S

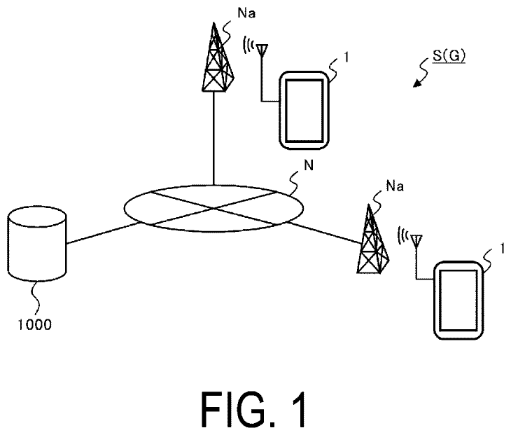

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various types of information for each player who plays the game. In addition, the server 1000 mainly performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 1000.

### Hardware Configuration of Player Terminal 1 and Server 1000

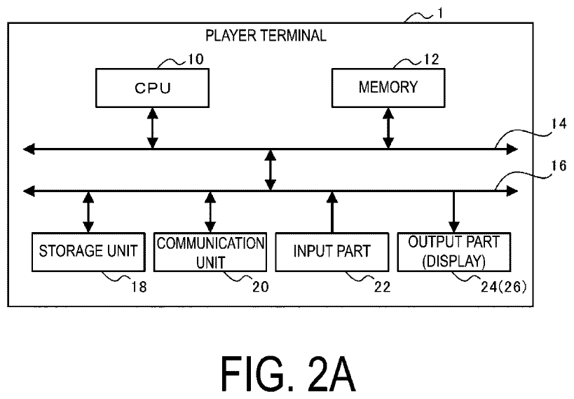

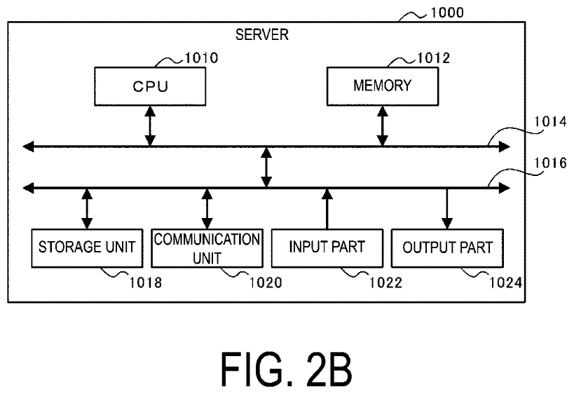

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting operations (receiving operations) of the player. Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 widely includes apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Details of Game

Next, a game provided by the information processing system S and the game apparatus G of the present embodiment will be described. The player can possess a game medium obtained through a lottery called a gacha or a game medium distributed by the game operator. In the present embodiment, the player can possess a character card and a support card as the game media. One character is always associated with each of the character card and the support card. Note that the character associated with the character card is a nurture target in a nurture game. Hereinafter, a character associated with a character card may be referred to simply as a character.

As will be described in detail below, in the game according to the present embodiment, a nurture game is provided. The player can nurture a character in the nurture game to produce a nurtured character in association with various parameters. In addition, the nurture game according to the present embodiment has a game property of nurturing a character associated with the character card while making the character participate in a race simulating horse racing.

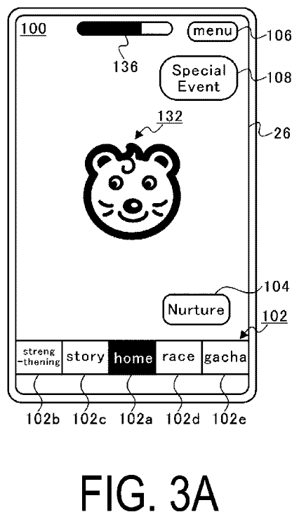

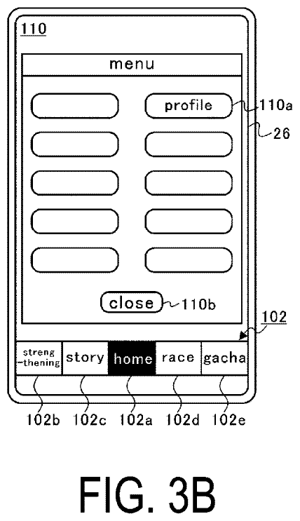

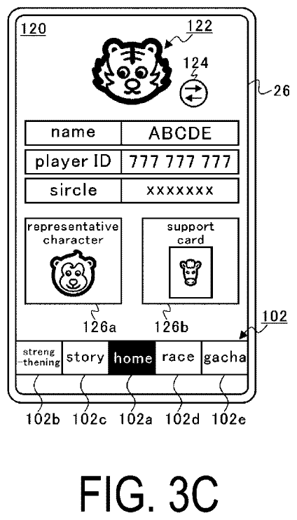

FIG. 3A is a diagram for describing an example of a home screen 100. When the game application is launched on the player terminal 1, the home screen 100 is displayed on the display 26. A menu bar 102 is displayed at a lower portion on the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the display 26 can be distinguished.

When the home screen selection operation portion 102a is tapped, the home screen 100 illustrated in FIG. 3A is displayed on the display 26.

When the strengthening screen selection operation portion 102b is tapped, a strengthening screen (not illustrated) is displayed. On the strengthening screen, it is possible to strengthen the character or the support card possessed by the player. The player can increase the level set for the character or the support card by strengthening the character or the support card. Various parameters are set for the character and the support card, and the parameter is increased as the level is increased. Increasing the parameters for the character and the support card enables the player to nurture the character with stronger stats in the nurture game.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in the nurture game described below can be made to enter. On the racing game selection screen, the player can select a racing game in which the nurtured character is made to enter. An example of a racing game is a team competition game in which a team formed by a plurality of nurtured characters and a team of other players selected by a computer compete against each other. The team competition game has a game property of competing with other players for ranking.

When the gacha screen selection operation portion 102e is tapped, a gacha screen (not illustrated) is displayed. On the gacha screen, the player can play a so-called gacha lottery by spending in-game currency or a ticket. In the gacha lottery, the character card or the support card can be obtained.

In addition, on the home screen 100, a nurture game operation portion 104 is provided above the menu bar 102. When the nurture game operation portion 104 is tapped, a nurture game screen is displayed, and a nurture game described below is started. The nurture game is roughly divided into a preparation stage and a nurture stage. First, in the preparation stage, the player selects and sets one character from among characters possessed by the player as a character to be nurtured (hereinafter referred to as a nurture target character).

Further, in the preparation stage, the player sets a deck to be used when nurturing the nurture target character. The deck is formed of a plurality of inheritance characters, which will be described in detail below, and a plurality of support cards. Thus, in the nurture game, the inheritance characters and the support cards forming the deck are used.

When the settings for the nurture target character and the deck (the inheritance characters and the support cards) are completed, the processing transitions from the preparation stage to the nurture stage, and the game for nurturing the nurture target character is started. In the nurture game, parameters for the nurture target character can be changed. The player can possess the character nurtured in the nurture game as a nurtured character. As described above, the player can form a team of nurtured characters possessed by the player and use the nurtured characters in a team competition game or the like.

As described above, the main goal of the game according to the present embodiment is to produce nurtured characters via the nurture game and to increase the ranking in the team competition game using the nurtured characters.

In addition, in the present embodiment, a function for sharing a nurtured character or a support card among players and a function for sharing information among a plurality of players are provided. The player can set a nurtured character and a support card that can be used by another player in the nurture game. To be specific, as illustrated in FIG. 3A, a settings operation portion 106 is provided in an upper right portion on the home screen 100. When the settings operation portion 106 is tapped, an option setting screen 110 is displayed.

FIG. 3B is a diagram for describing an example of the option setting screen 110. The option setting screen 110 is a screen on which various types of information can be confirmed and set. The option setting screen 110 is provided with a plurality of operation portions, and when an operation portion is tapped, information corresponding to the operation portion can be confirmed and set.

The operation portions of the option setting screen 110 include a profile setting operation portion 110a and a close operation portion 110b. When the close operation portion 110b is tapped, the option setting screen 110 is closed and the home screen 100 is displayed. When the profile setting operation portion 110a is tapped, a profile setting screen 120 is displayed.

FIG. 3C is a diagram for describing an example of the profile setting screen 120. On the profile setting screen 120, the player can confirm and set their own profile information. The profile information includes a profile character, a player name, a player ID, a circle they belong to, a representative character, and a rental card.

The profile character functions as a character that is displayed when the player's information is viewed by another player. For example, the profile character is displayed when using a circle function, the circle being a place for sharing information with other players. On the profile setting screen 120, a profile character image 122 that is currently set is displayed. Near the profile character image 122, a change button 124 is provided. When the change button 124 is tapped, a profile character change screen (not illustrated) is displayed. The player can change the profile character on the profile character change screen.

The profile setting screen 120 displays the player name set by the player, the player ID given to the player, and the name of the circle the player belongs to. The profile setting screen 120 is provided with a representative character setting operation portion 126a and a rental card setting operation portion 126b.

When the representative character setting operation portion 126a is tapped, a representative character setting screen (not illustrated) is displayed. The player can set any one of the nurtured characters nurtured by the player as a representative character on the representative character setting screen. In the representative character setting operation portion 126a, an icon image indicating the currently set representative character is displayed. As will be described in detail below, the representative character can be used for forming a deck as an inheritance character in the nurture game played by another player.

When the rental card setting operation portion 126b is tapped, a rental card setting screen (not illustrated) is displayed. The player can set any one of the support cards possessed by the player as a rental card on the rental card setting screen. In the rental card setting operation portion 126b, an icon image indicating the currently set rental card is displayed. As described above, a support card set as a rental card can be used for forming a deck by another player and is used in the nurture game played by another player.

Although not described in detail, when the setting of the profile information is changed on the profile setting screen 120, setting change information is transmitted to the server 1000. In the server 1000, profile information is saved for each player.

In addition, in the present embodiment, various limited-time events are held irregularly. A special event icon 108 is displayed on the home screen 100 during the active period of the special event which is a limited-time event. When the special event icon 108 is tapped, a special event screen is displayed. On the special event screen, for example, the player can exchange special event points provided only in the special event with various rewards.

When the nurture game operation portion 104 is tapped on the home screen 100, a nurture game screen is displayed and the nurture game is started. The player can play the nurture game by spending game points. The game points are given to the player at a rate of a predetermined value (for example, +1) every predetermined period of time (for example, 10 minutes). An upper limit value (for example, 100) is defined for the game points that can be possessed by the player, and the player can possess game points within the range of the upper limit value. A game point display bar 136 is provided in an upper portion on the home screen 100, and a ratio of the currently possessed game points to the upper limit value is visually displayed.

The game points are subtracted by a predetermined value (for example, −30) at a time when the nurture game is started. Thus, when the player does not possess the required game points, the player cannot start the nurture game. However, the player can possess an item for recovering game points and can recover game points using the item. For example, this item can be given as a reward in the nurture game or the team competition game or can be obtained by spending in-game currency. Hereinafter, the nurture game will be described in detail.

### Nurture Game

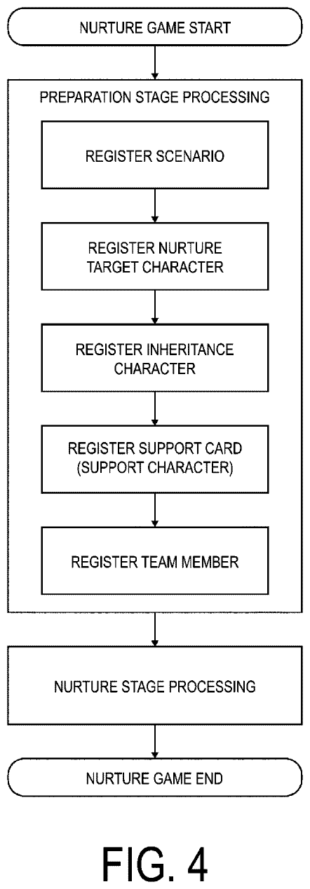

FIG. 4 is a diagram for describing a rough flow of the nurture game. The nurture game is roughly divided into a setting game and a nurture main game. As will be described in detail below, the nurture main game is a game in which one character selected from among the characters possessed by the player is nurtured as a character to be nurtured (hereinafter, referred to as a nurture target character).

In addition, the setting game is a game in which the player registers the nurture target character and a deck (inheritance characters and support cards), with this corresponding to the preparation stage of the nurture game. Hereinafter, the processing executed in the setting game is referred to as preparation stage processing, and the processing executed in the nurture main game is referred to as nurture stage processing. Here, in order to facilitate understanding, a rough flow of the preparation stage processing and the nurture stage processing will be described first.

As illustrated in FIG. 4, in the preparation stage processing, registration of a scenario, registration of a nurture target character, registration of an inheritance character, registration of a support card, and registration of a team member are sequentially performed. Note that the orders of the registrations and setting processing operations described above are merely examples. Therefore, the orders of the registrations and setting processing operations described above can be changed as appropriate.

### Preparation Stage Processing

In the preparation stage processing, registration of a scenario, registration of a nurture target character, and registration of a deck (inheritance characters and support cards) are mainly performed. Note that the support cards are for assisting the nurturing of the nurture target character. One character is always associated with each support card, and the character associated with the support card registered in the preparation stage processing assists the nurturing of the nurture target character. Hereinafter, a character associated with a support card is referred to as a support character.

### Registration of Scenario

When the player taps the nurture game operation portion 104 on the home screen 100, a scenario selection screen (not illustrated) is displayed. In the present embodiment, a plurality of scenarios of the nurture main game are provided. In each scenario of the nurture main game, a final goal, a goal for during the game, and the like are set. The player needs to sequentially clear the goals set in the respective scenarios. The goal, a time period until the goal is achieved, a difficulty of a game, and the like are different for each scenario.

Each scenario is provided with a scenario ID, and here, the scenario ID selected by the player is registered. When a nurture target character described below is selected, a character ID provided for each character is registered. The scenario includes a scenario (here, an existing scenario) in which a different target is set for each type of nurture target character and a scenario (here, a new scenario) in which a common target is set for all nurture target characters.

In the existing scenario, a target is set at the start of the nurture game based on the registered scenario ID and character ID. On the other hand, in the new scenario, the target is set based on the registered scenario ID. In the new scenario, since the character ID is not designated when the target of the nurture game is set, a common target is set regardless of the type of the nurture target character.

The nurture main game is story-like narrative, and the game progresses along a story. In addition, during the nurture main game, events occur at various timings. Events occurring during the nurture main game include a scenario-specific event. Therefore, the plurality of scenarios are different from each other in at least some of the events occurring during the nurture main game. The player can select any one of the plurality of scenarios on the scenario selection screen.

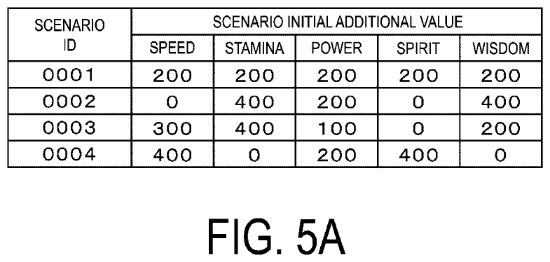

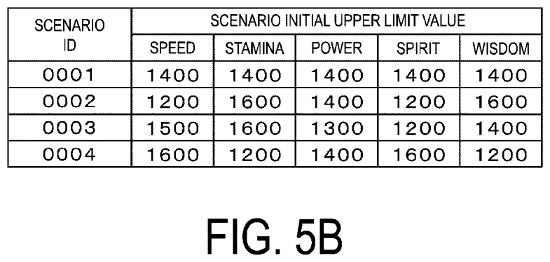

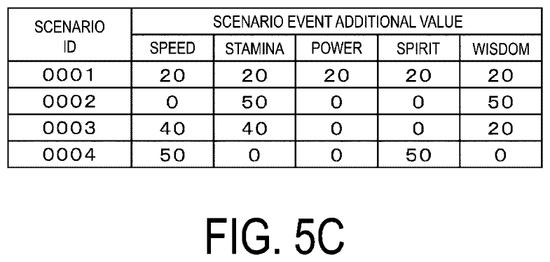

FIG. 5A is a diagram for describing an example of a scenario initial additional value data. FIG. 5B is a diagram for describing an example of a scenario initial upper limit value data. FIG. 5C is a diagram for describing an example of a scenario event additional value data. As illustrated in FIG. 5A, each scenario is associated with a unique scenario ID. When the player selects a scenario on the scenario selection screen, a scenario ID associated with the selected scenario is registered. Here, four scenario IDs of 0001 to 0004 are provided.

As will be described in detail below, the goals of the nurture game include increasing an ability parameter for the nurture target character. Here, five ability parameters are provided, namely speed, stamina, power, spirit, and wisdom. The greater values of these five ability parameters, the more advantageous a race development of the nurture target character.

However, an upper limit value is set for each ability parameter, and in the nurture main game, the value of each ability parameter is updated only within a range up to the upper limit value, and update of the ability parameter is restricted not to exceed the upper limit value. Upon starting of the nurture main game, an initial upper limit value of each ability parameter is set. The initial upper limit value is different for each scenario. Note that the upper limit value of each ability parameter may be increased from the initial upper limit value during the game.

The scenario initial additional value data is stored in the player terminal 1 and the server 1000. The scenario initial additional value data is data in which an initial additional value of each of five ability parameters is associated with the scenario ID. In the present embodiment, upon starting of the nurture main game, the initial upper limit value of each ability parameter is set based on the scenario initial additional value data.

Specifically, a common base value is set in advance for each ability parameter. In the present embodiment, the common base value is set to “1200”. This common base value is common for all scenarios and all ability parameters. However, the common base value may be different for each scenario or may be different for each ability parameter. Then, upon starting of the nurture main game, the scenario initial additional value corresponding to the scenario selected by the player is added to the common base value, and the initial upper limit value of each ability parameter is set.

For example, as illustrated in FIG. 5A, according to the scenario initial additional value data, the scenario initial additional values of five ability parameters associated with the scenario ID of “0001” are all set to “200”. Therefore, in a case where the scenario ID “0001” is selected and the nurture main game is started, the initial upper limit values of five ability parameters are all “1400”.

Further, for example, in a case where the scenario ID “0002” is selected and the nurture main game is started, the initial upper limit values of the ability parameters of speed and spirit are “1200” which is the common base value, the initial upper limit values of the ability parameters of stamina and wisdom are “1600”, and the initial upper limit value of the ability parameter of power is “1400”.

Note that here, the initial upper limit value is derived by adding the initial additional value of the ability parameter to the common base value. However, as illustrated in FIG. 5B, the scenario initial upper limit value data may be provided, and the initial upper limit value of each ability parameter may be derived based on the scenario initial upper limit value data. According to the scenario initial upper limit value data, the initial upper limit value of each of five ability parameters is associated with the scenario ID. In the scenario initial upper limit value data, the value of the initial upper limit value associated with each scenario ID is a value obtained by adding the initial additional value of the scenario initial additional value data to the common base value.

In this way, the scenario initial upper limit value associated with the scenario ID may be set as the initial upper limit value of each ability parameter. Alternatively, a value obtained by adding the scenario initial additional value to the common base value may be set as the initial upper limit value of each ability parameter.

In the nurture main game, a scenario event in which the upper limit value of each ability parameter is increased may occur at a predetermined timing. When the scenario event occurs, a scenario event additional value associated with the scenario event is added to the upper limit value at that time. For example, in the nurture main game of the scenario ID “0001”, when a predetermined scenario event occurs, the respective upper limit values of five ability parameters are increased by “20”.

As illustrated in FIG. 5C, the upper limit value of the ability parameter increased due to the scenario event differs for each scenario. Note that a plurality of scenario events in which the upper limit value of the ability parameter is increased may be provided for one scenario, or no scenario event may be provided. The timing of occurrence of a scenario event may be common to all scenarios or may be different from one scenario to another.

In this manner, the upper limit value of the ability parameter differs depending on the scenario selected by the player. As a result, the characters can be nurtured that have different abilities and characteristics for each scenario. This increases the motivation of the player to play the game in various scenarios.

### Registration of Nurture Target Character

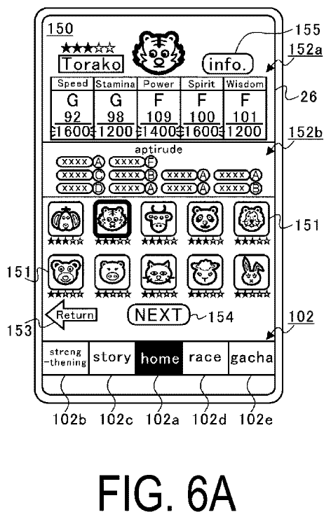

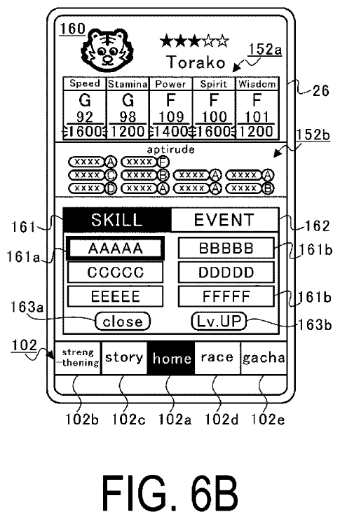

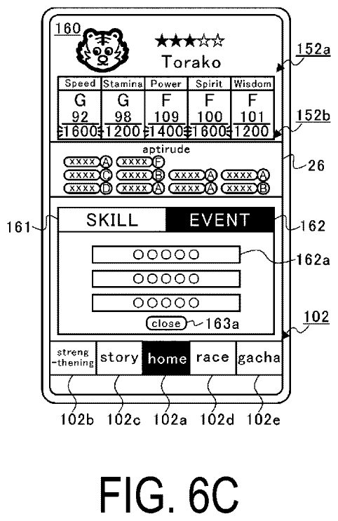

FIG. 6A is a diagram for describing a nurture target character selection screen 150. When the player selects a scenario on the scenario selection screen, the nurture target character selection screen 150 illustrated in FIG. 6A is displayed. At a central portion on the nurture target character selection screen 150, a plurality of character icons 151 are displayed and a list of characters possessed by the player is displayed.

In addition, an ability parameter display portion 152a and an aptitude parameter display portion 152b are displayed in an upper portion on the nurture target character selection screen 150. In addition, a return operation portion 153 and a next operation portion 154 are displayed in a lower portion on the nurture target character selection screen 150.

In the present embodiment, initial values of the ability parameters are set for each character. The initial values of the ability parameters for the character corresponding to the character icon 151 selected by the player are displayed in numerical values in the ability parameter display portion 152a. In the present embodiment, the larger the numerical value of the ability parameter is, the higher the ability is.

In the ability parameter display portion 152a, the initial upper limit values of the respective ability parameters are also displayed. In other words, the upper limit values of the respective ability parameters set upon starting of the nurture main game are displayed in the ability parameter display portion 152a in a state where the player can select a scenario or after the player selects a scenario. In the ability parameter display portion 152a, each of the initial upper limit values corresponding to the scenario selected by the player is displayed in the denominator, and each of the initial values of the ability parameters for the character selected by the player is displayed in the numerator.

Here, in the ability parameter display portion 152a, the initial upper limit values exceeding the common base value are displayed to be distinguished. For example, in the example illustrated in FIG. 6A, the initial upper limit values of the speed, the power, and the spirit exceed “1200” which is the common base value. Therefore, in the ability parameter display portion 152a, the initial upper limit values of the speed, the power, and the spirit are displayed to be distinguished relative to the initial upper limit values of the stamina and the wisdom. Here, in the displaying to be distinguished, the initial upper limit value exceeding the common base value is displayed in a blinking manner or displayed in a different color.

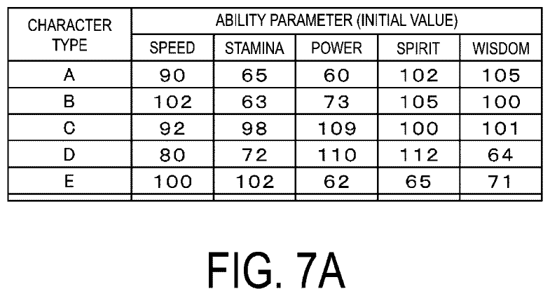

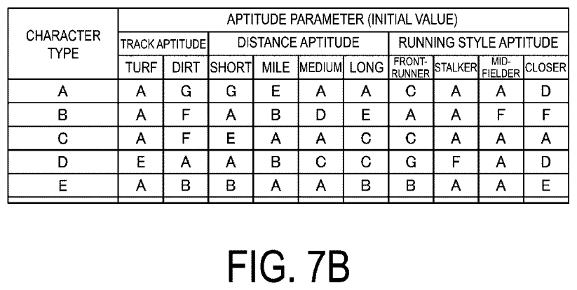

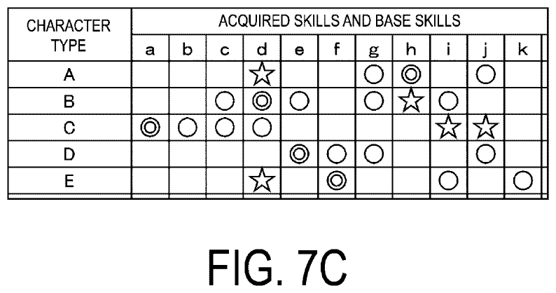

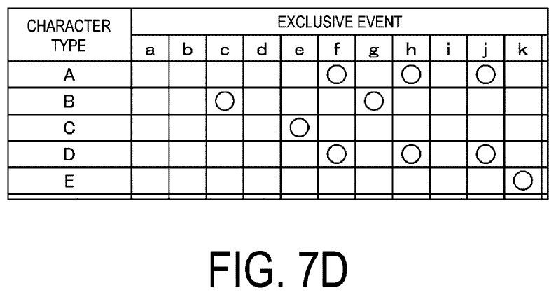

FIG. 7A is a diagram for describing an ability parameter (initial value) table. In the present embodiment, as illustrated in FIG. 7A, the initial values of ability parameters for each character are stored in the ability parameter (initial value) table. Then, based on the initial values of the ability parameters stored in the ability parameter (initial value) table, the initial values of the ability parameters are displayed in the ability parameter display portion 152a.

In the present embodiment, an initial value of an ability parameter is set for each one of a plurality of types of abilities for each character. To be more specific, an ability parameter of speed denoted by “Speed” in the ability parameter display portion 152a, an ability parameter of stamina denoted by “Stamina” in the ability parameter display portion 152a, an ability parameter of power denoted by “Power” in the ability parameter display portion 152a, an ability parameter of spirit denoted by “Spirit” in the ability parameter display portion 152a, and an ability parameter of wisdom denoted by “Wisdom” in the ability parameter display portion 152a are provided as the ability parameters.

Note that the initial value of the ability parameter for each character is increased by strengthening the character (character card). For example, each character is provided with five stages of stats levels, and the player can increase the stats level of the character by spending in-game currency and predetermined items. As the stats level of the character increases, the initial value of the ability parameter for the character increases.

In FIG. 7A, the initial values when the character is at a predetermined level is illustrated. Note that the player can increase the value of the ability parameters in the nurture main game. That is, the goal of the nurture main game is to nurture a character to have higher numerical values for the ability parameters.

In the present embodiment, an aptitude parameter (initial value) is set for each character. As illustrated in FIG. 6A, the initial values of the aptitude parameters for the character corresponding to the character icon 151 selected by the player are displayed in alphabetical letters in the aptitude parameter display portion 152b.

FIG. 7B is a diagram for describing an aptitude parameter (initial value) table. In the present embodiment, as illustrated in FIG. 7B, the initial values of the aptitude parameters for each character are stored in the aptitude parameter (initial value) table. The initial values of the aptitude parameters are set to any one of seven stages of alphabetical letters A to G. For the initial values of the aptitude parameters, A indicates the highest aptitude and G indicates the lowest aptitude. Based on the initial values of the aptitude parameters stored in the aptitude parameter (initial value) table, the initial values of the aptitude parameters are displayed in the aptitude parameter display portion 152b.

In the present embodiment, an initial value of the aptitude parameter is set for each one of a plurality of types of aptitude for each character. Specifically, the aptitude parameters include aptitude parameters related to track aptitude for turf and dirt; aptitude parameters related to distance aptitude for short distance, mile, medium distance, and long distance; and aptitude parameters related to running style aptitude for front-runner, stalker, midfielder, and closer.

In the nurture game, the player can make the nurture target character enter various races. At this time, if the aptitude of the nurture target character that matches the race content is high, the nurture target character will be more advantageous in the developments of the race.

The initial values of the aptitude parameters for each character may be increased by spending in-game currency. Further, the values of the aptitude parameters may change in the nurture main game. Further, in the nurture main game, the aptitude parameter may be set to S, which is a higher aptitude than A.

FIG. 6B is a first diagram for describing a character detail screen 160. FIG. 6C is a second diagram for describing the character detail screen 160. When the character icon 151 on the nurture target character selection screen 150 is tapped and held, the character detail screen 160 is displayed on the display 26. On the character detail screen 160, the details of the abilities of the character corresponding to the character icon 151 which was tapped and held on the nurture target character selection screen 150 are displayed.

A skill operation portion 161 and an event operation portion 162 are displayed at a central portion on the character detail screen 160. As illustrated in FIG. 6B, when the character detail screen 160 is first displayed, the skill operation portion 161 is highlighted, and the skills provided for each character are displayed. A skill is an ability that may be activated when a predetermined condition is met while executing a race and a team race as described below. Activating the skills gives each character an advantage in the development of the race.

FIG. 7C is a diagram for describing the skills. As illustrated in FIG. 7C, each character has a plurality of skills. As illustrated in FIG. 6B, the skills possessed by the character (hereinafter referred to as base skills) are displayed on the character detail screen 160. In the nurture main game, the base skill for the nurture target character can be acquired by satisfying a predetermined condition. Note that a skill just only being possessed is not activated during the race, but first becomes possible to be activated by acquiring the base skill. Hereinafter, a skill in a state in which the character can activate the skill, that is, the skill acquired by the character, is referred to as an acquired skill.

One acquired skill is set for the character from the beginning of the nurture main game. In addition to the acquired skill, a plurality of base skills are set for the character. The base skill can be acquired by spending skill points described below after starting of the nurture main game. That is, a base skill can become an acquired skill in exchange for skill points.

In the present embodiment, a skill corresponding to “⊚” illustrated in FIG. 7C is displayed as an acquired skill on the character detail screen 160 in FIG. 6B. Further, a skill corresponding to “◯” illustrated in FIG. 7C is displayed as a base skill on the character detail screen 160 in FIG. 6B. In the present embodiment, as illustrated in the character detail screen 160 in FIG. 6B, the acquired skill is highlighted so that the acquired skill and the base skill can be easily distinguished from each other.

Specifically, on the character detail screen 160 in FIG. 6B, one acquired skill is displayed in an acquired skill display field 161a and seven base skills are displayed in a base skill display field 161b. Note that the number of acquired skills and the number of base skills may be different for each character. Further, for example, the number of acquired skills or base skills for each character may be increased as the level of the character is increased, in-game currency or items are spent, and the like.

Here, the base skill includes an awakening skill. The awakening skill is a skill that becomes a base skill when an unlock condition is satisfied. That is, an awakening skill with an unsatisfied unlock condition is not a base skill. Thus, the awakening skill with an unsatisfied unlock condition cannot be obtained in the nurture main game.

In FIG. 7C, the awakening skill is indicated by a star mark. Here, four awakening skills are set for each character. However, the number of awakening skills may be different for each character. Note that the awakening skill is different for each character. For example, a skill “d” in the figure is set as an awakening skill for a character “A”, as an acquired skill for a character “B”, and as a normal base skill for a character “C”. In this way, the skills include those set differently depending on the character, such as an acquired skill, a base skill, and an awakening skill.

In the present embodiment, an awakening level of the character is set as the unlock condition for the awakening skill. The character (character card) is associated with the stats level and the awakening level described above. The player can individually increase the stats level and the awakening level. As illustrated in FIG. 6B, a close operation portion 163a and a strengthening operation portion 163b are provided on the character detail screen 160. When the strengthening operation portion 163b is tapped, a character strengthening screen 165 is displayed on the display 26.

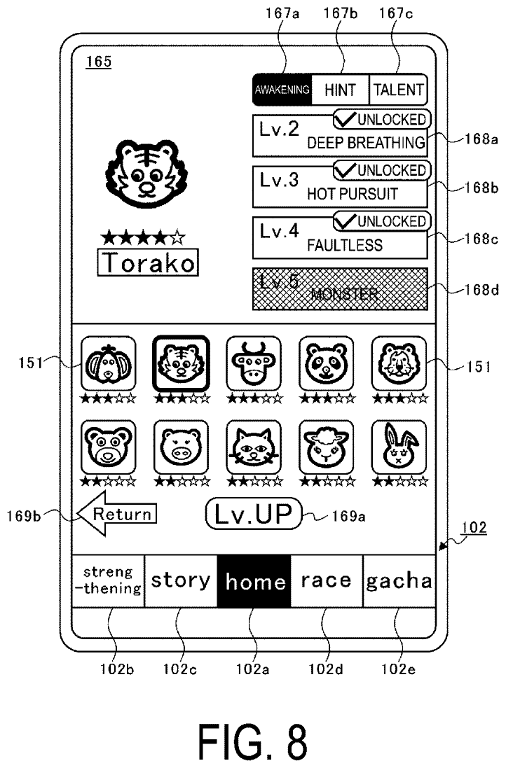

FIG. 8 is a diagram for describing the character strengthening screen 165. The character strengthening screen 165 is displayed when the strengthening operation portion 163b on the character detail screen 160 is tapped and when the strengthening screen selection operation portion 102b is tapped. Character icons 151 corresponding to the base characters are displayed at a center portion to a lower portion on the character strengthening screen 165. When any of the character icons 151 is tapped by the player, the character corresponding to the tapped character icon 151 is put in a selected state.

Note that when the strengthening operation portion 163b on the character detail screen 160 is tapped and the character strengthening screen 165 is displayed, the character in the selected state on the character detail screen 160 is also in the selected state at the time when the character strengthening screen 165 starts to be displayed. Information relating to the character in the selected state is displayed in an upper portion on the character strengthening screen 165.

To be more specific, the character strengthening screen 165 is provided with an awakening tab 167a, a hint tab 167b, and a stats tab 167c. When the awakening tab 167a is tapped, awakening skill display fields 168a, 168b, 168c, and 168d are displayed. Note that when the character strengthening screen 165 starts to be displayed, the awakening tab 167a is selected, and the awakening skill display fields 168a, 168b, 168c, and 168d are displayed. The awakening skill display fields 168a, 168b, 168c, and 168d are denoted by names corresponding to their respective awakening levels.

An awakening level strengthening button 169a is provided in a lower portion on the character strengthening screen 165. When the awakening level strengthening button 169a is tapped, a confirmation screen (not illustrated) is displayed. The confirmation screen displays an item required to increase the awakening level and a notification that spending the item increases the awakening level. When a predetermined operation is input on the confirmation screen, the awakening level of the character in the selected state increases.

In the present embodiment, the awakening level is set to level 1 in an initial state of each character. The player can increase the awakening level of the character up to level 5 by spending the item. Each awakening level is associated with one awakening skill. Increasing the awakening level unlocks the awakening skill corresponding to the increased awakening level. Specifically, when the awakening level becomes level 2, the awakening skill corresponding to level 2 is unlocked. Similarly, when the awakening level becomes level 5, the awakening skill corresponding to level 5 is unlocked.

In this way, four awakening skills are set for each character. Then, by increasing the awakening level, the player can unlock the same number of awakening skills as the number of awakening levels increased. The awakening skill once unlocked functions as a base skill that can be acquired.

The awakening skills unlocked when the awakening levels are 2, 3, 4, and 5 are displayed in the awakening skill display fields 168a, 168b, 168c, and 168d, respectively. At this time, the unlocked awakening skill is denoted by “unlocked” in the awakening skill display field 168a, 168b, 168c, or 168d. On the other hand, for an awakening skill not yet unlocked, the awakening skill display fields 168a, 168b, 168c, and 168d are grayed out. FIG. 8 illustrates a state in which three awakening skills with the awakening levels being level 4 are unlocked.

Note that when the awakening skill display fields 168a, 168b, 168c, and 168d are tapped and held, detailed information such as the content of each awakening skill is displayed although a detailed description is omitted. When the hint tab 167b is tapped, a hint level strengthening screen (not illustrated) is displayed. In the hint level strengthening screen, the hint level of the base skill described below can be increased by spending the item.

When the stats tab 167c is tapped, a stats level strengthening screen (not illustrated) is displayed. In the stats level strengthening screen, the stats level of the character can be increased by spending the item. The character strengthening screen 165 is provided with a return operation portion 169b. When the return operation portion 169b is tapped, the character strengthening screen 165 is closed, and the character detail screen 160 is displayed.

When the player taps the event operation portion 162 on the character detail screen 160, the content of the character detail screen 160 is switched as illustrated in FIG. 6C, and an exclusive event display field 162a indicating an exclusive event provided for each character is displayed. The exclusive event is generated when a predetermined condition is met in the nurture main game. When the exclusive event is generated, the story image related to the character appearing in the nurture game is displayed or the value of the ability parameter is changed.

FIG. 7D is a diagram for describing the exclusive events. As illustrated in FIG. 7D, each character is associated with a plurality of exclusive events. As illustrated in FIG. 6C, the exclusive events associated with the character are displayed on the character detail screen 160. Note that the exclusive events may include a hint event to enable a skill to be possessed or acquired, an ability event to increase or decrease a numerical value of an ability parameter for a character, and the like.

All of the exclusive events displayed in the character detail screen 160 illustrated in FIG. 6C may be executed during running the nurture main game, at least some thereof may be executed during running the nurture main game, or none thereof may be executed during running the nurture main game when a predetermined condition is not met. Also, for example, the number of exclusive events provided for each character may be increased due to an increase in the level of the character, spending of in-game currency or items, and the like. In addition, when a predetermined condition is met, an exclusive event that is not being displayed as the exclusive event may be executed during the nurture main game.

As illustrated in FIGS. 6B and 6C, a close operation portion 163a denoted by “close” is displayed in a lower portion on the character detail screen 160. When the close operation portion 163a on the character detail screen 160 is tapped, the display of the character detail screen 160 ends, and the nurture target character selection screen 150 is displayed on the display 26.

When the return operation portion 153 is tapped on the nurture target character selection screen 150 illustrated in FIG. 6A, the home screen 100 illustrated in FIG. 3A is displayed on the display 26. The nurture target character selection screen 150 is provided with a nurture information display button 155. When the nurture information display button 155 is tapped, a nurture information display screen (not illustrated) is displayed. The player can confirm the information related to the character selected on the nurture target character selection screen 150 on the nurture information display screen.

The goal of the nurture game is to produce a stronger nurtured character by nurturing a character selected as the nurture target character that is a character to be nurtured from among characters possessed by the player. As will be described in detail below, the nurture main game includes a plurality of turns, and the player needs to make the nurture target character train or participate in a race for each turn.

A plurality of clear goals are set for each character. The clear goals set for the selected character can be confirmed on the nurture information display screen. A race in which the nurture target character can be made to enter is predefined for each turn. The clear goal includes making the nurture target character enter a predetermined race in a predetermined turn and acquire a predetermined order of arrival.

Further, making the nurture target character that is a character to be nurtured enter the race allows the nurture target character to obtain fans. In each race, a base obtaining number of fans is defined for each placing, and the higher the placing, the larger number of fans to be obtained. In addition, a difficulty is set for each race, and the higher the difficulty, the larger number of fans can be obtained.

Here, the number of fans that can be obtained by entering the race is calculated by adding a bonus obtaining number to the base obtaining number defined for each placing. Specifically, a correction value is determined based on a race result, and the bonus obtaining number is calculated by multiplying the base obtaining number by the correction value. The total number of the bonus obtaining number and the base obtaining number is the number of fans obtained by the nurture target character. For example, when the race result is the first place, the correction value increases as a difference between the nurture target character and the second place character increases. In addition, when the race result is from the second to fifth place, the correction value increases as the difference between the nurture target character and the first place character decreases.

The nurture target character activates a skill (acquired skill) at a predetermined probability during the race. At this time, as the number of activated skills increases, the correction value increases. As described above, for each race, the condition for adding the number of fans is defined, and the number of fans to be obtained increases depending on various race results other than the placing and the progress of the race. However, the number of fans obtained by the nurture target character is at least equal to or greater than the base obtaining number corresponding to the placing.

For some races, the number of fans may be defined as a race entry condition. When the number of fans obtained by the nurture target character is less than the number of fans defined as the race entry condition, the player cannot make the nurture target character enter the race. The higher the difficulty of a race, the greater the number of fans required to enter the race. Thus, in a case where a race with the number of fans defined as the race entry condition is set as a race that is a target of a clear goal (hereinafter referred to as a target race), the nurture target character needs to obtain the number of fans defined for the target race by the turn in which the target race is run.

The clear goal includes acquiring a predetermined number or more of fans by a predetermined turn. The clear goal includes, for example, getting the first place a predetermined number of times or more in a race with the high difficulty (for example, GI) within a predetermined turn range. In this way, a plurality of clear goals are set for each character. By achieving the clear goal, the player can continue the nurture main game until the final turn. On the other hand, when the clear goal cannot be achieved, the nurture main game ends in the relevant turn.

Thus, if the number of fans defined for the target race is not obtained by the turn in which the target race is run, the nurture target character cannot enter in the target race. In this case, the clear goal is not achieved, and the nurture game ends.

In the nurture main game, since the various parameters for the nurture target character are increased in each turn, the larger the number of turns, the stronger nurtured character can be produced. Therefore, when the nurture main game is played, the parameters for the nurture target character need to be increased so that all the clear goals can be cleared.

Note that basically, the clear goal set for each character is fixed, and the same clear goal is set as a task each time the nurture game is played. However, a character may be included for which a clear goal that varies according to a progress status of the nurture main game is set or for which the player can select a clear goal.

When the nurture game is completed, the nurtured character is produced. At the time of completion of the nurture game, an evaluation score is calculated for the nurtured character and a nurture rank is derived based on the evaluation score. The evaluation score is calculated based on a calculation formula set in advance, such as a score calculated by various parameters for the nurture target character at nurture completion, a score calculated by the acquired skill, or the like. The nurture information display screen displays information indicating the rank, evaluation score, name, and registration date of each of the top three nurtured characters having high evaluation scores among the nurtured characters nurtured based on the selected character.

Note that a plurality of scenarios are provided in the nurture game although detailed description is omitted. The basic game specifications are common to the respective scenarios, but some functions are different for each scenario. The nurture information display screen displays a scenario selected when each nurtured character is nurtured.

As described above, the player can select a nurture target character while checking various types of information of each character on the nurture target character selection screen 150 illustrated in FIG. 6A. When the next operation portion 154 is tapped on the nurture target character selection screen 150, the selected character is set as the nurture target character, and an inheritance character selection screen 170 is displayed on the display 26.

### Registration of Inheritance Character

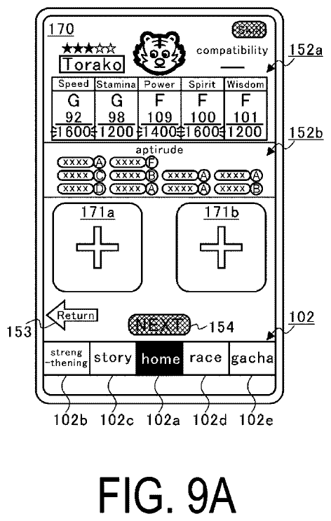

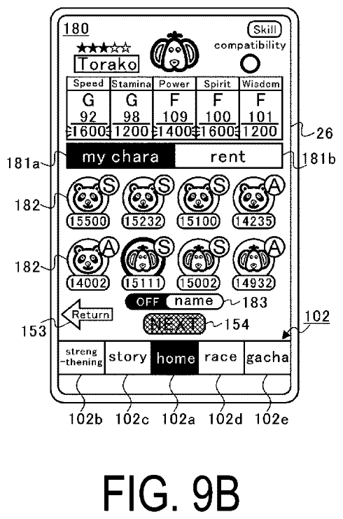

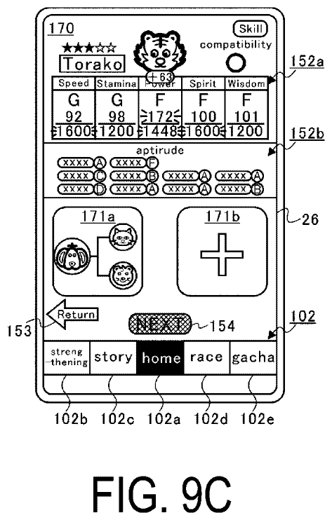

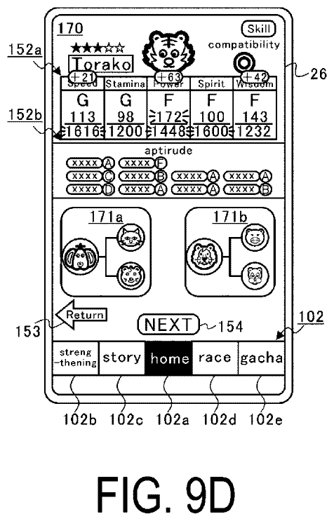

FIG. 9A is a first diagram for describing the inheritance character selection screen 170. FIG. 9B is a first diagram for describing a nurtured character list screen 180. FIG. 9C is a second diagram for describing the inheritance character selection screen 170. FIG. 9D is a third diagram for describing the inheritance character selection screen 170. The inheritance character selection screen 170 is a screen for the player to register an inheritance character.

An inheritance character is a character that causes the nurture target character to inherit an ability value, a skill, or the like. The player can select two inheritance characters from the nurtured characters possessed by the player and representative characters of other players extracted in accordance with a predetermined extraction condition, such as the representative characters of friends such as followers, and use the representative characters to form a deck and register the representative characters. Note that only one representative character of another player can be used as an inheritance character to form a deck in one nurture game.

The inheritance character selection screen 170 is provided with the ability parameter display portion 152a, the aptitude parameter display portion 152b, a first inheritance character selection region 171a, and a second inheritance character selection region 171b. When the screen transitions from the nurture target character selection screen 150 to the inheritance character selection screen 170, the first inheritance character selection region 171a and the second inheritance character selection region 171b are displayed as blank fields as illustrated in FIG. 9A.

When the first inheritance character selection region 171a or the second inheritance character selection region 171b is tapped, the nurtured character list screen 180 illustrated in FIG. 9B is displayed. The nurtured character list screen 180 is provided with a my character tab 181a and a rental tab 181b. Below the my character tab 181a and the rental tab 181b, a nurtured character list display region is provided. A nurtured character icon 182 is displayed in the nurtured character list display region.

In a state where the my character tab 181a is selected, the nurtured character icons 182 corresponding to the nurtured characters possessed by the player are displayed as illustrated in FIG. 9B. Although not illustrated, in a state where the rental tab 181b is selected, the representative character of a friend, that is, the nurtured character icon 182 corresponding to the nurtured character nurtured by a friend is displayed.

Further, when the nurtured character icon 182 is tapped, the nurtured character corresponding to the nurtured character icon 182 is put in a provisionally selected state. When the nurtured character icon 182 is tapped, the inheritance character selection screen 170 is displayed as illustrated in FIG. 9C. At this time, for example, when the first inheritance character selection region 171a is tapped to display the nurtured character list screen 180 and the nurtured character icon 182 is tapped on the nurtured character list screen 180, an image indicating the nurtured character in the provisionally selected state is displayed in the first inheritance character selection region 171a.

In this state, for example, when the second inheritance character selection region 171b is tapped to display the nurtured character list screen 180 and the nurtured character icon 182 is tapped on the nurtured character list screen 180, an image indicating the nurtured character in the provisionally selected state is displayed in the second inheritance character selection region 171b as illustrated in FIG. 9D.

In addition, the nurtured character is stored in association with information related to the inheritance character used in the nurturing. In the first inheritance character selection region 171a, information related to the inheritance character used when nurturing the nurtured character is displayed.

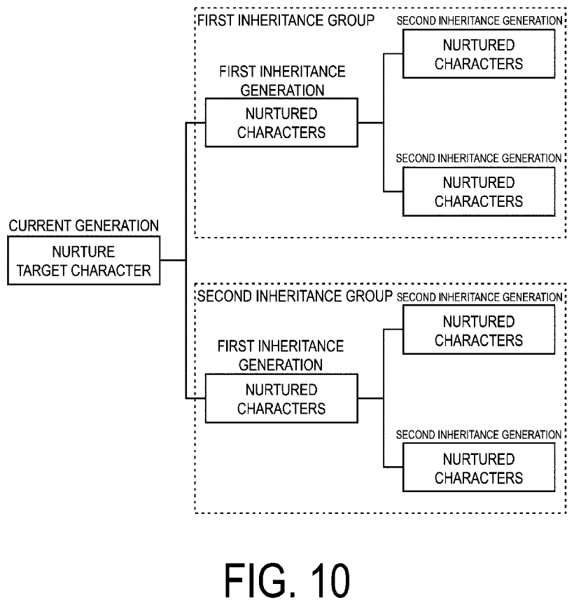

FIG. 10 is a diagram for describing an inheritance system. In the nurture game, various effects such as an increase in the values of an ability parameter and an aptitude parameter for the nurture target character are achieved based on the factor information of the inheritance character. Here, two inheritance characters are set for one nurture target character, and these inheritance characters are the previously produced nurtured characters. Thus, when a nurtured character set as an inheritance character is produced, two inheritance characters are set for the nurtured character.

As illustrated in FIG. 10, the nurture target character that is a character to be nurtured in the nurture main game to be started is set as a current generation. Further, for the nurture target character, two nurtured characters set as inheritance characters are of a first inheritance generation. Further, for each of the nurtured characters of the first inheritance generation, upon starting of the nurturing thereof, two nurtured characters are set as inheritance characters. The two nurtured characters set as inheritance characters when the nurtured character of the first inheritance generation is produced are of a second inheritance generation.

In this case, as illustrated in FIG. 10, the nurtured characters of the first inheritance generation and the second inheritance generation have an effectiveness on the nurture target character of the current generation. As described above, since two inheritance characters (of the first inheritance generation) are set for one nurture target character, a total of six nurtured characters have the effectiveness on one nurture target character.

For example, one of the two nurtured characters of the first inheritance generation and the two nurtured characters of the second inheritance generation that are the inheritance characters of the former nurtured character are included in a first inheritance group. In a similar manner, the other of the two nurtured characters of the first inheritance generation and the two nurtured characters of the second inheritance generation that are inheritance characters of the former nurtured character are included in a second inheritance group.

As illustrated in FIG. 9D, in the first inheritance character selection region 171a, icons are displayed which correspond to one nurtured character of the first inheritance generation and two nurtured characters of the second inheritance generation included in the first inheritance group. In a similar manner, in the second inheritance character selection region 171b, icons are displayed which correspond to one nurtured character of the first inheritance generation and two nurtured characters of the second inheritance generation included in the second inheritance group.

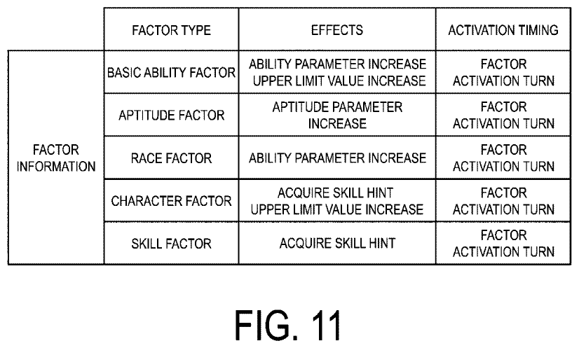

FIG. 11 is a diagram for describing factor information. As will be described in detail below, when the nurture game is completed, the nurture target character is registered as a nurtured character, and at this time, the factor information is stored in association with the nurtured character. Specifically, when the nurturing of the nurtured character is completed, a factor to be obtained by the nurtured character is determined through a lottery or the like. Then, the factor information indicating the determined factor is associated with the nurtured character. In other words, at the completion of the nurture game, the nurtured character can obtain the factor gained through the successful lottery.

However, the factor obtained by the nurtured character does not affect the abilities of the nurtured character themselves. For example, the nurtured character can be made to enter a racing game such as a team competition game. At this time, in the race, a simulation, that is, computational processing of determining the placing and the race developments is performed based on the ability parameters, the aptitude parameters, the acquired skills, and the like of all the nurtured characters running. Since the factor of the nurtured character is not used in the computational processing, even if the nurtured character has a large number of factors, the nurtured character is not given an advantage in the race.

When the nurtured character is set as the inheritance character, the factor of the nurtured character affects only the nurture target character. Factors that can be obtained by the nurtured character are classified into a plurality of types. Basic ability factor, aptitude factor, race factor, character factor, and skill factor as factor types in FIG. 11. Each factor is set to one of a plurality of stages. Here, three stages of factor levels, level 1, level 2, and level 3, are provided as stages for the factor.

The factor level is determined through a lottery. At this time, after the factors to be obtained by the nurtured character are determined, the factor level may be determined through the lottery for each of the obtained factors. Alternatively, a success ratio may be set for each combination pattern of a factor and a factor level, and any combination pattern may be determined based on the set success ratio. In this case, the factor to be obtained and the factor level are determined at the same time.

For factor levels, level 3 has the largest effect and level 1 has the least effect. In the lottery for determining the factor level, the success probability of level 3 is set to be the lowest and the success probability of level 1 is set to be the highest. However, the success probability of the factor to be obtained or the success probability of the factor level may be changed depending on the result of the nurture game. In this case, for example, a higher factor level may be determined for a nurtured character that has a higher ability parameter or evaluation score.

The basic ability factor increases the value of the ability parameter for the nurture target character and the upper limit value of the ability parameter. Five basic ability factors are provided including a speed factor, a stamina factor, a power factor, a spirit factor, and a wisdom factor. The nurtured character always obtains one basic ability factor from among five basic ability factors. The five basic ability factors correspond to five ability parameters of speed, stamina, power, spirit, and wisdom. For example, when the nurtured character of the first inheritance generation or the second inheritance generation has a speed factor, the value and upper limit value of the ability parameter of speed for the nurture target character increase.

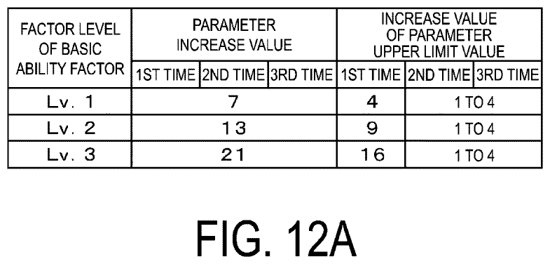

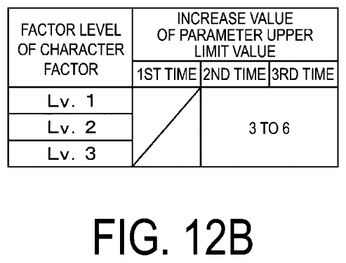

FIG. 12A is a diagram for describing the effectiveness of the basic ability factor. An increase value of each ability parameter and an increase value of the upper limit value vary depending on the factor level of the basic ability factor. For example, when the factor level of the speed factor is level 1, the ability parameter 5 of speed for the nurture target character increases by “7”; when the factor level is level 2, the ability parameter increases by “13”; and when the factor level is level 3, the ability parameter increases by “21”.

Thus, if a total of six nurtured characters including two nurtured characters of the first inheritance generation and four nurtured characters of the second inheritance generation all have the speed factor of level 3, the ability parameter of speed for the nurture target character increases by up to 126 (increase value of 21×6 (characters)).

However, an activation timing and an activation condition are set for each factor. Thus, even if the inheritance character has a factor, if the activation condition is not met at the activation timing, there is no effectiveness on the nurture target character.

As described above, the nurture main game includes a plurality of turns, and of these, a predetermined turn is set as a factor activation turn. For example, assume that three turns, namely the first turn, the 31st turn, and the 55th turn of the nurture main game are set as factor activation turns. In this case, the first turn is the first activation timing, the 31st turn is the second activation timing, and the 55th turn is the third activation timing. In each of the factor activation turns, whether to activate each factor (inheritance character) is determined, and in a case where the factor is determined to be activated, the activation condition of the factor is met, and an effectiveness corresponding to the factor is achieved.

Whether to activate the basic ability factor is determined through a lottery. At this time, a probability of being successful at a lottery as to whether to activate the basic ability factor, that is, a probability of activating the basic ability factor (hereinafter referred to as an activation probability) may be different in the three factor activation turns. Here, in the first turn, the activation probability of the basic ability factor is set to 100% regardless of the factor level. Also, in the 31st turn and the 55th turn, the activation probability of the basic ability factor varies depending on the factor level. As an example, in the 31st turn and the 55th turn, the activation probability of the basic ability factor of level 3 is set to 100%, the activation probability of the basic ability factor of level 2 is set to 90%, and the activation probability of the basic ability factor of level 1 is set to 80%.

On the inheritance character selection screen 170, an increase value that increases in the first turn is displayed for the ability parameter. For example, in FIG. 9C, one inheritance character included in the first inheritance group is provisionally selected. In this case, displayed are the type of the ability parameter to be increased by the one provisionally selected inheritance character in the first turn and the increase value thereof. Here, “+63” is displayed over the ability parameter of power, which indicates that the ability parameter of power increases by 63 points in the first turn. Further, in the ability parameter display portion 152a, the value to which the increase value increased in the first turn is added is displayed.

Further, in FIG. 9D, two inheritance characters included in the first inheritance group and the second inheritance group are provisionally selected. In this case, displayed are the types of the ability parameters to be increased by the two provisionally selected inheritance characters in the first turn and the increase values thereof. Here, “+21”, “+63”, and “+42” are displayed over the ability parameters of speed, power, and wisdom, respectively, which indicate that the ability parameters of speed, power, and wisdom increase by 21 points, 63 points, and 42 points, respectively, in the first turn.

Note that in the inheritance character selection screen 170, the increase value of the ability parameter to be increased by the inheritance character included in the first inheritance group and the increase value of the ability parameter to be increased by the inheritance character included in the second inheritance group are distinguishably displayed. For example, in FIG. 9D, the indication of “+63” displayed over the ability parameter of power is different in color from the indications of “+21” and “+42” displayed over the ability parameters of speed and wisdom are displayed.

When the basic ability factor is activated, the upper limit value of the corresponding ability parameter increases. At this time, the increase value of the upper limit value of the ability parameter varies depending on the factor level of the basic ability factor. The increase value of the upper limit value of the ability parameter also varies depending on the activation timing. For example, when the factor level of the speed factor is level 1, the upper limit value of the ability parameter of speed for the nurture target character is increased by “4” at the first activation timing, and the upper limit value of the ability parameter of speed is increased in a range of “1” to “4” at the second and third activation timings.

Further, when the factor level of the speed factor is level 2, the upper limit value of the ability parameter of speed for the nurture target character is increased by “9” at the first activation timing, and the upper limit value of the ability parameter of speed is increased in a range of “1” to “4” at the second and third activation timings. Further, when the factor level of the speed factor is level 3, the upper limit value of the ability parameter of speed for the nurture target character is increased by “16” at the first activation timing, and the upper limit value of the ability parameter of speed is increased in a range of “1” to “4” at the second and third activation timings.

Note that here, at the first activation timing, the upper limit value of the ability parameter is always increased by the increase value corresponding to the factor level. On the other hand, at the second and third activation timings, a lottery is performed to determine whether to activate the factor. Then, when the activation is determined, a lottery for determining the increase value of the upper limit value is performed. At this time, the higher the factor level, the higher the probability may be set that the activation is determined. Further, the higher the factor level, the higher the increase value of the upper limit value may be configured to be.

Whether to activate the basic ability factor may be determined per factor or may be determined for each effectiveness separately. For example, assume that in a case where whether to activate one basic ability factor is determined per factor, this basic ability factor is determined to be activated. In this case, the value of the corresponding ability parameter is increased and the upper limit value of the same ability parameter is increase depending on the factor level.

On the other hand, in a case where whether to activate one basic ability factor is determined for each effectiveness, the determination on whether to increase the value of the ability parameter and the determination on whether to increase the upper limit value are made through separate lotteries. Therefore, in this case, for example, only one of the value of the ability parameter and the upper limit value of the ability parameter may be increased. In any case, in the present embodiment, the basic ability factor is always activated at the first activation timing. Thus, the value of the ability parameter and the upper limit value are increased depending on the factor level as the nurture main game is started.

As illustrated in the FIGS. 9C and 9D, the initial upper limit value of the ability parameter displayed in the ability parameter display portion 152a on the inheritance character selection screen 170 is updated to a value to which an additional value of the upper limit value increased depending on the basic ability factor has been added. In this way, the initial upper limit value to which the scenario initial additional value and the additional value depending on the basic ability factor have been added is displayed, thereby improving convenience when selecting the inheritance character.

The aptitude factor illustrated in FIG. 11 increases the aptitude parameter for the nurture target character. The aptitude factors include six factors: a turf factor, a dirt factor, a short distance factor, a mile factor, a medium distance factor, and a long distance factor. The nurtured character always obtains one aptitude factor from among the six aptitude factors. The six aptitude factors respectively correspond to the turf aptitude, the dirt aptitude, the short distance aptitude, the mile aptitude, the medium distance aptitude, and the long distance aptitude. For example, when the nurtured character of the first inheritance generation or the second inheritance generation includes a nurtured character having a turf factor, the aptitude parameter of the turf aptitude for the nurture target character increases.

The activation timing and the activation condition are also set for the aptitude factor, and whether to activate is determined for each aptitude factor in the same factor activation turn as that of the basic ability factor. If activation of the aptitude factor is determined, the corresponding aptitude parameter increase by one stage. In this example, in the first turn, the activation probability of the aptitude factor is set to 100% regardless of the factor level.

For example, assume that the aptitude factors of three nurtured characters belonging to the first inheritance group are the turf factor, the short distance factor, and the mile factor; and the aptitude factors of three nurtured characters belonging to the second inheritance group are the turf factor, the short distance factor, and the medium distance factor. In this case, the turf aptitude and the short distance aptitude of the nurture target character are each increased by two stages, and the mile aptitude and the medium distance aptitude are each increased by one stage.

Further, for example, assume that the aptitude factors of the three nurtured characters belonging to the first inheritance group are all the turf factor, and the aptitude factors of the three nurtured characters belonging to the second inheritance group are all the short distance factors. In this case, the turf aptitude and the short distance aptitude of the nurture target character each increase by three stages. In another example, assume that the aptitude factors of the three nurtured characters belonging to the first inheritance group are all the turf factor, and the aptitude factors of the three nurtured characters belonging to the second inheritance group are the turf factor, the short distance factor, and the mile factor. In this case, the turf aptitude of the nurture target character increases by four stages, and the short distance aptitude and the mile aptitude each increase by one stage.

However, for the first turn, a limit is placed on the increase value of the aptitude parameter. Specifically, in the first turn, the upper limits of all the aptitude parameters are set to A. Thus, if the initial value of the turf aptitude of the nurture target character is A, the turf aptitude does not increase in the first turn even if the inheritance character has the turf factor.

On the other hand, in the 31st turn and the 55th turn, a lottery is performed to determine whether to activate each aptitude factor based on the factor level thereof. As an example, in the 31st turn and the 55th turn, the activation probability of the aptitude factor of level 3 is set to 5%, the activation probability of the aptitude factor of level 2 is set to 38, and the activation probability of the aptitude factor of level 1 is set to 1%. In the 31st turn or the 55th turn, when the activation of the aptitude factor is determined through a lottery, the aptitude parameter corresponding to the aptitude factor increases. In the 31st turn and the 55th turn, the upper limit of each aptitude is raised from A to S. Thus, in the 31st turn and the 55th turn, the value of the aptitude parameter can be increased to S by activation of the aptitude factor.

The value of the aptitude parameter increased in the first turn is displayed in the aptitude parameter display portion 152b on the inheritance character selection screen 170.

The race factor increases the ability parameter for the nurture target character. The race factor is provided for each race with a high difficulty (hereinafter referred to as a factor target race), such as GI races, from among the races that can be entered in the nurture main game. When the nurture game is completed, a lottery to determine whether a race factor is obtained is performed for each factor target race in which the nurture target character comes in the first place. The nurtured character can obtain a race factor via a successful lottery.

Note that the race factor is provided with factor levels, and the factor level is determined through a lottery for each race factor determined to be obtained. Here, there is no upper limit to the number of race factors that can be obtained by one nurtured character, and the nurtured character can obtain a plurality of race factors.

For each race factor, an ability parameter to be increased by activation and an increase value thereof are set in advance. For example, the race factors may include a factor to increase the ability parameter of speed and a factor to increase the ability parameter of power. At this time, the higher the factor level, the higher the increase value of the ability parameter.

In addition, the activation timing and the activation condition are also set for the race factor, and whether to activate each race factor is determined in the factor activation turn. If activation of a race factor is determined, the ability parameter corresponding to the race factor increases. The factor activation turns of the race factor are limited to the 31st turn and the 55th turn. In addition, the activation probability of the race factor in the factor activation turn varies depending on the factor level, and the higher the factor level, the higher the activation probability.

The character factor is a factor specific to the character, and for example, only when a character strengthened to a predetermined level is nurtured as a nurture target character, the character factor set for the character is always given to the nurtured character at the completion of the nurture game. Since only one character factor is set for one character, the maximum number of character factors that one nurtured character can obtain is one. When a nurtured character based on a character that is not strengthened to a predetermined level is produced, a character factor cannot be obtained.

The character factor can be activated in a factor activation turn set in advance and is activated by a successful lottery executed in the factor activation turn. When a character factor is activated, a hint event set for each character factor occurs, and a skill hint can be obtained as described above. When the character factor is activated, the upper limit value of the predetermined ability parameter increases.

FIG. 12B is a diagram for describing an effectiveness of a character factor. The increase in the upper limit value of the ability parameter by the character factor is limited to at the second and third activation timings. However, the character factor may be activated at the first activation timing. When the character factor is activated at the first activation timing, the nurture target character acquires a hint of the skill as described above, but the upper limit value of the ability parameter does not increase.

When the character factor is activated at the second or third activation timing, the upper limit value of the ability parameter increases in addition to the hint of the skill being acquired. Here, the upper limit value of the ability parameter increases within a range of “3” to “6” regardless of the factor level. Note that the increase value of the upper limit value is determined by, for example, through a lottery. At this time, the higher the factor level, the higher the increase value may be configured to be.

In the present embodiment, the ability parameter of which the upper limit value is increased by the activation of the character factor is set in advance for each character factor. For example, for a character factor A, the upper limit value of stamina is increased in a range of “3” to “6”, and for a character factor B, the upper limit value of speed is increased by “1” and the upper limit value of spirit is increased by “2”, or the upper limit value of speed is increased by “2” and the upper limit value of spirit is increased by “2”. Note that whether to activate the character factor may be determined per factor or may be determined for each effectiveness separately similar to the basic ability factor.

The skill factor illustrated inf FIG. 11 is given based on the acquired skill acquired by the nurtured character. Specifically, at the completion of the nurture game, a lottery is performed for whether to acquire a skill factor for each acquired skill acquired by the nurtured character. By being successful in the lottery, a skill factor is given to the nurtured character. In other words, the nurtured character can obtain some or all of the skill factors corresponding to acquired skills that have been already acquired. When it is determined to obtain a skill factor, the factor level of the skill factor is determined through a lottery.

The skill factor can be activated in a factor activation turn set in advance and is activated by a successful lottery executed in the factor activation turn. At this time, the higher the factor level, the higher the success probability. When a skill factor is activated, a hint event set for each skill factor occurs, and a skill hint can be obtained. Thus, the nurture target character can acquire a skill the same as the acquired skill having acquired by the inheritance character or the like.

As described above, whether to acquire the skill factor is determined within a range of the acquired skill acquired by the nurtured character. Thus, the nurtured character having more acquired skills obtains the skill factor with the higher possibility. However, since whether to obtain the skill factor is determined through a lottery, the nurtured character even having many acquired skills may not obtain the skill factor.

Note that although the nurtured character obtains the skill factor separately from the acquired skill, the skill that can be acquired by the nurture target character may be determined based on the acquired skill of the nurtured character as the inheritance character without providing the skill factor.

As described above, the ability parameter for the nurture target character greatly varies depending on the inheritance character to form the deck. In addition, even if the ability of the nurtured character itself is high, since whether to obtain the factor is determined through a lottery, the nurtured character with higher ability does not necessarily correspond to the inheritance character. On the other hand, even when the ability of the nurtured character itself is not high, the nurtured character may effectively function as an inheritance character by obtaining a large number of factors having a high factor level. In this manner, making it possible to form a deck using the inheritance characters provides the interest in not only simply nurturing a strong nurtured character but also nurturing a nurtured character that is effective as an inheritance character.

Furthermore, in the present embodiment, the compatibility is determined between the nurture target character, the nurtured character of the first inheritance generation, and the nurtured character of the second inheritance generation. Then, in the case of a combination of characters having good compatibility, an advantageous factor activation condition is achieved.

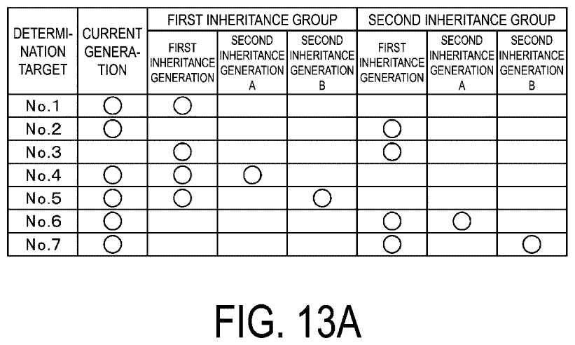

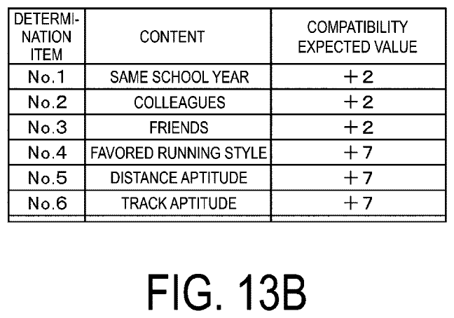

FIG. 13A is a diagram for describing a determination target for compatibility, and FIG. 13B is a diagram for describing a determination item for compatibility. As illustrated in FIG. 13A, in the present embodiment, seven determination targets of No. 1 to No. 7 are provided. A first determination target (No. 1) is the nurture target character of the current generation and the nurtured character of the first inheritance generation in the first inheritance group. A second determination target (No. 2) is the nurture target character of the current generation and the nurtured character of the first inheritance generation in the second inheritance group.

A third determination target (No. 3) is the nurtured character of the first inheritance generation in the first inheritance group and the nurtured character of the first inheritance generation in the second inheritance group. A fourth determination target (No. 4) is the nurture target character of the current generation, the nurtured character of the first inheritance generation in the first inheritance group, and one of the nurtured characters (nurtured character A) of the second inheritance generation in the first inheritance group. A fifth determination target (No. 5) is the nurture target character of the current generation, the nurtured character of the first inheritance generation in the first inheritance group, and the other nurtured character (nurtured character B) of the second inheritance generation in the first inheritance group.

A sixth determination target (No. 6) is the nurture target character of the current generation, the nurtured character of the first inheritance generation in the second inheritance group, and one of the nurtured characters (nurtured character A) of the second inheritance generation in the second inheritance group. A seventh determination target (No. 7) is the nurture target character of the current generation, the nurtured character of the first inheritance generation in the second inheritance group, and the other nurtured character (nurtured character B) of the second inheritance generation in the second inheritance group.

For each determination target, whether the condition is met is determined for each one of a plurality of determination items. Example of the determination items are illustrated in FIG. 13B. In the present embodiment, a world view of the game is set such that characters that can be selected as nurture target characters are students and each character performs training in a school.

As illustrated in FIG. 13B, settings including school years, colleagues, and friends are set in advance for each character. The determination items include, for example, whether the two or three characters as the determination targets are in the same school year, are colleagues, or are friends. In addition, the determination items include whether the running style, the distance aptitude, and the track aptitude that the character as the determination target favors.

Each determination item is associated with a compatibility expected value, and the compatibility expected values of the determination items established between the characters as the determination targets are accumulated. Here, the compatibility expected value varies depending on the determination item, but the compatibility expected value may be common to all the determination items.

For example, in the case of determining the compatibility, first, whether all determination items are established is determined between the nurture target character of the current generation which is the first determination target and the nurtured character of the first inheritance generation of the first inheritance group. At this time, the compatibility expected values associated with the established determination items are accumulated and counted. As described above, the calculation of the compatibility expected value is sequentially performed from the first determination target to the seventh determination target, and the activation probability of the factor is corrected based on the finally calculated compatibility expected value. That is, the higher the compatibility expected value, the higher the activation probability of all the factors, and the lower the compatibility expected value, the lower the activation probability of all the factors.

The activation probability may be calculated by using the calculated compatibility expected value as a correction value. For example, a correction value for correcting the activation probability of the factor may be set for each compatibility level, and the compatibility level may be determined based on the calculated compatibility expected value.

As described above, since the activation probability of the factor varies depending on the compatibility between the nurture target character and the inheritance character or the compatibility between the inheritance characters, the combination of the two inheritance characters greatly affects the nurturing of the nurture target character. In other words, the compatibility between characters is an important criterion for selecting an inheritance character.

As illustrated in FIGS. 9B, 9C, and 9D, in a state in which the inheritance character is selected, a compatibility mark indicating how a compatibility is good is displayed in an upper right portion of each of the inheritance character selection screen 170 and the nurtured character list screen 180. Here, the compatibility level of the selected characters is indicated by three compatibility marks: ⊚, ◯, and Δ. As illustrated in FIG. 9A, the compatibility mark is not displayed in a state in which an inheritance character is not selected.

As illustrated in FIG. 9B, a switch display button 183 is provided on the nurtured character list screen 180. When the switch display button 183 is operated, a display condition setting screen (not illustrated) is displayed. On the display condition setting screen, the player can rearrange or filter the nurtured character icons 182 displayed on the nurtured character list screen 180, that is, the nurtured characters selectable as inheritance characters.

### Registration of Support Card

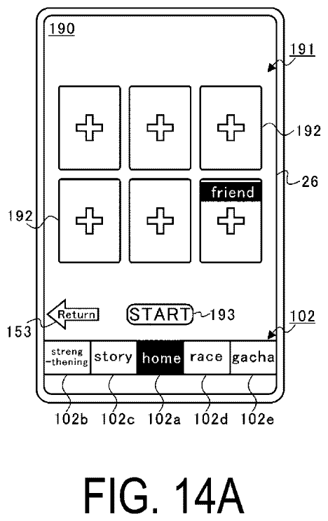

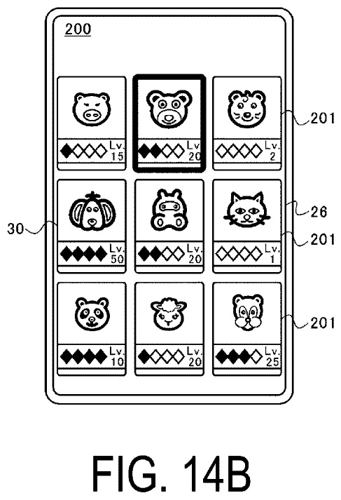

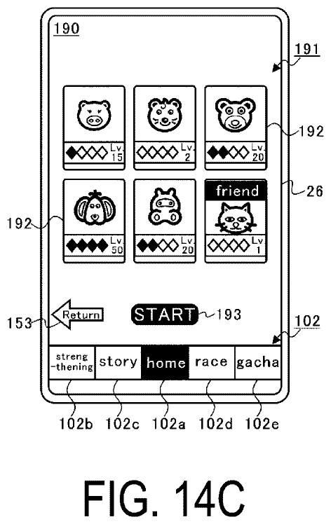

FIG. 14A is a first diagram for describing the support card organization screen 190. When two inheritance characters are registered on the inheritance character selection screen 170, the support card organization screen 190 illustrated in FIG. 14A is displayed. A support card display region 191 is provided at a central portion on the support card organization screen 190. The support card display region 191 includes a plurality of support card display frames 192. In addition, the return operation portion 153 and a start operation portion 193 are displayed in a lower portion on the support card organization screen 190.

In the support card display region 191, a plurality of (here, six) support card display frames 192 are displayed. The number of support card display frames 192 displayed is the same as the number of support cards that can be set by the player. When the support card organization screen 190 is first displayed, the support card display frames 192 are blank.

In the present embodiment, the player can set six types of support cards in the deck. One or more (for example, five types) of the six types that can be set by the player can be selected from among the support cards possessed by the player. In addition, the remaining (for example, one type) of the six types that can be set by the player can be selected from support cards set as rental cards by other players such as friends.

FIG. 14B is a diagram for describing a support card selection screen 200. When the support card display frame 192 (excluding the support card display frame 192 displayed in a lower right portion) is tapped on the support card organization screen 190 of FIG. 14A, the support card selection screen 200 illustrated in FIG. 14B is displayed on the display 26. The support card selection screen 200 displays a list of card icons 201 corresponding to the support cards possessed by the player. By tapping the card icon 201 displayed on the support card selection screen 200, the player can select a support card.

Although not illustrated, when the support card display frame 192 displayed at the lower right of the support card organization screen 190 is tapped, a support card set as a rental card by a friend or a player extracted based on a predetermined condition such as a lottery is displayed on the support card selection screen 200. At this time, the player can select one support card of a friend by tapping a support card displayed on the support card selection screen 200. In this manner, the player can use a support card possessed by another player in the nurture game.

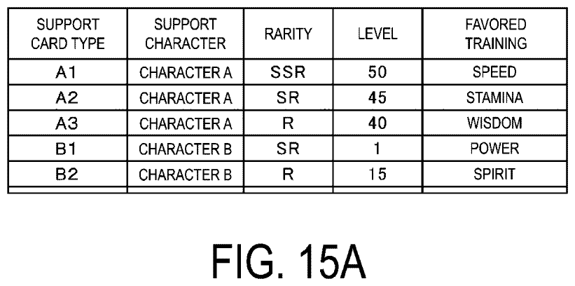

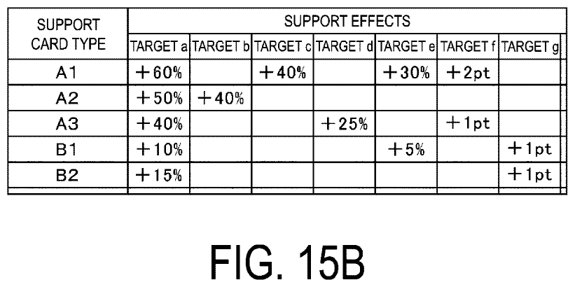

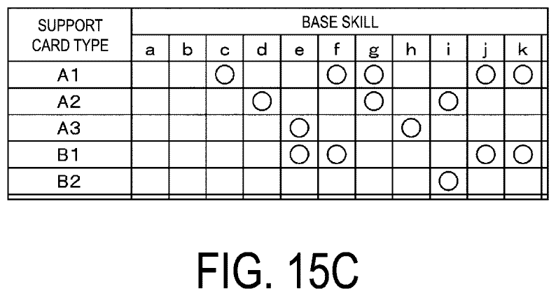

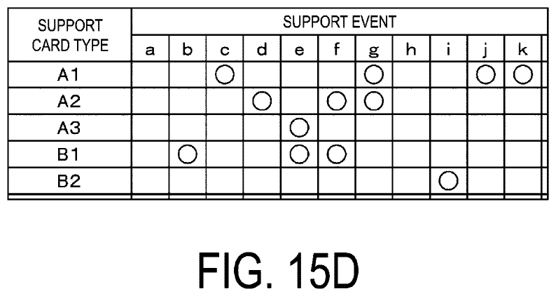

FIG. 15A is a diagram for describing a support card table. As illustrated in FIG. 15A, the support card table stores the type of support character (that is, a character ID), rarity, level, and favored training for each type of support card possessed by the player (that is, support card ID). The support characters are in one-to-one correspondence with the types of support cards. That is, one character ID is always associated with a support card ID. In other words, one support card is always associated with one support character.

In the present embodiment, a rarity is set for each support card. The rarity has three stages: R (rare), SR (super rare), and SSR (super special rare). R is set to the lowest rarity and SSR is set to the highest rarity. In the present embodiment, a support card having a higher rarity tends to have a higher support effect described below. In the present embodiment, the number of base skills and the number of support events described below tend to increase as the rarity of a support card increases.

For the levels of the support card, 50 stages of level 1 to level 50 are provided. The level of the support card can be increased by the player, and the level increased by the player is stored for each support card. The level of the support card can be increased by using in-game currency, an item, or the like. The level of the support card has an upper limit depending on rarity.

For example, level 20 is defined as the upper limit for a support card with a rarity of R, level 25 is defined as the upper limit for a support card with a rarity of SR, and level 30 is defined as the upper limit for a support card with a rarity of SSR.

The upper limit of the level can be raised incrementally when a predetermined condition is met. For example, a support card with a rarity of R may have its upper limit raised to level 40, a support card with a rarity of SR may have its upper limit raised to level 45, and a support card with a rarity of SSR may have its upper limit raised to level 50.

FIG. 15B is a diagram for describing support effects. As illustrated in FIG. 15B, a plurality of support effects are stored in each support card. The support effects increase various stats in the nurture main game. A support card has support effects for a plurality of targets. Examples of the support effect targets include energy, speed, stamina, power, spirit, and wisdom.

FIG. 15C is a diagram for describing the base skills. As illustrated in FIG. 15C, a plurality of base skills are set in each support card. In the present embodiment, the base skills are associated with the support card as each character possesses the base skills. The base skill set for each support card can be obtained by the nurture target character selected by the player when a hint event occurs during the nurture main game.

FIG. 15D is a diagram for describing support events. As illustrated in FIG. 15D, each support card is associated with a plurality of support events. A support event is an event that may occur during the nurture main game. When a support event occurs, the values of various stats in the nurture main game may increase or decrease.

For example, a support event that occurs according to the turn number, or a support event that occurs according to a predetermined lottery may be determined. A plurality of support events to occur may be selected in one turn. In any case, the support event to occur may be determined according to a predetermined determination method set in advance.

Note that the support events may include a hint event and an ability event. The hint event may include a first hint event that may occur upon starting of a turn in the nurture game, a second hint event that may occur after training is performed in the nurture game described below. The ability event may include a first ability event that may occur upon starting of a turn in the nurture game and a second ability event that may occur after training in the nurture game is performed.

The first hint event and the second hint event are events that make it possible to possess or obtain a skill. Further, the first ability event and the second ability event are events for increasing or decreasing the numerical value of an ability parameter for the character. Hereinafter, the first hint event and the first ability event are collectively referred to as a first event, and the second hint event and the second ability event are collectively referred to as a second event.

FIG. 14C is a second diagram for describing the support card organization screen 190. In the present embodiment, when all six support cards are selected, the start operation portion 193 becomes operable as illustrated in FIG. 14C. On the other hand, when all the six support cards are not selected, the start operation portion 193 cannot be operated as illustrated in FIG. 14A.

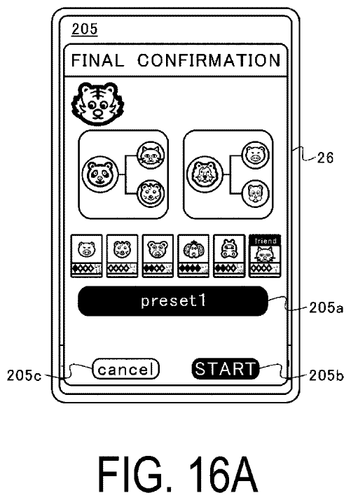

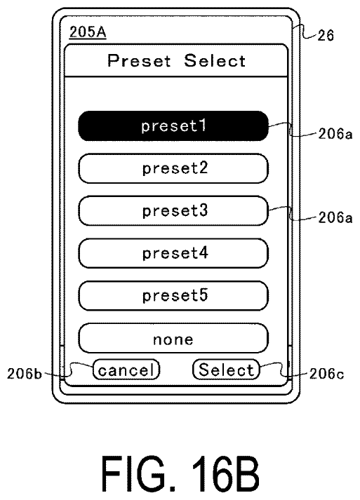

When the return operation portion 153 is operated on the support card organization screen 190, the inheritance character selection screen 170 illustrated in FIG. 9D is displayed on the display 26. Further, as illustrated in FIG. 14C, when the start operation portion 193 is tapped on the support card organization screen 190, the selected support card is provisionally registered, and a final confirmation screen 205 illustrated in FIG. 16A is displayed.

FIG. 16A is a diagram for describing the final confirmation screen 205. FIG. 16B is a diagram for describing a preset selection screen 205A. On the final confirmation screen 205, the nurture target character selected by the player, the nurtured character included in the first inheritance group, the nurtured character included in the second inheritance group, and the support cards are displayed. Further, a preset display portion 205a is displayed on the final confirmation screen 205. In the preset display portion 205a, the number of the preset currently selected is indicated.

Here, the preset is reservation information of a race in which the nurture target character is made to enter in the nurture main game. The player can select any race from all the races to create a preset. A plurality of presets can be saved, and one preset can be selected from the saved presets on the final confirmation screen 205. To be more specific, when the preset display portion 205a is tapped, the preset selection screen 205A illustrated in FIG. 16B is displayed.

On the preset selection screen 205A, preset read buttons 206a corresponding to the saved presets are displayed. The player can set a preset by tapping any of the preset read buttons 206a and then tapping a select operation portion 206c. When the select operation portion 206c is tapped, the preset selection screen 205A is closed, and the final confirmation screen 205 is displayed. When a cancel operation portion 206b of the preset selection screen 205A is tapped, the preset selection screen 205A is displayed without changing the preset.

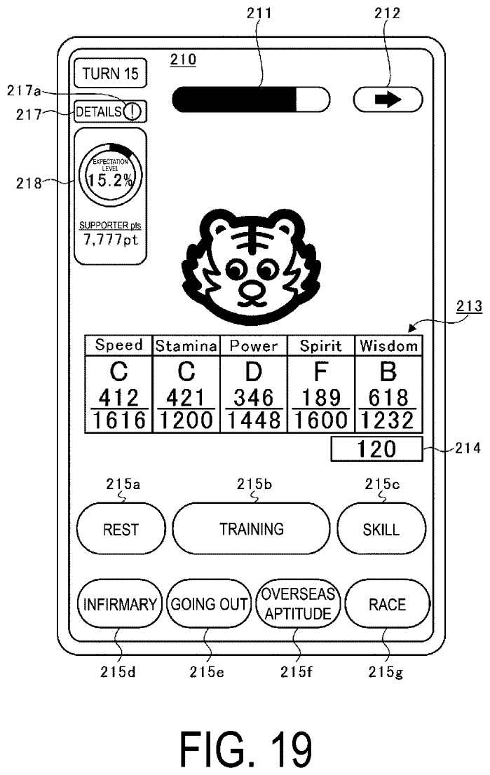

When a cancel operation portion 205c is tapped on the final confirmation screen 205, the support card organization screen 190 is displayed. On the other hand, when a start operation portion 205b is tapped, as illustrated in FIG. 4, after team member registration, a top screen 210 (FIG. 19) is displayed on the display 26.

### Team Member Registration

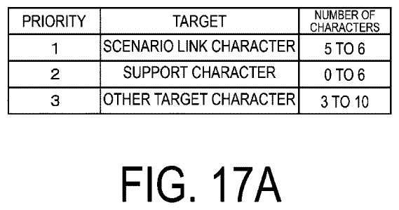

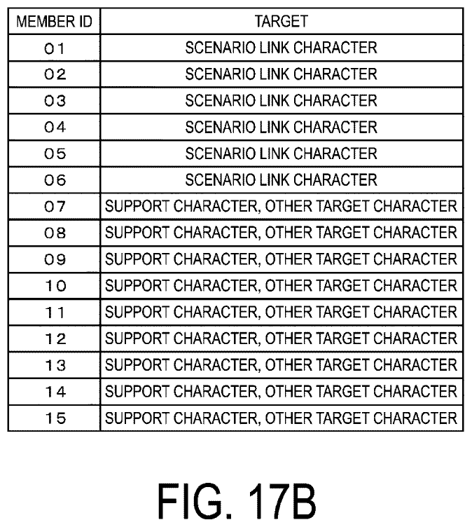

FIG. 17A is a diagram for describing the types of characters. FIG. 17B is a diagram for describing member IDs. The nurture main game of the present embodiment has a story-like narrative in which the nurture target character and 15 other characters constitute one team. In the preparation stage processing, 15 characters constituting a team are determined. Hereinafter, a character determined as a member of the team is referred to as a team member.

The characters that can become team members are characters associated with character cards or support cards provided by the game operator. As illustrated in FIG. 17A, the characters that can be determined as team members are given a priority, and the team members are determined in order from the character with the highest priority. Here, the scenario link character is set to have the highest priority.

The scenario link character is a character indispensable for the story of the nurture main game, and in the present embodiment, six characters are set as the scenario link characters in advance. When the nurture target character is not a scenario link character, six scenario link characters are determined as team members. In addition, when the nurture target character is a scenario link character, five scenario link characters other than the nurture target character are determined as team members.

When the scenario link characters are determined as team members, the support character is then determined as a team member. As described above, the support character is a character associated with a support card. Here, the priority of the support character is set to be the highest after the scenario link character. In the preparation stage processing, six support cards are formed into a deck. Accordingly, the team members may include six support characters associated with support cards formed into a deck.

However, when the character associated with the support card is a scenario link character, the character has already been determined as a team member as a scenario link character. For example, take an example in which scenario link characters are associated with two support cards among six support cards formed into a deck. In this case, since two support characters have already been determined as team members as scenario link characters, the other four support characters are determined as team members.

Although detailed description is omitted, a support character includes a character that can be set as a nurture target character and a special character that cannot be set as a nurture target character. A special character is set in advance so as to not be determined as a team member. Thus, when special characters are associated with all of the six support cards formed into the deck, the number of support characters determined as team members is 0. In this case, the scenario link character does not include a special character. However, a special character may be set as a scenario link character. In addition, when the special character is a support character, the special character may be determined as a team member.

When the team members are determined from the scenario link character and the support characters, the remaining team members are determined from the other target characters. The other target characters are characters other than the nurture target characters, the scenario link characters, and the support characters among the characters that can be determined as team members. The target character does not include a special character.

For example, when ten team members have already been determined from the scenario link characters and the support characters, five characters are determined as team members from the other target characters. Here, other target characters are extracted, and characters to be team members are determined through a lottery from among the extracted characters. For example, a priority order may be set for characters to fill up the remaining team members, and the characters may be determined as team members in order from the character with the highest priority order.

A member ID is associated with a character determined as a team member. Here, as illustrated in FIG. 17B, member IDs 01 to 15 are provided. Although a detailed description is omitted, the member ID is associated with initial values of various parameters such as ability parameters, in a similar manner to the nurture target character. Here, the initial values associated with the member IDs of 01 to 06 are overall higher than the initial values associated with the member IDs of 07 to 10. The initial values associated with the member IDs of 07 to 10 are overall stronger than the initial values associated with the member IDs of 11 to 15. Thus, the higher the priority of a character, the higher the initial ability of the team member.

As described above, when the nurture target character, the inheritance character, the support character (support card), and the team member are registered and stored, the preparation stage processing ends, and the processing moves to the nurture stage processing.

### Nurture Stage Processing

When the preparation stage processing ends, the nurture stage processing is started. Via the nurture stage processing, the nurture main game in which the nurture target character can be nurtured progresses. Hereinafter, in order to facilitate understanding, first, a basic flow of the nurture main game will be described.

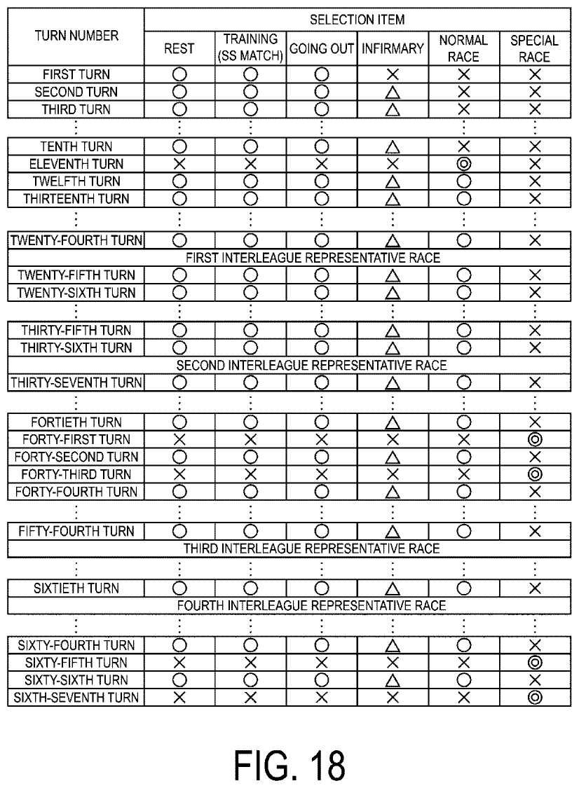

FIG. 18 is a diagram for describing selection items in each turn. In the scenario of the present embodiment, a goal to be achieved during the nurture game is set for the nurture target character. Here, as described above, a common goal is set for all the nurture target characters based on the scenario ID registered in the preparation stage processing. Thus, the player needs to achieve a common goal in the nurture game regardless of the type of character selected as the nurture target character.

As illustrated in FIG. 18, the nurture main game includes the first turn to the 67th turn. The player selects any one of the selection items for each turn to progress through the nurture main game. When a selection item is selected in each turn, the turn is ended, and the game proceeds to the next turn. Various parameters are updated in accordance with the selection item selected by the player in each turn. The selection items will be described below with reference to FIGS. 18 and 19.

FIG. 19 is a diagram for describing the top screen 210. In the nurture stage processing, the top screen 210 illustrated in FIG. 19 is displayed on the display 26. In an upper portion on the top screen 210, an energy display portion 211 and a mood display portion 212 are displayed. The nurture target character is associated with an “energy” parameter. The “energy” parameter is mainly used for calculation of a failure probability which is a probability of failure in training described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of stages (five stages including very bad, bad, normal, good, and very good) so that the user can visually recognize the mood. With higher “mood” parameter, race developments become more advantageous for the nurture target character and the increase value of ability parameters in training are increased.

As illustrated in FIG. 19, an image of the nurture target character, a stats display portion 213, and a skill point display portion 214 are displayed at a central portion on the top screen 210. In the stats display portion 213, current stats of the nurture target character are displayed. In the stats display portion 213, the stats of the nurture target character are displayed by a numerical value and an alphabet indicating a rank divided according to the numerical value. Specifically, in the present embodiment, the numerical values and ranks of the ability parameters of speed, stamina, power, spirit, and wisdom are displayed. In the skill point display portion 214, the skill point possessed by the nurture target character is indicated in a numerical value.

As illustrated in FIG. 19, a rest operation portion 215a, a training operation portion 215b, a skill operation portion 215c, an infirmary operation portion 215d, a going out operation portion 215e, an overseas aptitude operation portion 215f, and a race operation portion 215g are displayed in a lower portion of the top screen 210. These operation units can be said to be commands for designating the action of the nurture target character. The commands including the rest operation portion 215a, the training operation portion 215b, the infirmary operation portion 215d, the going out operation portion 215e, and the race operation portion 215g are commands that end the current turn. In other words, in each turn, only one command from among the rest operation portion 215a, the training operation portion 215b, the infirmary operation portion 215d, and the going out operation portion 215e, and the race operation portion 215g can be selected.

However, a goal is set as described above for the nurture target character. The goal set for the nurture target character includes a goal such as entering a goal race set in advance and attaining a predetermined result in the goal race. In the turn set with the goal race (hereinafter referred to as a race-limited turn), the race operation portion 215g is selectable and the rest operation portion 215a, the training operation portion 215b, the infirmary operation portion 215d, and the going out operation portion 215e are not selectable.

Note that in the race-limited turn, the rest operation portion 215a, the training operation portion 215b, the infirmary operation portion 215d, and the going out operation portion 215e are displayed in a grayed-out manner, and an operation by the player is not accepted. Thus, in the race-limited turn, the player has to operate the race operation portion 215g to make the nurture target character enter the race.

The player can select “Rest” as the selection item by operating the rest operation portion 215a. When “Rest” is selected, the energy of the nurture target character is recovered. In addition, the player can select training to be executed by the nurture target character by operating the training operation portion 215b.

Also, the player can select a selection item “Skill” by operating the skill operation portion 215c. When “Skill” is selected, the player can acquire a skill by spending skill points. Note that the skill operation portion 215c is set to be always selectable in all turns. Even if the player operates the skill operation portion 215c to obtain a skill, the turn is not ended.

The player can select “Infirmary” as the selection item by operating the infirmary operation portion 215d. When “Infirmary” is selected, the minus parameters of the nurture target character may be cancelled. Although a detailed description is omitted, a minus parameter that is a disadvantage to progressing through the game may be set for the nurture target character.

In the nurture main game, an event of obtaining a minus parameter is provided. The nurture target character obtains a minus parameter by the occurrence of the event. In addition, even when the training fails, the nurture target character may obtain a minus parameter. When “Infirmary” is selected in a state where the nurture target character has obtained a minus parameter, the minus parameter can be canceled. However, even if “Infirmary” is selected, the minus parameter may not be canceled. In addition, energy may be recovered by selecting “Infirmary”. In a state where the nurture target character has not obtained a minus parameter, the infirmary operation portion 215d cannot be selected.

The player can select “Going out” as the selection item by operating the going out operation portion 215e. When “Going out” is selected, the mood of the nurture target character increases.

The player can select a selection item “Overseas aptitude” by operating the overseas aptitude operation portion 215f. By selecting “Overseas aptitude”, the player can acquire overseas aptitude by spending aptitude points described below. Note that the overseas aptitude operation portion 215f is set to be always selectable in all turns. Even if the player operates the overseas aptitude operation portion 215f to acquire overseas aptitude, the turn is not ended. The details of overseas aptitude and aptitude points will be described below.

In addition, the player can select the race type to enter the nurture target character in by operating the race operation portion 215g.

When the nurture target character performs any one of rest, training, infirmary, going out, and race entry, the current turn ends and shifts to the next turn.

FIG. 18 illustrates an example of selection items that can be selected by the player in each turn. In FIG. 18, ⊚ indicates that the selection item has to be selected, ◯ indicates that selection item is selectable, and x indicates that selection item is not selectable. Further, Δ indicates a case where whether the selection item is selectable or not selectable depends on the parameter of the nurture target character at the start of each turn. In the present embodiment, the “race” described above are roughly classified into “normal race” and “special race” as illustrated in FIG. 18.

In this example, from the 1st turn to the 10th turn, “race” is not selectable, and selection items other than “race” are selectable. In addition, for example, a plurality of race-limited turns are provided such as the 11th turn, the 41st turn, the 43 rd turn, the 65th turn, the 67th turn, and the like are provided. In the race-limited turn, the player has to select a preset normal race or special race.

In other words, a goal race and a goal in the goal race are set in advance for the nurture target character. Here, placing in each goal race is set as a goal, and the turn in which the goal race is held is a race-limited turn. Thus, in the race-limited turn, the player has to enter the nurture target character into the goal race. In a case where the goal set for the goal race is not satisfied, the nurture main game ends.

The scenario of the present embodiment has a story-like narrative in which the nurture target character trains with team members and aims to win an overseas race. Thus, the normal races are domestic races, and the special races are overseas races. As described above, in the present embodiment, an interleague representative race is performed after the end of a predetermined turn. In the interleague representative race, the nurture target character and the team members participate in a race with international representatives. Here, as illustrated in FIG. 18, the interleague representative race is performed four times in total, from a first interleague representative race to a fourth interleague representative race. The goal of the nurture target character may include acquiring a predetermined placing in the interleague representative race.

As illustrated in FIG. 19, a details icon 217 and an expectation level display field 218 are provided in the upper left portion of the top screen 210. The current supporter points and the expectation level calculated from the supporter points are displayed in the expectation level display field 218. The supporter points correspond to a parameter associated with the nurture target character and each team member. For example, the supporter points of the nurture target character increase by the execution of an SS match described below. For example, the supporter points of the team members are increased by the execution of joint training described below.

The condition for the nurture target character and the team members to acquire supporter points is not limited to this. For example, one or both of the nurture target character and the team members may acquire supporter points by entering the goal race. The supporter points may be randomly given in each turn. The supporter points (7,777 pt in FIG. 19) of the nurture target character is displayed in the expectation level display field 218.

The details icon 217 is provided with an information button 217a. When the information button 217a is operated, a team member dialog 310 described below is displayed. The team member dialog 310 displays supporter points and the like for each character.

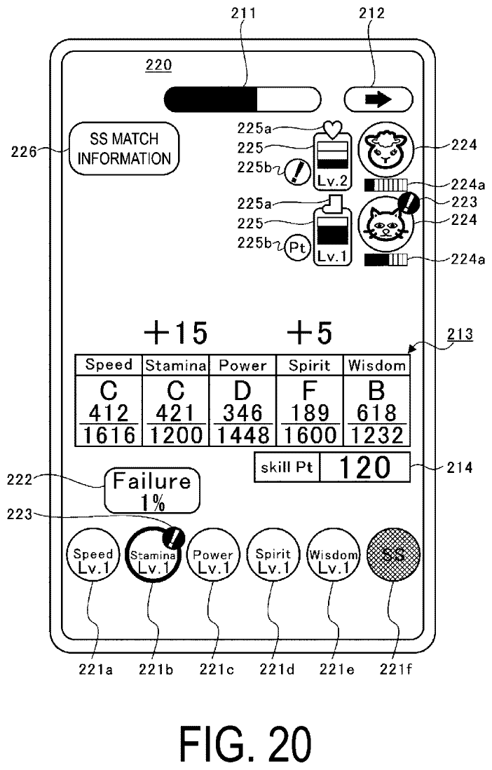

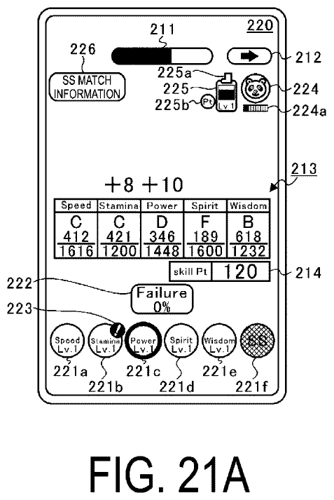

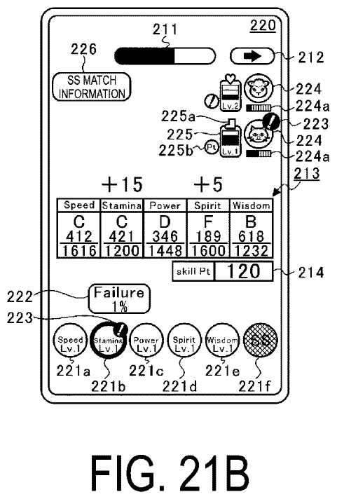

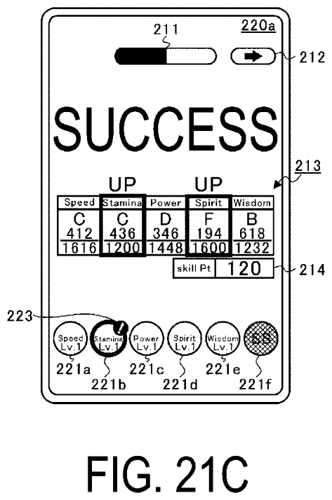

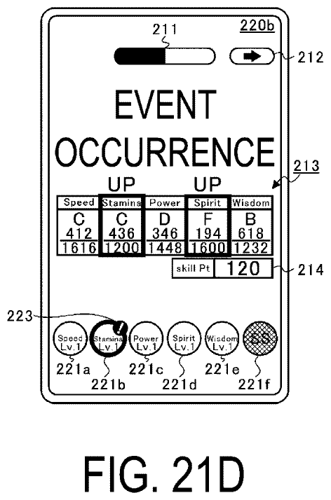

FIG. 20 is a first diagram for describing a training screen 220. FIG. 21A is a second diagram for describing the training screen 220. FIG. 21B is a third diagram for describing the training screen 220. When the training operation portion 215b of the top screen 210 is operated, the training screen 220 is displayed on the display 26. As illustrated in FIG. 20, training items are displayed in a lower portion of the training screen 220. Here, a speed operation portion 221a, a stamina operation portion 221b, a power operation portion 221c, a spirit operation portion 221d, a wisdom operation portion 221e, and an SS match operation portion 221f are displayed. Hereinafter, the speed operation portion 221a, the stamina operation portion 221b, the power operation portion 221c, the spirit operation portion 221d, the wisdom operation portion 221e, and the SS match operation portion 221f may be collectively referred to simply as the operation portions 221.

When the player operates the operation portions 221, the training item corresponding to the operation portion 221 to which that operation input is given is put in a provisionally selected state. At this time, the operation portion 221 corresponding to the training item in the provisionally selected state is highlighted. For example, in FIGS. 20 and 21B, the stamina operation portion 221b is provisionally selected. Also, in FIG. 21A, the power operation portion 221c is provisionally selected.

When an operation input is again given to the operation portion 221 in the provisionally selected state, the training corresponding to the operation portion 221 to which that operation input is given is performed. Specifically, when an operation input is again given to the speed operation portion 221a, the stamina operation portion 221b, the power operation portion 221c, the spirit operation portion 221d, the wisdom operation portion 221e, or the SS match operation portion 221f in the provisionally selected state, training for speed, stamina, power, spirit, wisdom, or SS match is performed, respectively.

Here, the training level per training item is displayed together with the speed operation portion 221a, the stamina operation portion 221b, the power operation portion 221c, the spirit operation portion 221d, and the wisdom operation portion 221e. Although details will be described below, the training level is a parameter that increases based on the number of times training per training item, and when the training levels are higher, the increase value of the ability parameter when the training is successful is larger. The training level is initially set to level 1 and is increased up to level 5.

Here, a failure probability display portion 222 is displayed in the speed operation portion 221a, the stamina operation portion 221b, the power operation portion 221c, the spirit operation portion 221d, or the wisdom operation portion 221e in a provisionally selected state. The failure probability displayed using a numerical value in the failure probability display portion 222 is configured to increase in inverse proportion to the remaining energy displayed in the energy display portion 211.

Further, at the stats display portion 213, the increase value of the ability parameter in a case where the training corresponding to the operation portion 221 in the provisionally selected state is successful is displayed. In the example illustrated in FIGS. 20 and 21B, the stamina operation portion 221b is provisionally selected, and “+15” is displayed at a field of stamina and “+5” is displayed at a field of spirit of the stats display portion 213. For example, in the example illustrated in FIG. 21A, the power operation portion 221c is provisionally selected, and “+8” is displayed at a field of stamina and “+10” is displayed at a field of power of the stats display portion 213.

In addition, when the training is performed and is successful, a predetermined event may occur. In this case, an event notification display 223 is displayed at the operation portion 221 corresponding to the training item for which the predetermined event occurs. Note that the event notification display 223 may have different display modes depending on the type of the event.

In a turn in which training can be performed, a character may be arranged for each training item. The characters arranged in the training items are the team members and the story characters set in the scenario. In a turn in which training can be performed, whether to arrange a character for a training item and a training item for which the character is arranged are determined through a lottery for each character to be arranged for the training.

As illustrated in FIG. 20, in an upper right portion on the training screen 220, an arranged character icon 224 is displayed corresponding to the character arranged for the training (hereinafter, referred to as the arranged character) for each item in the operation portion 221 in the provisionally selected state. When the training is successful, a predetermined event associated with the arranged character may occur. In this case, the event notification display 223 is displayed at the corresponding arranged character icon 224.

When the arranged character is successful in the associated training, the increase value of the parameter for the nurture target character is higher compared to when any of the arranged characters is successful in unassociated training. Note that hereinafter, the training for which the character is arranged is referred to as joint training.

In addition, a bond gauge 224a is displayed below the arranged character icon 224. The bond gauge 224a visually displays a bond parameter associated with the arranged character. When the training associated with the arranged character is successful, the bond parameter for the arranged character increases. The higher a value of the bond parameter, the larger the increase value of the ability parameter for the nurture target character when the training is successful.

In addition, when a support character having a bond parameter equal to or greater than a predetermined value is arranged for a predetermined training item, a friendship training occurrence possible state is set for the training item. When a training item for which the friendship training occurrence possible state is set is selected and the training is successful, friendship training occurs. In other words, when training in the friendship training occurrence possible state is successful, the normal joint training is upgraded to a friendship training. In the friendship training, the increase value of the ability parameter for the nurture target character is larger than that in the normal joint training.

Note that the support card (support character) is associated with any one of five training items of speed, stamina, power, spirit, and wisdom as the favored training. Here, the support character being arranged for the favored training and the bond parameter for the support character being equal to or greater than a predetermined value are set as the setting conditions for the friendship training occurrence possible state.

Thus, when the support character having the bond parameter equal to or greater than a predetermined value is arranged for the favored training of the support character based on a predetermined probability, the friendship training occurrence possible state is set for the training item. Then, the training item for which the friendship training occurrence possible state is set is selected and this training is successful, the ability parameter for the nurture target character is greatly increased compared to the normal joint training.

Note that the support cards (support characters) may include a support card (support character) not associated with the favored training. Then, the friendship training occurrence possible state may be set for the support card (support character) not associated with the favored training on condition that a bond parameter for the support character is equal to or greater than a predetermined value, regardless of the training item to be arranged. Alternatively, the friendship training occurrence possible state may not be set for the support card (support character) not associated with the favored training.

As described above, in the present embodiment, the bond parameter for the support character being equal to or greater than a predetermined value and the support character being arranged for the training item set in advance are set as the setting conditions for the friendship training occurrence possible state.

FIG. 21C is a diagram for describing a training result notification screen 220a. As described above, when an operation input is again given to the operation portion 221 in the provisionally selected state, the training corresponding to the operation portion 221 to which the operation input is given is performed. When the training is performed, the training result notification screen 220a is displayed on the display 26. An image for notifying of success or failure of the training is displayed on the training result notification screen 220a.

Although not illustrated, when the normal joint training is performed, an image for the nurture target character to perform the training is displayed on the training result notification screen 220a. The image displayed at this time is provided for each training item. In addition, the image corresponding to each training item is provided with a success pattern displayed in a case where the training is successful and a failure pattern displayed in a case where the training is failed.

When the training for which the friendship training occurrence possible state is set is successful, a friendship training-dedicated performance is performed. The friendship training-dedicated performance includes a performance in which a support character is displayed on the training result notification screen 220a. The support character displayed at this time is a character that satisfies the setting conditions for the friendship training occurrence possible state.

For example, assume that a character A which is a support character is arranged for the training item of speed. Assume that at this time, the bond parameter for the character A is equal to or greater than a predetermined value and the favored training of the character A (support card) is speed. In this case, the training item of speed is put in the friendship training occurrence possible state. Assume that the training item of speed is selected and the training of speed is successful in this state. In this case, an image including the character A is displayed on the training result notification screen 220a.

Note that in one turn, a plurality of support characters arranged for the same training item may satisfy the setting conditions for the friendship training occurrence possible state. For example, assume that four support characters of characters A, B, C, and D are arranged for the training item of stamina. Assume that at this time, all of the characters A, B, C, and D satisfy the setting conditions for the friendship training occurrence possible state. In this case, the friendship training-dedicated performance is performed in which the characters A, B, C, and D are displayed simultaneously or sequentially on the training result notification screen 220a.

Note that the friendship training-dedicated performance is content in which the character satisfying the setting conditions for the friendship training occurrence possible state and the nurture target character perform training together. Therefore, it can be said that the friendship training occurrence possible state is set for the support character in addition to the training item.

Although not illustrated, an effect is superimposed and displayed on the arranged character icon 224 corresponding to the arranged character for which the friendship training occurrence possible state is set. This allows the player to distinguish which arranged character the friendship training occurs for. In addition, when the friendship training occurrence possible state is set to any one of the training items, the effect is also superimposed and displayed on the training operation portion 215b of the top screen 210. Therefore, the player can also recognize that the friendship training occurrence possible state is set on the top screen 210.

The ability parameter in the stats display portion 213 is updated and displayed on the training result notification screen 220a. That is, the ability parameter for the nurture target character corresponding to the training item selected by the player is updated.

Here, the value of the ability parameter that increases when the training displayed in the stats display portion 213 in FIG. 21A or 21B is successful is added. In addition, the display of the energy display portion 211 is updated according to the performed training item. When any of the training of speed, stamina, power, or spirit is successful, the energy decreases. On the other hand, when the training of wisdom is successful, the energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure probability is high may be more disadvantageous than the penalty given when the failure probability is low (for example, the numerical value of the decrease in energy is large, the numerical value of the decrease in the ability parameter is large, or the number of stages of the decrease in mood is large).

The content of the penalty may be determined in accordance with the training item. For example, the value of the ability parameter of speed may be decreased when the training of speed is failed, and the value of the ability parameter of power may be decreased when the training of power is failed. In addition, for some training items (for example, wisdom), even if training is failed, a penalty may not be given.

FIG. 21D is a diagram for describing an event screen 220b. When the display of the training result notification screen 220a ends, the event screen 220b may be displayed on the display 26. Various events are performed via the event screen 220b. Note that a plurality of events may occur during one turn.

For example, when a first hint event or a second hint event occurs, a skill hint may be obtained. When a skill hint is obtained, the player can acquire the skill by spending skill points. A plurality of types of skills are provided, and a predetermined ability may be activated for each skill. An activation condition and an effect are predefined for each skill, and when an activation condition is met, the predefined effect is activated. A skill may be activated while a race is being executed as described below.

The events include, in addition to the first hint event and the second hint event for obtaining a skill hint, an event for recovering energy, an event for decreasing energy, a first ability event and a second ability event for increasing or decreasing an ability parameter, an event for increasing mood, an event for decreasing mood, and the like. As will be described in detail below, examples of the event include an event in which a turn to occur is predefined and an event that occurs through a predetermined successful lottery. In addition, there are events that occur upon starting of a turn and events that occur before a turn is finished. When all the events that have occurred end, the top screen 210 related to the next turn is displayed.

Note that an SS parameter and an SS level are set as parameters for each team member. The SS parameter and the SS level are parameters associated with each team member. The SS parameter is configured with four levels of 0 to 3, and the SS level is configured with five levels of 1 to 5, for example. At the start of the nurture main game, the Ss level of all team members is set to level 1, and the level of the SS parameters is set to “0”.

As illustrated in FIG. 20, in the training screen 220, a star gauge 225 is displayed on the left side of the arranged character icon 224. The star gauge 225 displays the current SS parameter and SS level of the team member corresponding to the arranged character icon 224. In the star gauge 225, the current SS parameter is indicated by a gauge divided into three regions.

Specifically, when the level of the SS parameter is “1”, the lower region of the three regions is displayed in black and the middle and upper two regions are displayed in white as in the star gauge 225 located relatively higher from among the two star gauges 225 in FIG. 20. In addition, in a case where the level of the SS parameter is “2”, the lower and middle two regions of the three regions are displayed in black and the upper region is displayed in white as in the star gauge 225 located relatively lower in FIG. 20. Although not illustrated, when the level of the SS parameter is “0”, all of the three regions are displayed in white, and when the level of the Ss parameter is “3”, all of the three regions are displayed in black.

A bonus mark 225a is displayed on the upper portion of the star gauge 225. Each team member is set with a bonus training. Specifically, one from among the five training items of speed, stamina, power, spirit, and wisdom is associated in advance as a bonus training with the member ID associated with the team member. Thus, the team member is assigned a bonus training corresponding to the member ID associated with the team member. Thus, even for the same character, different bonus training may be set for each nurture game due to the different assigned member IDs.

The bonus mark 225a suggests a bonus training of the team member. Note that when the character of the team member is a support character, the character is associated with two types of training, the favored training set for the support card and the bonus training as a team member. At this time, the bonus training may be the same as or different from the favored training.

A reward mark 225b is displayed near the star gauge 225. The reward mark 225b suggests an additional reward to be acquired when the nurture target character wins against the team member in the SS match described below.

When the team member is successful in the joint training they are arranged in, the SS parameters of all team members arranged in the successful joint training are increased. Here, when the normal joint training is successful, the SS parameter is increased by one level. In addition, when friendship training occurs, the SS parameter of the arranged team member is increased by two levels. However, “3” is set as the upper limit for each SS level in the SS parameter. Thus, for example, in the training in which the team member having an SS parameter level of “2” is arranged, when the friendship training occurs, the SS parameter level of the team member is increased to “3”.

Then, the team member whose SS parameter has reached the upper limit is arranged and associated with “SS match” which is a training item. By at least one team member being arranged in an “SS match”, the “SS match” training item is enabled. In other words, when there are one or more team members whose SS parameter has reached the upper limit, the player can execute the “SS match”. A team member whose SS parameter has reached the upper limit is always arranged in the “SS match”, unlike training other than the “SS match”. Thus, in a case where a reward that the player wants to acquire is associated with a team member, the player can perform training with the desired team member without fail.

Accordingly, when there is not one team member whose SS parameter has reached the upper limit, the player cannot execute the “SS match”. In this manner, when the “SS match” cannot be executed, the SS match operation portion 221f is displayed in a gray-out manner as illustrated in FIG. 20. In this state, the SS match operation portion 221f is disabled.

When arrangement or not of team members in the “SS match” is determined, next, it is determined whether or not to arrange a team member in the “Race” to be held in this turn. At this time, the team members arranged in the “SS match” are not arranged in the “Race”. When arrangement or not of team members in the “SS match” and the “Race” is determined, next, the arrangement or not in each training item is determined for each team member. At this time, each team member can be arranged in each training item regardless of whether or not the team member is arranged in the “SS match” or the “Race”. That is, a team member may be arranged in both the “SS match” or the “Race” and any one training item in one turn. Since the team members determined to be arranged in the “SS match” and “Race” are also arranged by lottery in other training, it is possible to prevent the members from being unbalanced toward one of the trainings and the options for performing the joint training from being reduced.

Then, when the enabled SS match operation portion 221f is operated by the player, the SS match is executed as the training. Although details will be described below, the SS match is a match in which the nurture target character competes 1 vs 1 against a team member. When the SS match is executed, the SS level of the team member who competed against the nurture target character is raised by “1”. At the same time, the level of the SS parameter is reset to “0”.

An information operation portion 226 is displayed in the upper left portion of the training screen 220. When the information operation portion 226 is operated, an SS match information dialog 300 is displayed.

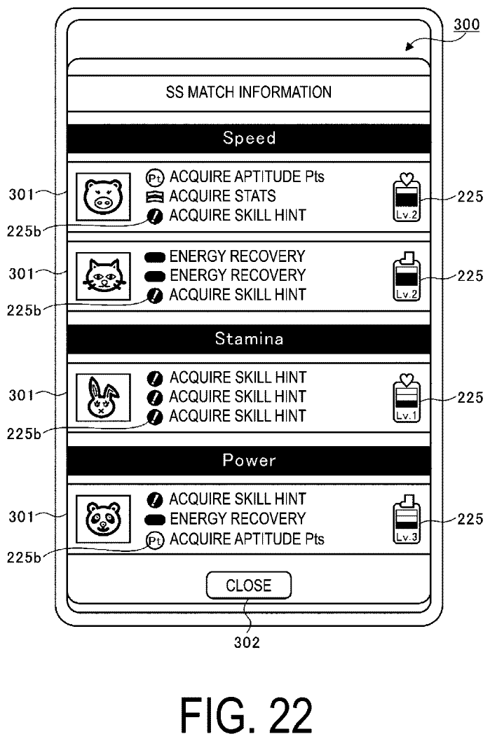

FIG. 22 is a diagram for describing the SS match information dialog 300. The SS match information dialog 300 is provided with a plurality of team member information fields 301. The team member information fields 301 are provided for each team member. In other words, the team member information fields 301 correspond to any one team member. As described above, the bonus training is set for each team member. In the SS match information dialog 300, team member information fields 301 are classified and displayed for each bonus training set for the team member. In FIG. 22, four team member information fields 301 are illustrated, but other team member information fields 301 are displayed by inputting a slide operation in the vertical direction in the SS match information dialog 300.

Icons representing characters are displayed on the left side of the team member information fields 301. The icons allow the team member information displayed in the team member information fields 301 to be identified.

The star gauge 225 is displayed on the right side of the team member information field 301, and the current SS parameter and SS level of the team member can be confirmed. In addition, three additional rewards are displayed in the team member information field 301. As described above, in the SS match, when the nurture target character wins against the team member as the opponent, an additional reward is given to the nurture target character. At this time, one additional reward is given to the nurture target character.

At the start of the nurture main game, three additional rewards are determined for all team members. At this time, the order of giving the three additional rewards to the nurture target character is set. In the team member information field 301, the additional reward that is given earlier among the three additional rewards is displayed higher. That is, in the SS match, the next time the nurture target character wins against a predetermined team member, the additional reward displayed highest in the team member information field 301 is given. After that, when the nurture target character wins against a predetermined team member in the SS match, the additional reward displayed in the middle of the team member information field 301 is given.

When the number of additional rewards to be given is two, the giving order is newly determined for the three additional rewards determined at the start of the nurture main game. For example, take an example in which the first additional reward from among the three additional rewards determined at the start of the nurture main game is given to the nurture target character. In this case, since the remaining number of additional rewards to be given is two, the giving order of three additional rewards is newly determined. As a result, a total of five additional rewards are set as additional rewards to be given to the team member. However, even in this case, only three additional rewards, which are the first to third additional rewards in the order of being given to the nurture target character, are displayed in the team member information field 301.

Thereafter, when the SS match is further executed and the nurture target character wins the battle against the team member three times, three additional rewards are given to the nurture target character. In this case, the remaining additional rewards to be given again becomes two, and the giving order of the three additional rewards is newly determined at this time.

Here, it is assumed that three additional rewards are determined at the start of the nurture main game. Then, during the nurture main game, the giving order of the three additional rewards determined at the start of the nurture main game is additionally determined. Thus, the number of types of additional rewards associated with one team member is three at maximum. However, during the nurture main game, an additional reward different from that at the start of the nurture main game may be determined through a lottery.

In addition, for example, for some characters such as the scenario link characters, the additional rewards to be given and the giving order may be set in advance. In addition, the additional rewards to be given and the giving order may be set in advance for all the characters.

In addition, in a case where the additional rewards are determined through a lottery, a new additional reward may be determined through a lottery every time one additional reward is given. Alternatively, at the start of the nurture main game, a predetermined number (for example, 10 to 20) of additional rewards may be determined by lottery for each team member. In this case, when all of the predetermined number of additional rewards set for one team member are given, the additional rewards may be given again in order from the first additional reward as a second round.

Here, acquisition of an aptitude point, acquisition of a status, acquisition of a skill hint, energy recovery, and the like are provided as additional rewards. However, the contents of the additional rewards here are merely examples, and many other additional rewards may be provided. Here, the content of the additional reward determined through the lottery may be different for each team member. For example, the type of additional reward that can be determined by lottery may be determined in advance according to the type of character and the member ID.

In the team member information field 301, the reward mark 225b is displayed together with text indicating the content of the additional reward. As described above, the reward mark 225b is also displayed near the star gauge 225 on the training screen 220. On the training screen 220, only one reward mark 225b corresponding to the additional reward to be given next is displayed (see FIG. 20).

In addition, a close operation portion 302 is provided at the bottom of the SS match information dialog 300. When the close operation portion 302 is operated, the SS match information dialog 300 is hidden, and the training screen 220 is displayed.

As illustrated in FIG. 19, when the information button 217a of the details icon 217 displayed on the top screen 210 is operated, the team member dialog 310 is displayed.

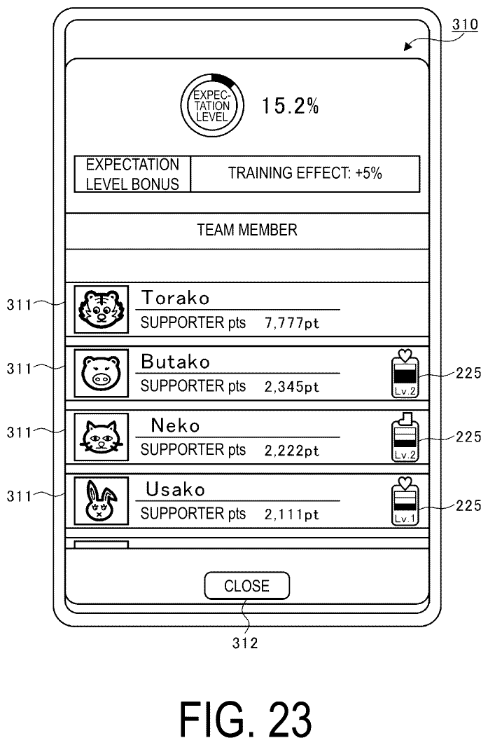

FIG. 23 is a diagram for describing the team member dialog 310. The team member dialog 310 is provided with a plurality of character information fields 311. The character information field 311 is provided for each of the nurture target character and the team members. In other words, the character information field 311 corresponds to the nurture target character or any one of the team members.

Although four character information fields 311 are illustrated in FIG. 23, another character information field 311 is displayed by inputting a slide operation in the vertical direction in the team member dialog 310. In the team member dialog 310, the uppermost character information field 311 corresponds to the nurture target character. In addition, here, the character information field 311 of the team member having higher supporter points is displayed higher up in the team member dialog 310.

Icons representing characters are displayed on the left side of the character information fields 311. The icons allow the character information displayed in the character information fields 311 to be identified.

The star gauge 225 is displayed on the right side of the character information field 311 corresponding to the team member, and the current SS parameter and SS level of the team member can be confirmed. In addition, the name of the character and the current supporter points are displayed in the character information field 311.

The current expectation level is displayed at the top of the team member dialog 310. As described above, the expectation level is calculated based on the total point of the supporter points of the nurture target character and the team members. The higher the total points, the higher the expectation level. Then, in the present embodiment, an expectation level bonus corresponding to the expectation level is given to the nurture target character. For example, an expectation level bonus is provided in which the increase value of the ability parameter that increases when the training is successful increases by 5%. The team member dialog 310 displays the expectation level bonus currently given.

The time period in which the effect of the expectation level bonus is applied is not particularly limited. For example, the effect of the expectation level bonus once obtained may be continued until the nurture main game is finished. Alternatively, the number of turns may be set as the time period during which the effect continues. Further, the duration of the effect may end at the time when a predetermined event occurs during the nurture main game.

In addition, a close operation portion 312 is provided at the bottom of the team member dialog 310. When the close operation portion 312 is operated, the team member dialog 310 is hidden, and the top screen 210 is displayed.

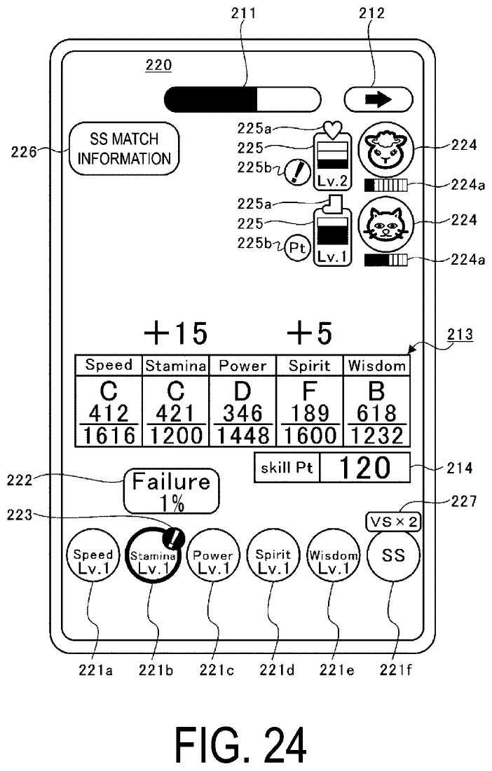

FIG. 24 is a fourth diagram for describing the training screen 220. When a team member is arranged in (associated with) the training item “SS match”, the SS match operation portion 221f is enabled as illustrated in FIG. 24. At this time, a character number display icon 227 is displayed on the upper portion of the SS match operation portion 221f. The character number display icon 227 displays “VS×n (n is an integer of 1 to 5)”. The symbol n in “VS×n” indicates the number of team members arranged in the training item “SS match”.

In the example illustrated in FIG. 24, “VS×2” is displayed, and this suggests that two team members are arranged in the training item “SS match”. When the SS match operation portion 221f is operated in the state illustrated in FIG. 24, the “SS match” is provisionally selected. In the “SS match” provisionally selected state, the training screen 220 becomes an SS match provisional selection screen 320.

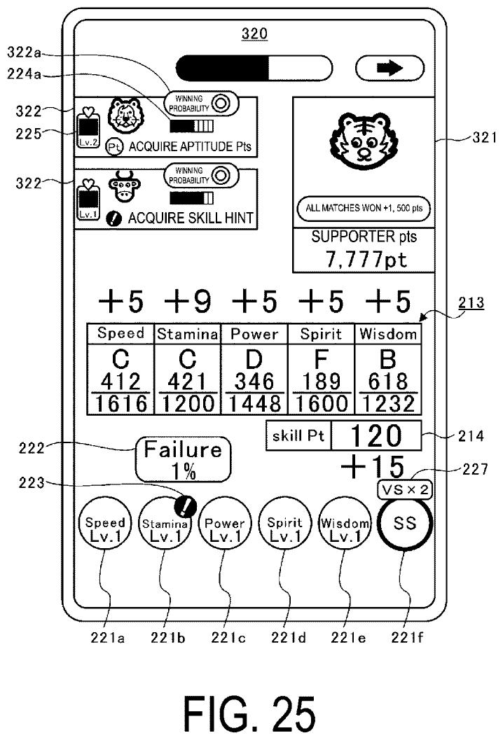

FIG. 25 is a diagram for describing the SS match provisional selection screen 320. The SS match provisional selection screen 320 displays the stats display portion 213, the skill point display portion 214, the operation portion 221, the failure probability display portion 222, and the event notification display 223, in a similar manner to the normal training screen 220. As described above, the SS match is a game in which the nurture target character competes 1 vs 1 against a team member whose SS parameter has reached the upper limit.

Although details will be described below, at the start of a turn, team members whose SS parameter has reached the upper limit are extracted. At this time, when the number of extracted team members is five or less, all the extracted team members are determined as opponents. On the other hand, when the number of extracted team members is six or more, five team members are determined as opponents through a lottery from among the extracted team members. That is, in one SS match, a maximum of five team members are determined as opponents. For example, whether the SS parameter has reached the upper limit for each team member may be confirmed in order, and the processing may be terminated when five team members whose SS parameter has reached the upper limit are extracted.

Then, when the team members to be the opponents are determined, a winning probability, which is the probability that the nurture target character wins, is set for each opponent. The winning probability is calculated mainly based on the evaluation score associated with the nurture target character and the evaluation score associated with the team member as the opponent. The evaluation score is calculated based on parameters that are referred to mainly when deriving the race result, such as the current ability parameters, the aptitude parameters, and the acquired skills. That is, the evaluation score is a parameter comprehensively representing the strength of the character in the race, and the stronger the character, the higher the evaluation score. The parameters used for calculating the evaluation score may include parameters unrelated to the race result, such as the number of fans.

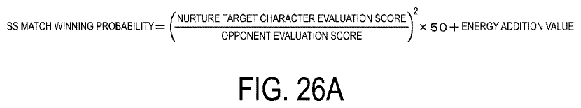

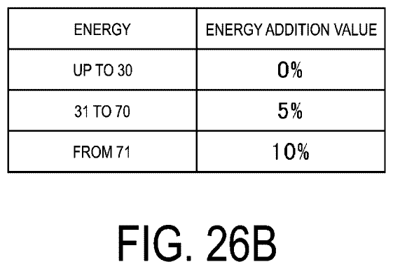

FIG. 26A is a diagram for describing a calculation formula for the winning probability. FIG. 26B is a diagram for describing an energy addition value. The winning probability of the SS match is calculated based on the calculation formula illustrated in FIG. 26A. That is, the winning probability of the SS match is calculated by (evaluation score of the nurture target character÷evaluation score of the opponent)²×50+“energy addition value”. Here, the energy addition value is specified based on the current energy of the nurture target character, as illustrated in FIG. 26B.

Specifically, the energy of the nurture target character is set as an integer of 0 to 100. The energy addition value is 0% when the energy of the nurture target character is 30 or less, 5% when the energy ranges from 31 to 70, and 10% when the energy is 71 or more.

As described above, the higher the evaluation score of the nurture target character is compared to the evaluation score of the opponent, the higher the winning probability of the SS match becomes. Further, the higher the energy of the nurture target character, the higher the winning probability of the SS match. The above-described calculation formula for the winning probability of the SS match is merely an example. The parameters used when calculating the winning probability of the SS match are not limited to the evaluation score and the energy described above, and other parameters may be used.

For example, a correction value based on the energy may be applied instead of the energy addition value. Specifically, in this example, a correction value of −80% is applied when the energy ranges from 0 to 1, a correction value of −50% is applied when the energy ranges from 2 to 9, a correction value of −20% is applied when the energy ranges from 10 to 19, and a correction value of 0% is applied when the energy is 20 or more. In this manner, a negative correction value corresponding to the energy may be applied instead of the energy addition value described above.

Further, for example, only the correction value based on the energy may be used as a parameter for calculating the winning probability. In this case, the winning probability may be calculated by adding a negative correction value corresponding to the energy to a reference value. The reference value may be a fixed value such as 100%. Alternatively, the reference value may be a value calculated based on the SS level or the SS parameter.

Further, as a parameter used when calculating the winning probability of the SS match, a parameter of “mood” may be applied. For example, an addition correction value in a case where the “mood” is the best mood and a subtraction correction value in a case where the “mood” is the worst mood may be provided, and these correction values may be added to, subtracted from, multiplied by, or divided by the reference value. Further, the correction value based on the parameter of “mood” and the negative correction value corresponding to the energy may be added to, subtracted from, multiplied by, or divided by the reference value.

As described above, by changing the winning probability depending on the execution timing of the SS match, it is possible to make the player enjoy the tactics of whether or not to execute the SS match.

Then, when the SS match operation portion 221f is operated again with the training item “SS match” in a provisionally selected state, the SS match is executed. When the SS match is executed, whether the nurture target character wins or loses is determined for each opponent based on the winning probability calculated at the start of the turn. Winning or losing is determined through a lottery. For example, when the winning probability is 70%, a lottery is performed in which a win is derived with a probability of 70% and a loss is derived with a probability of 30%. Accordingly, whether the nurture target character wins or loses is determined for each opponent.

When the SS match is executed, the competition is executed with all team members associated with the SS match. Thus, the player can wait for a large number of team members to be associated with the SS match, and then can compete in the SS match against them all at once. Since one turn is consumed for the execution of the SS match, the number of turns required for the SS match can be reduced by executing the SS match after waiting for a large number of team members to be associated with the SS match.

On the other hand, as described above, the SS parameter of the team member is reset by the execution of the SS match. In other words, if the SS match is not executed, the SS parameter of the team member remains at the upper limit, and the SS parameter and the SS level do not increase even if the training is performed. Thus, unless the SS match is executed with a large number of team members associated with the SS match, the SS level of the team members is less likely to increase. In this manner, high strategic performance is required from the player in relation to the timing of executing the SS match, and this increases the player's motivation to play.

Referring back to FIG. 25, on the SS match provisional selection screen 320, the increase values of various parameters are displayed near the stats display portion 213 and the skill point display portion 214. When the SS match is executed, all the ability parameters and the skill points are increased regardless of whether the nurture target character wins or loses. That is, when the SS match is executed, the increase value of the ability parameters and the skill points are given as a basic reward. In addition, the increase values of the ability parameters are added to the bonus training of the opponent team member. That is, the ability parameter that matches the bonus training of the opponent team member has a larger increase value than the other ability parameters. When the SS match is executed, only the ability parameter that matches the bonus training of the opponent team member may be increased. Further, for example, in a case where the nurture target character wins in the SS match, the ability parameter that matches the bonus training of the opponent team member may be increased as the additional reward.

Note that the content of the basic reward is not particularly limited. For example, the basic reward may change depending on the number of times of execution of the SS match or the number of wins, the number of opponents of the SS match of this time, the number of wins, the winning probability, and the like. For example, the higher the SS level of the opponent team member, the greater the basic reward may be.

In the present embodiment, a winning reward is given to the nurture target character separately from the basic reward. Here, supporter points are given as a winning reward. A point display region 321 is provided on the SS match provisional selection screen 320. In the point display region 321, the supporter points of the current nurture target character is displayed. In addition, the supporter points (here, 1,500) given when all opponents are beaten are displayed in the point display region 321. The winning reward includes the additional rewards described above. The supporter points may be given as a basic reward separately from the winning reward or in addition to the winning reward.

In addition, an opponent information display field 322 is displayed on the SS match provisional selection screen 320. The opponent information display field 322 is provided for each opponent. In the example illustrated in FIG. 25, two team members are determined as opponents, and two opponent information display fields 322 are displayed. In the opponent information display field 322, a character icon indicating an opponent, the star gauge 225, the bond gauge 224a, and an additional reward to be acquired when the nurture target character wins are displayed.

In addition, a winning probability icon 322a is provided in the opponent information display field 322. A winning probability mark corresponding to the winning probability is displayed in the winning probability icon 322a. The winning probability mark is provided in four patterns of, for example, ⊚, ◯, Δ, and x. The player can estimate the winning probability of each opponent to some extent via the winning probability mark. The winning probability icon 322a is used to determine whether or not to execute the SS match.

Although not illustrated, when the SS match is executed, an individual match-up screen is displayed. The individual match-up screen notifies of whether or not the nurture target character has won the competition against the opponent. When there are a plurality of opponents, the individual match-up screen is repeatedly displayed a plurality of times. When the display of all the individual match-up screens is finished, the reward acquired by the nurture target character is notified, and the stats are updated.

As described above, in the nurture main game of the present embodiment, the various parameters are increased by the nurture target character executing training including the SS match. As the parameters of the nurture target character increases, the winning probability of the nurture target character in the races increases.

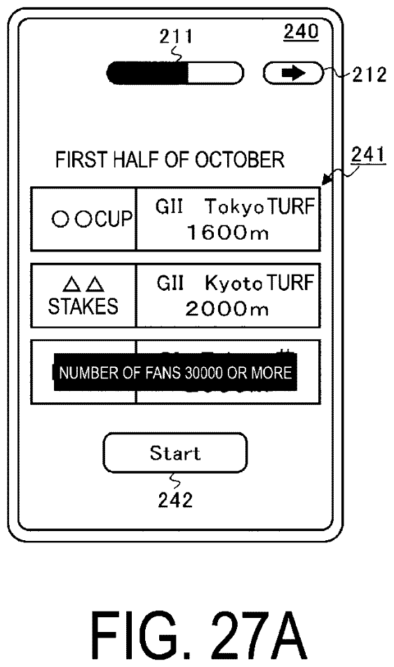

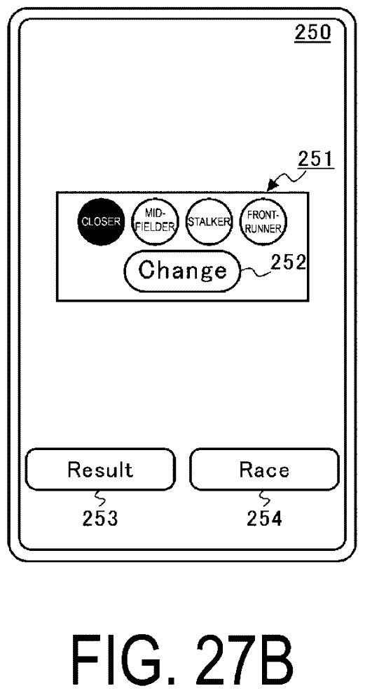

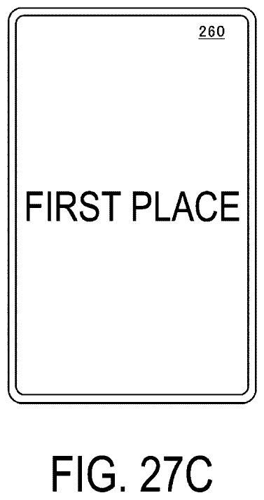

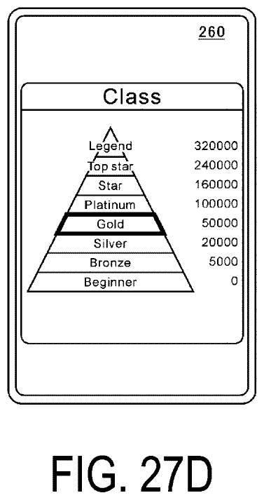

FIG. 27A is a first diagram for describing a race selection screen 240. When the race operation portion 215g of the top screen 210 is operated, the race selection screen 240 illustrated in FIG. 27A is displayed. Races have a game property in which the nurture target character races with a non-player character (hereinafter, referred to as NPC).

In an upper portion on the race selection screen 240, an energy display portion 211 and a mood display portion 212 are displayed. In addition, in a central portion on the race selection screen 240, a race selection operation portion 241 is displayed for selecting a race event in which the nurture target character is made to enter. In addition, in a lower portion on the race selection screen 240, a start operation portion 242 is displayed. A race that can be selected via the race selection operation portion 241 on the race selection screen 240 is set in advance for each turn.

In addition, the race entry condition is set in advance for each race, and the player can only make the nurture target character enter a race with race entry conditions being satisfied. As described above, a race may have the number of fans defined as a race entry condition. For a race short of the defined number of fans, as illustrated in FIG. 27A, the race selection operation portion 241 displays the race entry condition and notifies that the race cannot be selected. In the turn in which the target race of the clear goal is set, only the target race is displayed in a selectable manner on the race selection screen 240.

FIG. 27B is a diagram for describing a race start screen 250. When the start operation portion 242 is operated in a state where the race event of the race to participate in is selected by the race selection operation portion 241, the race start screen 250 illustrated in FIG. 27B is displayed. In a central portion on the race start screen 250, a strategy display portion 251 is displayed. In the strategy display portion 251, a strategy currently selected (closer, midfielder, stalker, or front-runner) is highlighted. A change operation portion 252 is also displayed in the strategy display portion 251. When the change operation portion 252 is operated, a strategy change screen (not illustrated) is displayed on the display 26. The player can change the strategy in the race to any strategy by an operation on the strategy change screen.

Further, in a lower portion on the race start screen 250, a result operation portion 253 and a race operation portion 254 are displayed. When the race operation portion 254 is operated, a race screen (not illustrated), that is, a race video, is displayed on the display 26.

FIG. 27C is a first diagram for describing a race result screen 260. FIG. 27D is a second diagram for describing the race result screen 260. When playback of the race moving image described above ends and when the result operation portion 253 is operated, the race result screen 260 is displayed on the display 26. On the race result screen 260, as illustrated in FIG. 27C, the placing of the nurture target character in the race is displayed. Further, on the race result screen 260, as illustrated in FIG. 27D, the current class of the nurture target character is displayed.

In the present embodiment, the nurture target character is classified according to the obtained number of fans. A range of the number of fans is set for each class. Here, the nurture target character is classified into one of eight stages of classes according to the number of fans. Further, on the race result screen 260, the cumulative number of fans obtained by adding the number of fans newly obtained in the latest race to the number of fans obtained before is displayed. In addition, the current class corresponding to the cumulated number of fans is displayed to be distinguished.

As described above, in the present embodiment, races are roughly classified into normal races and special races. As illustrated by ⊚ in FIG. 18, all the special races are set as goal races, and the player has to enter the nurture target character into the special races on the 41st turn, the 43rd turn, the 65th turn, and the 67th turn. As described above, the present scenario is set such that the normal races are domestic races and the special races are overseas races, and there is a story-like narrative in which the aim is to win an overseas race. In order to further enhance the story-like narrative, in the present scenario, the difficulty specific to overseas races is expressed in the game.

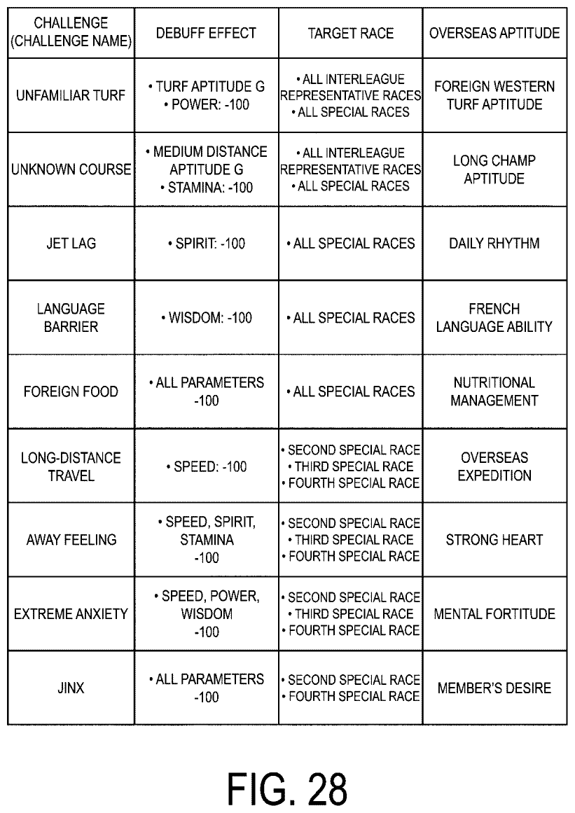

FIG. 28 is a diagram for describing challenges faced in interleague representative races and special races. In the nurture main game, the challenges indicated in FIG. 28 are provided for the interleague representative races and the special races. Each challenge is provided with a name (challenge name). Here, the challenges that are generally specific to overseas races and include “Unfamiliar turf”, “Unknown course”, “Jet lag”, “Language barrier”, “Foreign food”, “Long-distance travel”, “Away feeling”, “Extreme anxiety”, and “Jinx”, are set.

A debuff effect to be activated in the target race is set for each challenge. The debuff effect is a negative effect that makes the race disadvantageous for the nurture target character. For example, the debuff effect of the challenge “Unfamiliar turf” is activated in every interleague representative race and special race. When the debuff effect of the challenge “Unfamiliar turf” is activated, the turf aptitude of the nurture target character is set to “G” and the power parameter is set to “−100”.

For example, the debuff effect of the challenge “Unknown course” is activated in every interleague representative race and special race. When the debuff effect of the challenge “Unknown course” is activated, the medium distance aptitude of the nurture target character is set to “G” and the stamina parameter is set to “−100”.

For example, the debuff effect of the challenge “Jinx” is activated in the 2nd special race and the 4th special race. When the debuff effect of the challenge “Jinx” is activated, all of the ability parameters of the nurture target character are set to “−100”.

Thus, for example, all the challenges indicated in FIG. 28 are set in the 2nd special race and the 4th special race, and all the debuff effects are activated, so that the nurture target character is extremely disadvantageous in the development of the race. In this manner, the interleague representative races and the special races are set such that it is difficult for the nurture target character to win due to the activation of the debuff effects.

However, each challenge is associated with an overseas aptitude. The nurture target character can acquire overseas aptitude by satisfying a predetermined acquisition condition. Overseas aptitude is associated with an effect that overcomes a corresponding challenge. For example, when the nurture target character acquires the overseas aptitude “Foreign Western turf aptitude”, the challenge “Unfamiliar turf” is overcome. By overcoming the challenge “Unfamiliar turf”, the debuff effect corresponding to the challenge is not activated. Thus, the player needs to acquire the necessary overseas aptitude by the turn in which the interleague representative race or the special race is executed.

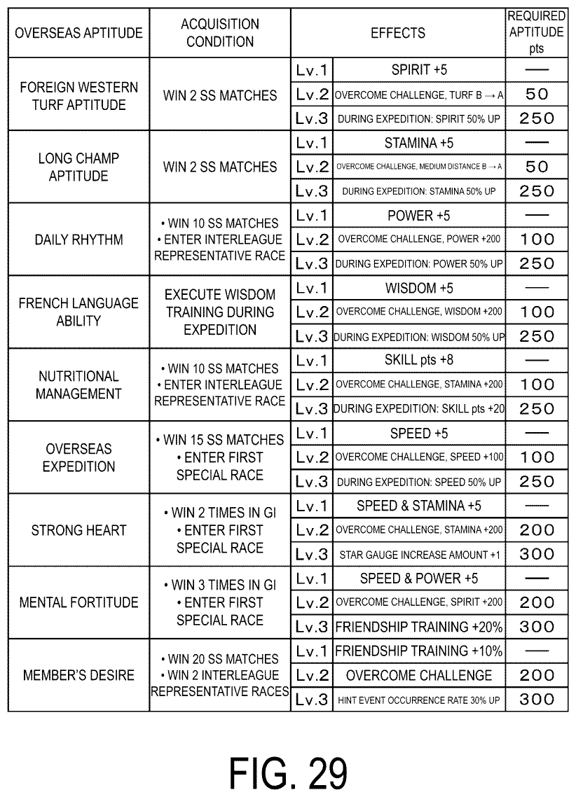

FIG. 29 is a diagram for describing overseas aptitude. As illustrated in FIG. 29, an acquisition condition is set for each overseas aptitude, and the nurture target character can acquire the overseas aptitude for which the acquisition condition is satisfied. For example, the overseas aptitude “Foreign Western turf aptitude” and “Long champ aptitude” are set with the acquisition condition of winning two SS matches. Thus, when the nurture target character wins two SS matches during the nurture main game, the overseas aptitude “Foreign Western turf aptitude” and “Long champ aptitude” are acquired at the same time.

Here, an aptitude level parameter is associated with each overseas aptitude. In the present embodiment, three levels of aptitude level from “1” to “3” are provided. When each overseas aptitude is acquired, the aptitude level is set to “1”. In other words, when the acquisition condition is satisfied, the nurture target character newly acquires the overseas aptitude with the aptitude level of “1”.

The effect of each aptitude level is associated with each overseas aptitude. For example, an effect that the “Spirit” ability value at the time of training success is “+5” is associated with the aptitude level “1” of the overseas aptitude “Foreign Western turf aptitude”. Also, for example, an effect that the “Stamina” ability value at the time of training success is “+5” is associated with the aptitude level “1” of the overseas aptitude “Long champ aptitude”.

In addition, two effects of overcoming a challenge and improving turf aptitude are associated with the aptitude level “2” of the overseas aptitude “Foreign Western turf aptitude”. The effect of overcoming a challenge is an effect of overcoming the challenge “Unfamiliar turf” corresponding to the overseas aptitude “Foreign Western turf aptitude”. Thus, when the aptitude level 2 of the overseas aptitude “Foreign Western turf aptitude” is acquired, the debuff effect of the challenge “Unfamiliar turf” is not activated in the target race.

Also, improving turf aptitude is an effect that targets a nurture target character with a turf aptitude of “B” or less and is an effect that the turf aptitude becomes “A” in the nurture main game thereafter. The effect of increasing the turf aptitude is not limited to the interleague representative races and the special races and is also activated in the normal races. Thus, in the present scenario, for example, even in a case where a character with a turf aptitude of “G” is selected as the nurture target character, the nurture main game can be progressed through in a similar manner to a case where a character with a turf aptitude of “A” is selected as the nurture target character.

Accordingly, the player can nurture a character that is not originally suitable for the present scenario, such as a character whose turf aptitude is set to “G”, as the nurture target character.

However, the effect of increasing the turf aptitude is limited to inside of the nurture game. Specifically, in the present embodiment, when the nurturing of the nurture target character ends, the nurture target character nurtured in the nurture game is stored as a nurtured character. Among the various parameters of the nurture target character, the final ability parameters, the aptitude parameters, the acquired skills, and the like in the nurture game are inherited by the nurtured character.

However, the effects that are activated by the acquisition of the overseas aptitudes are limited to inside of the nurture game. Thus, for example, even if the turf aptitude of the nurture target character is changed from “G” to “A” by acquiring the aptitude level 2 of the overseas aptitude “Foreign Western turf aptitude”, the turf aptitude of the nurtured character becomes “G” when the nurture game is completed.

In a similar manner, two effects of overcoming a challenge and improving medium distance aptitude are associated with the aptitude level “2” of the overseas aptitude “Long champ aptitude”. The effect of overcoming a challenge is an effect of overcoming the challenge “Unknown course” corresponding to the overseas aptitude “Long champ aptitude”. Thus, when the aptitude level 2 of the overseas aptitude “Long champ aptitude” is acquired, the debuff effect of the challenge “Unknown course” is not activated in the target race.

Also, improving medium distance aptitude is an effect that targets a nurture target character with a medium distance aptitude of “B” or less and is an effect that the medium distance aptitude becomes “A” in the nurture main game thereafter. The effect of increasing the medium distance aptitude is not limited to the interleague representative races and the special races and is also activated in the normal races. Thus, in the present scenario, for example, even in a case where a character with a medium distance aptitude of “G” is selected as the nurture target character, the nurture main game can be progressed through in a similar manner to a case where a character with a medium distance aptitude of “A” is selected as the nurture target character.

However, the effect of increasing the medium distance aptitude is limited to inside of the nurture game. Thus, for example, even if the medium distance aptitude of the nurture target character is changed from “G” to “A” by acquiring the aptitude level 2 of the overseas aptitude “Long champ aptitude”, the medium distance aptitude of the nurtured character becomes “G” when the nurture game is completed.

Note that, here, the effect of increasing the aptitude parameter by acquiring the aptitude level 2 of the overseas aptitude is limited to inside of the nurture game. However, when the aptitude parameter is increased due to the acquisition of the aptitude level 2 of the overseas aptitude, the increased aptitude parameter may be inherited by the nurtured character.

The race result is derived mainly based on the ability parameters, the aptitude parameters, and the acquired skills. At this time, the calculation is performed so that the race result becomes more advantageous as the values of the ability parameters and the aptitude parameters become higher and as the number of acquired skills becomes larger. Here, two challenges and two overseas aptitudes related to the aptitude parameters are provided, and the other challenges and overseas aptitudes are mainly related to the ability parameters and the effects at the time of training execution as illustrated in FIGS. 28 and 29.

Here, the overseas aptitude always corresponds to one challenge, and the effect of overcoming the corresponding challenge is setting the aptitude level to “2” in all cases. Thus, the nurture target character cannot overcome the challenge only by acquiring overseas aptitude. As illustrated in FIG. 29, the necessary aptitude points are set to the aptitude levels “2” and “3” of the respective overseas aptitude. When the player has already acquired the overseas aptitude of the aptitude level “1”, the player can acquire the aptitude level “2” or “3” of the overseas aptitude by spending aptitude points.

Note that, although the effect of overcoming a challenge is associated with the aptitude level “2” for all the overseas aptitudes, this is merely an example. For example, the effect of overcoming a challenge may be associated with the aptitude level “1”. In addition, the aptitude level associated with the effect of overcoming a challenge may be varied depending on the type of the overseas aptitude. In addition, although all the overseas aptitudes are always associated with one challenge here, an overseas aptitude that is not associated with a challenge may be provided. Also, challenges may be provided that are not overcome by the acquisition of overseas aptitude.

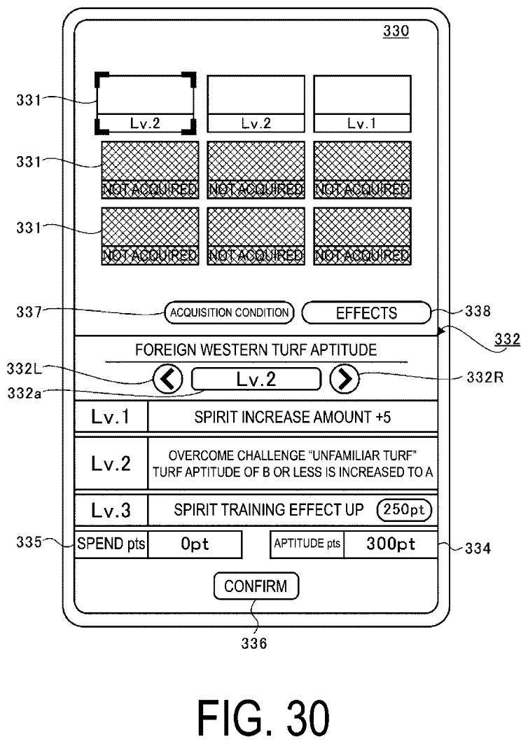

FIG. 30 is a diagram for describing an overseas aptitude acquisition screen 330. When the overseas aptitude operation portion 215f is operated on the top screen 210, the overseas aptitude acquisition screen 330 illustrated in FIG. 30 is displayed. The player can acquire overseas aptitude by an operation input on the overseas aptitude acquisition screen 330.

An overseas aptitude icon 331 corresponding to the overseas aptitude is displayed on the overseas aptitude acquisition screen 330. The overseas aptitude icon 331 corresponds to any one of the overseas aptitudes. The overseas aptitude icon 331 displays the aptitude level that has been acquired at present of the corresponding overseas aptitude. However, the overseas aptitude icon 331 corresponding to the overseas aptitude that has not been acquired is displayed as “Not acquired” and is displayed in a gray-out manner as indicated by cross-hatching in the diagram.

When the player performs an operation input to the overseas aptitude icon 331, the overseas aptitude corresponding to the overseas aptitude icon 331 on which the operation input has been performed is put in a selected state. An effect display field 332 is provided in a lower portion of the overseas aptitude acquisition screen 330. In the effect display field 332, the effect gained by the overseas aptitude in the selected state is displayed for each aptitude level. The effect display field 332 is provided with a selection aptitude level display portion 332a, a left button 332L, and a right button 332R.

The aptitude level currently selected by the player is displayed in the selection aptitude level display portion 332a. When the left button 332L is operated, the selected aptitude level is decremented by “−1”, and when the right button 332R is operated, the selected aptitude level is incremented by “+1”. That is, the player can change the selected aptitude level within the range of “1” to “3” by operating the left button 332L or the right button 332R.

The overseas aptitude acquisition screen 330 is provided with a possessed aptitude point display field 334 and a spend points display field 335. In the possessed aptitude point display field 334, the current aptitude points possessed by the nurture target character are displayed. In the spend points display field 335, the aptitude points necessary for acquiring overseas aptitude of the selected aptitude level in the selected state are displayed.

In the example illustrated in FIG. 30, the aptitude level “2” of the overseas aptitude “Foreign Western turf aptitude” has been acquired. In this manner, when the acquired aptitude level is displayed in the selection aptitude level display portion 332a, “0” is displayed in the spend points display field 335. In the effect display field 332, the field for displaying the effect of the unacquired aptitude level displays the aptitude points required to acquire the overseas aptitude of the aptitude level.

With the example illustrated in FIG. 30, consider a case in which the player operates the right button 332R and the selected aptitude level is updated to “3”. In this case, “250 pt” is displayed in the spend points display field 335. In this state, when a confirm operation portion 336 provided at the lowermost portion of the overseas aptitude acquisition screen 330 is operated, the nurture target character acquires the aptitude level “3” of the overseas aptitude “Foreign Western turf aptitude”.

Even when the aptitude level cannot be raised, such as when the aptitude points possessed by the nurture target character are insufficient, the aptitude level displayed in the selection aptitude level display portion 332a may be increased by operating the right button 332R. In this case, however, the confirm operation portion 336 may be set to be unable to receive an operation, or even if an operation is received, a pop-up such as “Condition not satisfied” may be displayed. In any case, the system may be configured so that the overseas aptitude cannot be acquired by spending the aptitude points when the aptitude level cannot be raised.

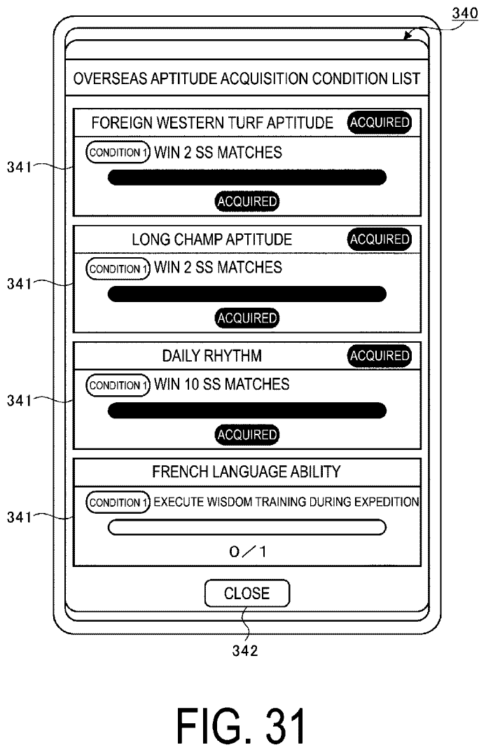

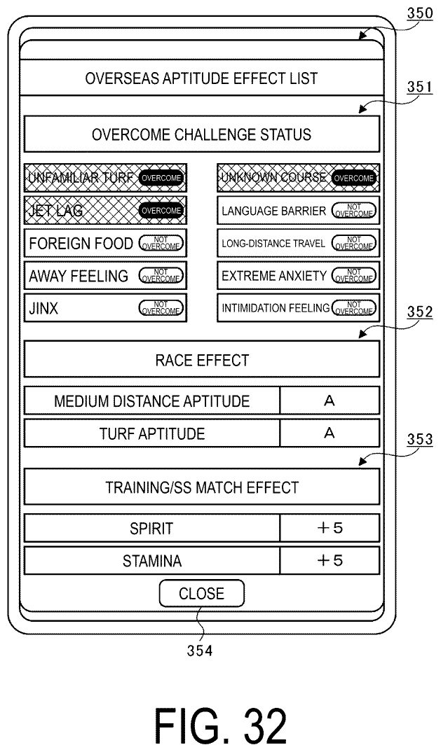

In addition, an acquisition condition button 337 and an effect button 338 are provided in the middle of the overseas aptitude acquisition screen 330. When the acquisition condition button 337 is operated, an acquisition condition list dialog 340 illustrated in FIG. 31 is displayed. When the effect button 338 is operated, an effect list dialog 350 illustrated in FIG. 32 is displayed.

FIG. 31 is a diagram for describing the acquisition condition list dialog 340. In the acquisition condition list dialog 340, a plurality of overseas aptitude display fields 341 corresponding the overseas aptitudes are displayed. The acquisition condition required to acquire the overseas aptitude of the aptitude level “1” are displayed in text in the overseas aptitude display field 341. The degree of achievement of the acquisition condition is visually displayed, and “Acquired” is displayed in the overseas aptitude display field 341 corresponding to the acquired overseas aptitude. A close operation portion 342 is provided at the bottom of the acquisition condition list dialog 340. When the close operation portion 342 is operated, the acquisition condition list dialog 340 is hidden, and the overseas aptitude acquisition screen 330 is displayed.

FIG. 32 is a diagram for describing the effect list dialog 350. The effect list dialog 350 displays a list of effects to be granted by acquiring the overseas aptitude. The effect list dialog 350 is provided with a challenge overcoming status display field 351. The challenge overcoming status display field 351 displays a list of challenges set for the interleague representative races and the special races. In the challenge overcoming status display field 351, whether each challenge has been overcome or not is displayed in an identifiable manner.

The effect list dialog 350 is provided with a race effect display field 352 and a training effect display field 353. In the race effect display field 352, all effects to be activated in the race are displayed in a list according to the acquired overseas aptitude. In addition, in the training effect display field 353, all effects to be activated in the training including the SS match are displayed in a list according to the acquired overseas aptitude. A close operation portion 354 is provided at the bottom of the effect list dialog 350. When the close operation unit 354 is operated, the effect list dialog 350 is hidden, and the overseas aptitude acquisition screen 330 is displayed.

As described above, in the nurture game of the present embodiment, the SS match and the acquisition of the overseas aptitude need to be executed at the optimal timing, and thus high strategic performance is required. In addition, since the player can select the overseas aptitude to be acquired depending on the nurture target character and the nurturing policy, it is easy to nurture any character, and it is possible to nurture a character according to the nurturing policy of the player. Hereinafter, a supplement description of the SS match described above will be given while describing the processing at the time of starting the turn.

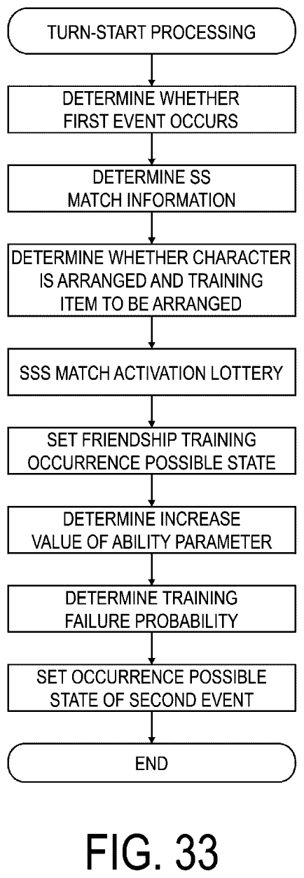

FIG. 33 is a diagram for describing a rough flow of turn-start processing. The nurture stage processing includes the turn-start processing executed upon starting of each turn of the nurture game. The rough flow of the turn-start processing is described here, and the details of the turn-start processing is described below. The turn-start processing described below is executed in a turn other than a race-limited turn, that is, a turn in which training can be selected.

During the nurture main game, processing to determine whether to cause various events to appear is executed in each turn. Events are roughly classified into three types: a scenario event, the above-described exclusive event provided for each nurture target character, and a support event. In each scenario, a scenario event, an exclusive event, and a support event that may appear during the nurture main game are predefined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears shared across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears. As described above, the support event is an event set in advance for each support card. In the nurture main game, a support event associated with the support card registered by the player in the setting game appears. The support event includes a first event that may occur upon starting of a turn and a second event that may occur after training is performed. Upon starting of a turn, whether to cause the first event to occur is determined based on a random number obtained at random and a first event table.

Whether to cause the second event to occur is determined based on a randomly obtained random number and a second event table after the determination processing for each support character arranged in the training is performed. Note that whether to cause the second event to occur is determined for the arranged support character only in a case where a support character is arranged in training.

Note that in the present embodiment, the support event that may be selected for the first event is associated with the support card, which is not limited to that support card registered in the deck by the player in the preparation stage processing, but is selected through a lottery from among all support cards implemented in the game. However, a selection probability of the support event associated with the support card registered in the deck is higher than a selection probability of the support card event associated with the support card not registered in the deck.

As described above, whether a scenario event appears is determined based on the scenario. Also, whether an exclusive event and a support event appear is determined based on the nurture target character and the support card, respectively. These event types are classified by information that is referenced when determining whether an event appears.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or acquire a skill. The first ability event and the second ability event are events for increasing or decreasing the ability parameter for the nurture target character. The aptitude event is an event for increasing or decreasing the aptitude parameter for the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes processing of determining a scenario event and processing of determining an exclusive event. Note that, here, the illustration and description of the processing of determining the scenario event and the processing of determining the exclusive event are omitted. The turn-start processing includes “processing of determining whether to cause the first event to occur”, “processing of determining SS match information”, “processing of determining whether the character is arranged and the training item to be arranged”, “processing of setting the friendship training occurrence possible state”, “processing of determining the increase value of the ability parameter”, “processing of determining the failure probability of the training”, and “processing of setting the occurrence possible state of the second event” illustrated in FIG. 33. Although various other processing is executed in the turn-start processing, the processing illustrated in FIG. 33 will be sequentially described here.

### Processing of Determining Whether to Cause First Event to Occur

In the processing of determining whether to cause the first event to occur, the first event to occur is determined through a lottery from among the support events associated with all the support cards provided by the operator. At this time, the success probability of the support event associated with the support card registered in the deck by the player in the preparation stage processing is set to be higher.

### Processing of Determining SS Match Information

At the start of a turn, the SS match information is determined. The SS match information is various kinds of information related to the SS match. In the processing of determining the SS match information, first, all team members whose SS parameters have reached the upper limit are extracted at the start of the turn. At this time, if the number of extracted team members is five or less, all the extracted team members are associated with the training item “SS match”.

On the other hand, when the number of extracted team members is six or more, five team members to be associated with the training item “SS match” are determined from the extracted team members. Here, the determined five team members are associated with “SS match”. Note that as described above, whether the SS parameter has reached the upper limit for each team member may be confirmed in order, and the processing may be terminated when five team members whose SS parameter has reached the upper limit are extracted.

### Processing of Determining Whether Character is Arranged and Training Item to be Arranged

Once the SS match information is determined, the characters to be arranged in the race or training item are then determined. Here, first, characters to be arranged in the race are determined through a lottery. As described above, the characters (team members) associated with the “SS match” are excluded from the processing of determining the characters to be arranged in the race. Then, when whether or not to arrange the characters in the “SS match” and “race” is determined, next, whether or not to arrange each character in the training item is determined. The processing of determining the training item in which the character is arranged is executed for all the characters to be processed regardless of whether or not the characters are arranged in the “SS match” or “race”. However, the characters arranged in “SS match” or “race” may not be arranged in the training items other than “SS match”.

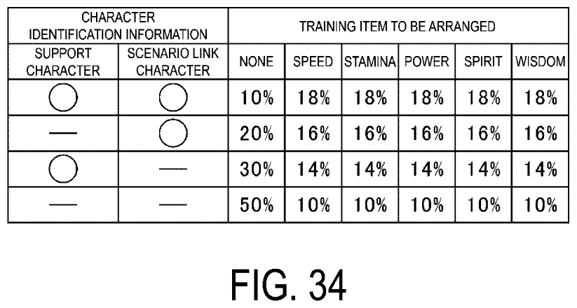

FIG. 34 is a diagram for describing the arrangement ratio for the training items. The player terminal 1 and the server 1000 store an arrangement determination table, and a training item in which a character is arranged is determined based on the arrangement determination table. In the present embodiment, the training items for arrangement are determined for all support characters, scenario link characters, story characters, and other team members based on character identification information.

Here, the arrangement determination table is provided for each piece of character identification information, and the arrangement ratio to each training item is different for each arrangement determination table. Specifically, according to the arrangement determination table for the support characters and the scenario link characters, the determination of not arranging the character and the specific character in any training (“none” in the figure) is set to 10%, and the determination of arranging the character and the specific character in the training items of speed, stamina, power, spirit, and wisdom (“speed”, “stamina”, “power”, “spirit”, and “wisdom” in the figure) all is set to 18%. The arrangement determination table for the support character and the scenario link character is used when the character determined to be arranged is set as the support character and the scenario link character.

In addition, according to the arrangement determination table for the scenario link character, the determination of not arranging the specific character in any training is set to 20%, and the determination of arranging the specific character in the training items of speed, stamina, power, spirit, and wisdom all is set to 16%. The arrangement determination table for the scenario link character is used when the character determined to be arranged is not set as the support character but set as the scenario link character.

In addition, according to the arrangement determination table for the support character, the determination of not arranging the support character in any training is set to 30%, and the determination of arranging the support character in the training items of speed, stamina, power, spirit, and wisdom all is set to 14%. The arrangement determination table for the support character is used when the character determined to be arranged is set as the support character but is not set as the scenario link character.

In addition, according to the arrangement determination table for other characters, the determination of not arranging other characters in any training is set to 50%, and the determination of arranging other characters in the training items of speed, stamina, power, spirit, and wisdom all is set to 108. The arrangement determination table for other characters is used when the character determined to be arranged is not set as any of the support character and the scenario link character. Note that the arrangement determination table for other characters may be used, for example, when the character to be arranged is set as a story character.

Note that as described above, the favored training is set for the support card (support character). When the target character is a support character, based on the arrangement determination table illustrated in FIG. 34, a change may be made so that the selection probability of the favored training set for the support card is increased. In addition, for example, some or all of the support cards (support characters) may be associated with an effect of increasing a probability of arrangement to a predetermined training item. The probability of arrangement of the support character associated with such an effect to a predetermined training item is changed to be higher.

Note that each training item is provided with an arrangement upper limit number of characters. Here, the arrangement upper limit number of characters is set to “5” for all the training items. Therefore, the number of arranged characters to be arranged in one training item is up to “5”.

Note that as described above, the training item associated with the character is determined for each character. At this time, the order of characters for determining the training items is arbitrary. Then, for example, in a case where the arrangement upper limit number of arranged characters have already been determined to be arranged in the training item in which a character is determined to be arranged, those characters may be determined to be not arranged in any training item. Alternatively, the training item in which the number of arranged characters has already reached the arrangement upper limit number may be excluded from the lottery, and the probability of arrangement to the other training items may be changed.

However, the arrangement upper limit number is not essential, and the arranged characters may be arranged in the training item as the lottery result. The method of determining the training item in which the character is arranged is not particularly limited.

When the arranged characters are determined as described above, the arranged characters are associated with each training item. Then, arrangement information in which the training item is associated with the arranged character is stored in the player terminal 1 and the server 1000.

### SSS Match Activation Lottery

Referring back to FIG. 33, when the arrangement of each character in the training items is determined, next, the SSS match activation lottery is executed. In the present embodiment, the SSS match positioned above the SS match is provided. Specifically, when the activation condition of the SSS match is satisfied, the SS match is promoted to the SSS match. The SSS match activation condition includes being successful in the SSS match activation lottery. However, an execution condition is provided for the SSS match activation lottery, and the SSS match activation lottery is executed only when the execution condition is satisfied.

Here, the execution condition of the SSS match activation lottery includes that five team members are linked to the SS match for the first time after the nurture game is started or after an SS match (SSS match) has been executed last. Thus, in the current turn, the SSS match activation lottery can be executed only when five team members are associated with the SS match.

However, for example, in a turn in which the SSS match activation lottery is not successful, the SS match may not be executed. In this case, in the next turn, five team members are also associated with the SS match. However, in this case, the SSS match activation lottery has already been executed after the execution of the previous SS match or after the start of the nurture game. Thus, in this case, the execution condition of the SSS match activation lottery is not satisfied. When the execution condition of the SSS match activation lottery is not satisfied, the winning probability is determined for each team member. At this time, the winning probability of the team member is determined based on the evaluation score of the nurture target character and the team member.

On the other hand, when the execution condition of the SSS match activation lottery is satisfied, the SSS match activation lottery is executed. At this time, if the SSS match activation lottery is unsuccessful, the winning probability is determined for each team member in the same manner as described above. When the SSS match activation lottery is successful, the winning probabilities of all team members are determined to be 100%.

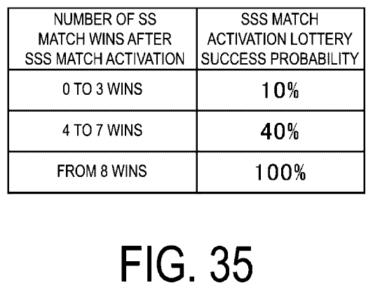

FIG. 35 is a diagram for describing the SSS match activation lottery. As illustrated in FIG. 35, after the SSS match is activated (or after the nurture game has started), when the number of wins of the nurture target character in the SS matches is three or less, the success probability of the SSS match activation lottery is set to 10%. Further, after the SSS match is activated (or after the nurture game has started), when the number of wins of the nurture target character in the SS matches ranges from 4 to 7, the success probability of the SSS match activation lottery is set to 40%, and when the number of wins is eight or more, the success probability is set to 100%.

In FIG. 35, the number of wins of the nurture target character in the SS matches after the SSS match is activated is reset in conjunction with the activation of the SSS match. Thus, the number of wins of the SS matches in FIG. 35 can be said to be the number of wins of the SS matches after the last SSS match was activated.

When the SS match is promoted to the SSS match, for example, the effect is superimposed and displayed on the training operation portion 215b on the top screen 210 and the SS match operation portion 221f on the training screen 220. In this manner, the top screen 210 and the training screen 220 suggest that the SS match has been promoted to the SSS match. Then, when the SSS match is executed, the nurture target character always wins against all the team members. In addition, when the SSS match is executed, the increase value of the ability parameter of the nurture target character and the reward given to the nurture target character are larger than those given when the SS match is executed.

The success probability of the SSS match activation lottery is merely an example. For example, the success probability may be always constant. Further, the bonus added when the SSS match is executed is not particularly limited. Furthermore, SSS match is not essential.

### Processing of Setting Friendship Training Occurrence Possible State

Referring back to FIG. 33, when the placement information is determined as described above, the friendship training occurrence possible state is set. Specifically, a support character is extracted from the characters arranged in the training item. Then, whether the setting condition for the friendship training occurrence possible state is met is determined for the extracted support character. As described above, here, the training item in which the support character is arranged being the favored training and the bond parameter associated with the support character being equal to or greater than a predetermined value are set as the setting conditions for the friendship training occurrence possible state.

Then, the support character that satisfies the setting conditions for the friendship training occurrence possible state is associated with friendship training occurrence possible information. In addition, the training item in which the support character that satisfies the setting conditions for the friendship training occurrence possible state is arranged is also associated with friendship training occurrence possible information. Thus, the friendship training occurrence possible state is set.

### Processing of Determining Increase Value of Ability Parameter

In a turn in which training can be performed, the increase value of the ability parameter when the training is successful is determined for each training item.

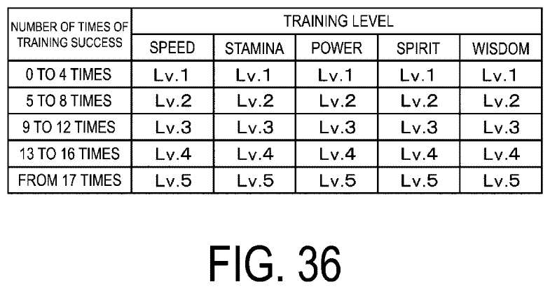

FIG. 36 is a diagram for describing training levels. As illustrated in FIG. 36, the training levels increase in accordance with the number of successes for each training item. Specifically, the training levels are provided for each of the five training items, namely, speed, stamina, power, spirit, and wisdom. For example, when the number of successes in the training of “speed” ranges from 0 to 4, the training level of speed is “1”. As the number of successes of the training of “speed” increases, the training level of speed increases as illustrated in the diagram.

Note that, although the training level is increased in accordance with the number of successes of the training here, the training level may be increased in accordance with the number of times the training is performed. The parameter for increasing the training level is not limited to the number of successes or the number of times the training is performed.

In the present embodiment, when the training selected by the player has been performed and has been successful, the value of a predetermined ability parameter is increased by the performed training item.

Specifically, in the present embodiment, if training of speed is performed and the training is successful, the values of the ability parameters for speed and power are increased.

In addition, if training of stamina is performed and the training is successful, the values of the ability parameters for stamina and spirit are increased.

In addition, if training of power is performed and the training is successful, the values of the ability parameters for stamina and power are increased.

In addition, if training of spirit is performed and the training is successful, the values of the ability parameters for speed, power, and spirit are increased.

In addition, if training of wisdom is performed and the training is successful, the values of the ability parameters of speed and wisdom are increased.

In the present embodiment, the value of the ability parameter to be increased when the training is successful is calculated by adding a value obtained by adding a bonus additional value to a fixed increase value determined corresponding to the performed training item and the training level to the fixed increase value.

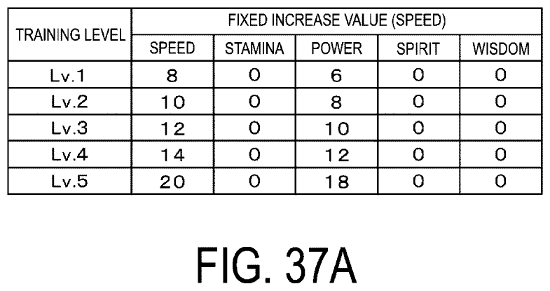

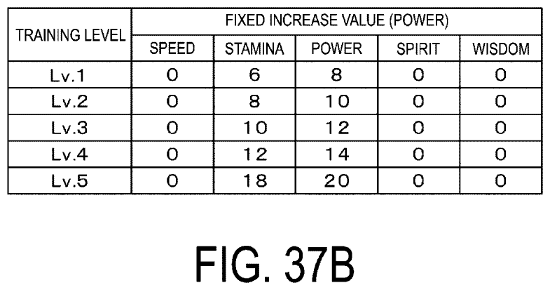

FIG. 37A is a diagram for describing a fixed increase value (speed) table. FIG. 37B is a diagram for describing a fixed increase value table (power). That is, FIG. 37A indicates the fixed increase value when the training item is speed. Also, FIG. 37B indicates the fixed increase value when the training item is power.

As illustrated in FIGS. 37A and 37B, the fixed increase value table stores fixed increase values determined corresponding to the performed training item and the training level. Further, in the present embodiment, as illustrated in FIGS. 37A and 37B, the ability parameter is set to increase more as the training level is higher.

Note that although description is omitted here, fixed increase value tables in a case where stamina, spirit, and wisdom are selected as the training item are also provided.

In the present embodiment, a large number of addition conditions for the ability parameters are provided. The addition conditions include, for example, the arranged character being arranged. In this case, a predetermined additional value is added to the fixed increase value. Further, for example, a growth rate may be set in advance for each training item for each nurture target character. In this case, the fixed increase value is multiplied by the growth rate for each training item.

In this way, when the addition condition is met, the additional value is added to the fixed increase value, or the fixed increase value is multiplied by a predetermined addition rate. Then, the calculated value is finally multiplied by a friendship bonus addition rate. The friendship bonus addition rate is used when a friendship bonus occurrence possible state is set for the training item. Moreover, the friendship bonus addition rate is calculated for each of the arranged characters arranged in the training item.

For example, assume that the friendship bonus addition rate is 20% and three arranged characters for each of which the friendship bonus occurrence possible state is set are arranged in the same training item. In this case, the friendship bonus addition rate is 60%. In this manner, the increase value of the ability parameter is increased by multiplying the friendship bonus addition rate.

### Processing of Determining Training Failure Probability

Referring back to FIG. 33, in a turn in which training can be performed, the failure probability of the training is determined for each training item.

### Processing of Setting Occurrence Possible State of Second Event

For a support character arranged in any of the training items, an occurrence possible state of the second event is set. The second event is selected through a lottery from among the support events (second events) associated with the support character (support card) arranged in each training item.

In the present embodiment, processing is executed to determine whether to set the occurrence possible state of the second event for all support characters arranged in the training item. When the player selects the training in which the support character for which the occurrence possible state of the second event is set is arranged, the second event occurs after the training is performed.

Note that the occurrence possible state of the second event may be set for each of a plurality of support characters arranged in one training item. In this case, when the training is performed, only one of the second events for which the occurrence possible states are set may be performed. All the second events for which the occurrence possible states are set may be performed.

As described above, in the nurture main game, the player can increase the ability parameter for the nurture target character as the turn progresses. The ability parameter is increased due to the success of training or the appearance of various events. Then, in the nurture main game, when all the turns are finished, the nurture game ends. If the goal set for each character was not achieved during the nurture main game, the nurture game ends at this point.

Here, when the nurture game ends, the nurture target character nurtured in the nurture game is stored as a nurtured character. More strictly, the information related to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes the ability parameter, the aptitude parameter, the acquired skill, inheritance information, and the like.

When the nurture game ends, the evaluation score of the nurtured character is calculated. Here, the evaluation score is calculated based on the ability parameter, the aptitude parameter, the acquired skill, race results, team race results, and the like at the end of the nurture game. Note that the method of calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based on only the parameter that affects the race result when the nurtured character enters a race in a team competition game or another racing game, such as the ability parameter, the aptitude parameter, the acquired skill, or the like at the end of the nurture game.

A nurture rank is set for the nurtured character based on the evaluation score. The nurture rank is an indicator of the strength of the nurtured character, and a range of the evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

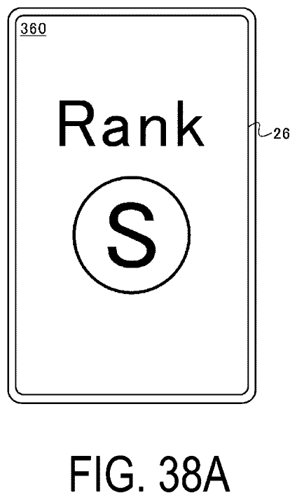

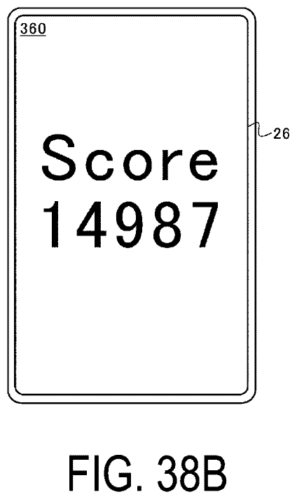

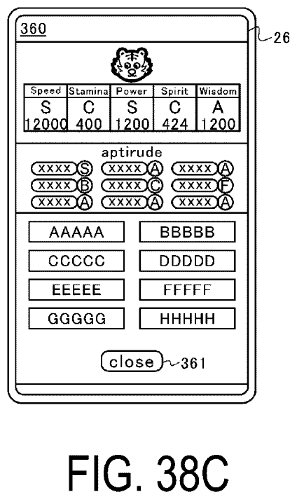

FIG. 38A is a first diagram for describing a nurture completion screen 360. FIG. 38B is a second diagram for describing the nurture completion screen 360. FIG. 38C is a third diagram for describing the nurture completion screen 360. When the nurture game ends, the nurture completion screen 360 is displayed on the display 26 as illustrated in FIG. 38A. On the nurture completion screen 360, the nurture rank of the nurtured character is first displayed, and thereafter, the evaluation score is displayed as illustrated in FIG. 38B.

When a predetermined amount of time elapses after the evaluation score is displayed, the ability parameter, the aptitude parameter, and the acquired skill of the nurtured character are displayed on the nurture completion screen 360 as illustrated in FIG. 38C. At this time, a close operation portion 361 is provided on the nurture completion screen 360. When the close operation portion 361 is tapped, the nurture completion screen 360 is hidden, and the home screen 100 is displayed on the display 26.

Note that when the nurture game ends, a lottery for a factor to be obtained by the nurtured character is performed, and factor information is stored in association with the nurtured character. Although not illustrated, the player can display the factor information obtained by the nurtured character on the nurture completion screen 360. The lottery for the factor is performed according to a condition set in advance for each factor type. An acquisition probability of the factor and the like are set based on the result of the nurture game.

Next, the functional configuration of the player terminal 1 and the server 1000 for executing the above-described nurture game will be described.

### Functional Configuration of Player Terminal 1

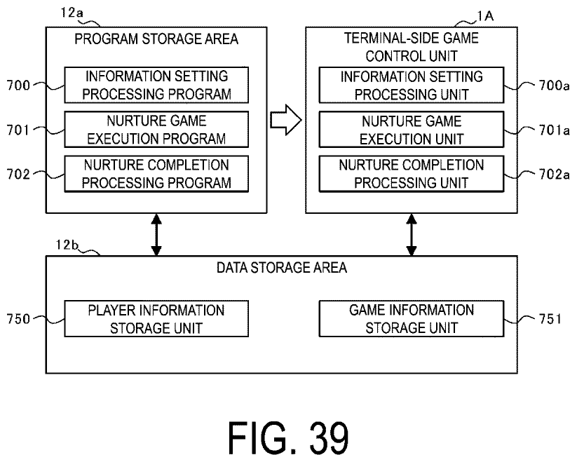

FIG. 39 is a diagram for describing a configuration of the memory 12 in the player terminal 1 and a function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, and a nurture completion processing program 702. Note that the programs listed in FIG. 39 are examples, and many other programs are provided in the terminal-side game control program.

In the data storage area 12b, a player information storage unit 750 and a game information storage unit 751 are provided as storage units that store data. Note that the data storage area 12b is provided with a large number of other storage units. Here, information directly related to a game such as a nurture game (hereinafter referred to as game information) is stored in the game information storage unit 751. Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player and setting information of the player terminal 1, is set as player information. The player information is stored in the player information storage unit 750.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes an information setting processing unit 700a, a nurture game execution unit 701a, and a nurture completion processing unit 702a.

To be specific, the CPU 10 runs the information setting processing program 700 to cause the computer to function as the information setting processing unit 700a. Similarly, the CPU 10 runs the nurture game execution program 701 and the nurture completion processing program 702 to cause the computer to function as the nurture game execution unit 701a and the nurture completion processing unit 702a.

When various types of information are set in the player terminal 1, the information setting processing unit 700a stores information related to the setting in the player information storage unit 750 as player information. When the information in the player information storage unit 750 is updated, the information setting processing unit 700a transmits the updated information to the server 1000.

The nurture game execution unit 701a executes all processing related to the nurture game. To be specific, the nurture game execution unit 701a executes the preparation stage processing and the nurture stage processing.

The nurture completion processing unit 702a stores the nurtured character information including the ability parameter, the aptitude parameter, the acquired skill, the inheritance information, the factor information, the type of the character used for nurturing, and the like of the nurtured character at the time of completion of the nurture game.

### Functional Configuration of Server 1000

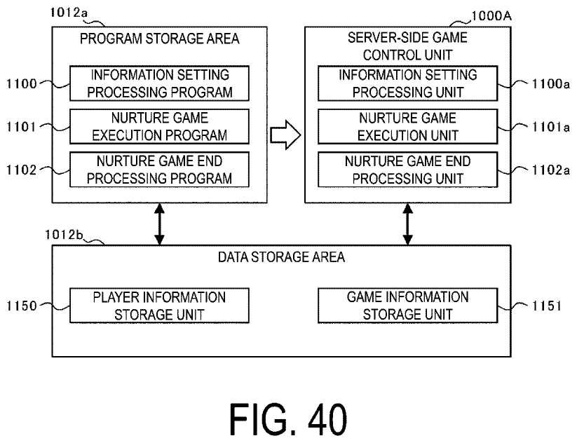

FIG. 40 is a diagram for describing a configuration of the memory 1012 in the server 1000 and a function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, and a nurture game end processing program 1102. Note that the programs listed in FIG. 40 are examples, and many other programs are provided in the server-side game control program.

In the data storage area 1012b, a player information storage unit 1150 and a game information storage unit 1151 are provided as storage units that store data. Note that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 operates each program stored in the program storage area 1012a and updates the data in each storage unit of the data storage area 1012b. Then, the CPU 1010 causes the server 1000 (computer) to function as a server-side game control unit 1000A by running each program stored in the program storage area 1012a. The server-side game control unit 1000A includes an information setting processing unit 1100a, a nurture game execution unit 1101a, and a nurture game end processing unit 1102a.

To be specific, the CPU 1010 runs the information setting processing program 1100 to cause the computer to function as the information setting processing unit 1100a. Similarly, the CPU 1010 runs the nurture game execution program 1101 and the nurture game end processing program 1102 to cause the computer to function as the nurture game execution unit 1101a and the nurture game end processing unit 1102a.

When various types of information are set in the player terminal 1, the information setting processing unit 1100a updates the player information in the player information storage unit 1150 based on the update information received from the player terminal 1. In addition, the information setting processing unit 1100a measures time and updates the game points of each player.

The nurture game execution unit 1101a executes all processing related to the nurture game.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores, associated with the player ID, nurtured character information including the ability parameter, the aptitude parameter, the acquired skill, the inheritance information, the factor information, the type of the character used for nurturing, and the like of the nurtured character.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a in the player terminal 1 and the nurture game execution unit 1101a in the server 1000 are the same in that both execute processing related to the nurture game, but have different roles, that is, different ranges of responsibility.

Processing performed by each functional unit in the player terminal 1 and the server 1000 will be described below with reference to a flowchart.

### Processing of Player Terminal 1 and Server 1000 Processing Related to Nurture Game

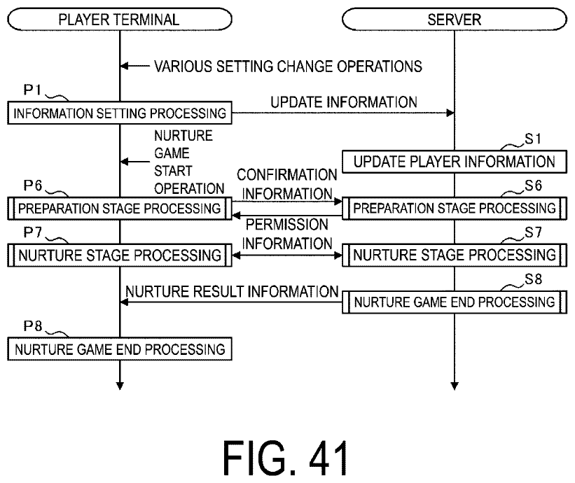

FIG. 41 is a sequence diagram for describing processing of the player terminal 1 and the server 1000 related to the nurture game. In the following description, the processing in the player terminal 1 is denoted by Pn (n is any integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750 based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information that is information related to friends is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing based on the information received from the player terminal 1 (S6).

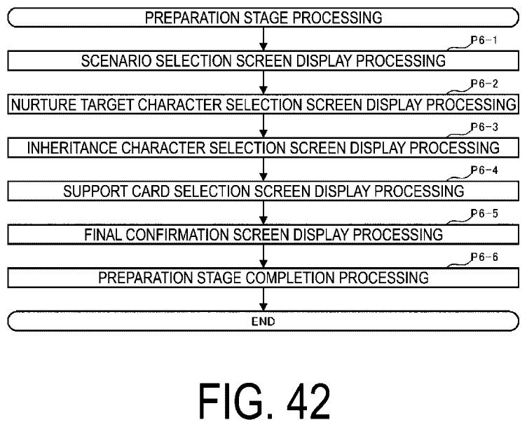

FIG. 42 is a flowchart for describing the preparation stage processing (P6) in the player terminal 1. The nurture game execution unit 701a in the player terminal 1 executes a scenario selection screen display processing (P6-1). Here, the nurture game execution unit 701a displays the scenario selection screen, and provisionally registers the scenario ID based on the operation input of the player.

Next, the nurture game execution unit 701a in the player terminal 1 executes a nurture target character selection screen display processing (P6-2). Here, the nurture game execution unit 701a displays the nurture target character selection screen 150, and provisionally registers the nurture target character based on the operation input of the player.

To be more specific, the nurture game execution unit 701a switches the display screen of the display 26 when the player inputs a display switching operation for switching the display of the screen. When a tapping and holding operation on the character icon 151 on the nurture target character selection screen 150 is input, the nurture game execution unit 701a displays the character detail screen 160. When the strengthening operation portion 163b is operated on the character detail screen 160, the character strengthening screen 165 is displayed. Further, when a selection operation (operation on the character icon 151) is input on the nurture target character selection screen 150, the nurture game execution unit 701a temporarily stores the character corresponding to the character icon 151 to which the selection operation has been input, and switches the display screen.

When a confirm operation (operation on the next operation portion 154) is input on the nurture target character selection screen 150, the nurture game execution unit 701a provisionally registers the temporarily stored character as a nurture target character. The nurture game execution unit 701a acquires information related to the representative characters extracted according to a predetermined extraction condition, such as the representative characters of the friends, from the server 1000, and displays the inheritance character selection screen 170.

Next, the nurture game execution unit 701a executes inheritance character selection screen display processing (P6-3). Here, the nurture game execution unit 701a switches the display screen on the display 26 when the display switching operation is input. Further, when a selection operation (operation on the nurtured character icon 182) is input on the nurtured character list screen 180, the nurture game execution unit 701a temporarily stores the character corresponding to the nurtured character icon 182 on which the selection operation input has been performed as an inheritance character, and switches the display screen.

When a confirm operation (operation on the next operation portion 154) is input on the inheritance character selection screen 170, the nurture game execution unit 701a displays the support card organization screen 190 on the display 26.

Next, the nurture game execution unit 701a executes support card selection screen display processing (P6-4). Here, when a selection operation (operation on the card icon 201 of the support card) is input, the nurture game execution unit 701a temporarily stores the support card corresponding to the card icon 201 on which the selection operation has been performed, and switches the display screen.

In addition, when a display switching operation for switching the display of the screen is input while the support card organization screen 190 is displayed, the nurture game execution unit 701a switches the display screen of the display 26. When a confirm operation (operation on the start operation portion 193) is input, the nurture game execution unit 701a displays the final confirmation screen 205 on the display 26.

Next, the nurture game execution unit 701a executes final confirmation screen display processing (P6-5). Here, when a display switching operation for switching the display of the screen is input, the nurture game execution unit 701a switches the display screen on the display 26.

In addition, when a selection operation (operation on the select operation portion 206c) is input on the preset selection screen 205A, the nurture game execution unit 701a temporarily stores reservation selection information corresponding to the preset on which the selection operation input has been performed, and switches the display screen.

When a confirm operation (operation on the start operation portion 205b) is input on the final confirmation screen 205, the nurture game execution unit 701a executes preparation stage completion processing (P6-6). Here, the nurture game execution unit 701a determines whether the game point is equal to or greater than a predetermined value (such as 30), and if the game point is equal to or greater than the predetermined value, transmits confirmation information to the server 1000.

Note that the confirmation information includes information for identifying the provisionally registered nurture target character, inheritance character, and support card. When the confirmation information is received, the preparation stage processing (S6) is executed in the server 1000. Although details will be described below, in the server 1000, a determination is made on whether to permit the nurture main game to be performed using the provisionally registered nurture target character, inheritance character, and support card.

The nurture game execution unit 701a after transmitting the confirmation information, when receiving permission information from the server 1000, registers the provisionally registered scenario ID and nurture target character. Additionally, the nurture game execution unit 701a registers the nurtured character temporarily stored as the inheritance character and the temporarily stored support card in the deck. In addition, when the scenario selected in P6-1 is an existing scenario, the nurture game execution unit 701a sets a goal based on the scenario ID and the character ID of the nurture target character. Further, for example, when the scenario selected in P6-1 is a new scenario, the nurture game execution unit 701a sets a goal based on the scenario ID. Thus, the preparation stage completion processing ends, and the nurture main game is started. Setting of a goal in a nurture main game is performed.

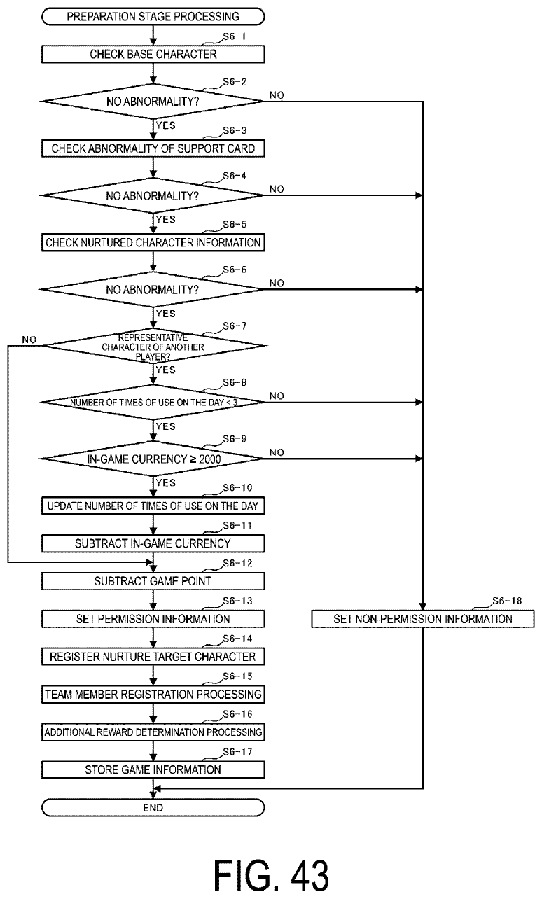

FIG. 43 is a flowchart for describing the preparation stage processing (S6) in the server 1000. The nurture game execution unit 1101a, when receiving the confirmation information, checks the base character of the player stored in the player information storage unit 1150 (S6-1). The nurture game execution unit 1101a determines that there is no abnormality when the nurture target character selected by the player is included in the base character (S6-2).

If there is no abnormality in the nurture target character selected by the player (YES in S6-2), the nurture game execution unit 1101a checks whether there is no abnormality in the support card selected by the player (S6-3). Note that in S6-3, it is determined that there is an abnormality when a support card that is not possessed by the player is selected, when a rental card selected by the player is not associated with the player ID of the player, when the support character duplicates the nurture target character, or the like.

If there is no abnormality in the support card selected by the player (YES in S6-4), the nurture game execution unit 1101a checks the nurtured character information stored in the game information storage unit 1151 (S6-5). Then, when the nurtured character selected as the inheritance character by the player is associated with the player ID of the player, that is, when the nurtured character nurtured by the player is selected as the inheritance character, the nurture game execution unit 1101a determines that there is no abnormality in the inheritance character (YES in S6-6).

When it is determined that there is no abnormality in the inheritance character, the nurture game execution unit 1101a determines whether a representative character of another player is included in the nurtured character selected as the inheritance character by the player (S6-7). When the representative character of another player is included (YES in S6-7), the nurture game execution unit 1101a determines whether the number of times of use on the day is less than three (S6-8).

When the number of times of use on the day is less than three (YES in S6-8), the nurture game execution unit 1101a determines whether a value of a predetermined in-game currency possessed by the player is 2000 or more (S6-9). That is, in the S6-8 and the S6-9, whether an organization condition is satisfied is determined. When the player possesses the value of the in-game currency of 2000 or more (YES in S6-9), the nurture game execution unit 1101a adds “1” to the number of times of use on the day (S6-10). The nurture game execution unit 1101a subtracts 2000 from the value of predetermined in-game currency possessed, which is stored in the player information storage unit 1150 (S6-11).

Further, the nurture game execution unit 1101a subtracts a predetermined value (for example, 30) from the game point of the player (S6-12). Then, when there is no abnormality in the nurture target character, the inheritance character, and the support card, and the organization condition for using the representative character of another player is satisfied, the nurture game execution unit 1101a sets the permission information (S6-13), and causes the player terminal 1 to receive the permission information.

Next, the nurture game execution unit 1101a registers a nurture target character (S6-14). Further, the nurture game execution unit 1101a executes team member registration processing (S6-15). Here, the nurture game execution unit 1101a determines the scenario link character, the support character, and the other target characters as team members as described above. The nurture game execution unit 1101a associates the determined team member with the member ID. Further, the nurture game execution unit 1101a sets initial values of various stats such as ability parameters for each team member based on the member ID.

Next, the nurture game execution unit 1101a executes additional reward determination processing (S6-16). Here, the nurture game execution unit 1101a determines three additional rewards for each team member. As described above, three additional rewards are set in advance for the member ID associated with the team member. Here, three additional rewards are determined for each team member based on the member ID. Note that an additional reward ID is provided for the additional reward, and here, three additional reward IDs and information indicating the giving order are associated with each team member.

When the nurture target character is a scenario link character, the additional reward originally assigned to the scenario link character is assigned to a character having the smallest member ID excluding the scenario link character. Then, the nurture game execution unit 1101a saves the information determined in the processing from S6-14 to S6-16 described above as the game information received by the player terminal 1 (S6-17). In the player terminal 1, the received game information is stored, and the nurture stage processing is started.

On the other hand, when there is an abnormality in any of the nurture target character, the inheritance character, and the support card, or when the organization condition for using the representative character of another player is not satisfied, the nurture game execution unit 1101a sets non-permission information (S6-18), and causes the player terminal 1 to receive the non-permission information. The player terminal 1, when receiving the non-permission information, displays the final confirmation screen 205 and presents a predetermined error notification.

Referring back to FIG. 41, when the preparation stage processing (P6, S6) ends, the nurture game execution unit 701a in the player terminal 1 executes the nurture stage processing (P7). Further, during the nurture stage processing, communication processing is executed between the player terminal 1 and the server 1000. In the server 1000, the nurture game execution unit 1101a executes the nurture stage processing based on the information received from the player terminal 1 (S7).

Hereinafter, the nurture stage processing (P7) executed in the player terminal 1 and the nurture stage processing (S7) executed in the server 1000 are described. However, here, for ease of understanding, the processing in the player terminal 1 and the processing in the server 1000 are described with the order thereof changed as appropriate.

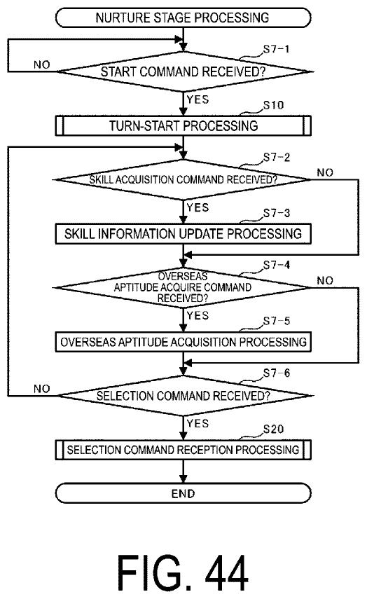

FIG. 44 is a flowchart for describing the nurture stage processing in the server 1000. The nurture game execution unit 1101a in the server 1000 waits for receiving a start command from the player terminal 1 (S7-1). Then, the nurture game execution unit 1101a, when receiving the start command (YES in S7-1), executes the turn-start processing (S10). Note that the start command is transmitted from the player terminal 1 to the server 1000, for example, when the processing or performance related to the current turn is completed.

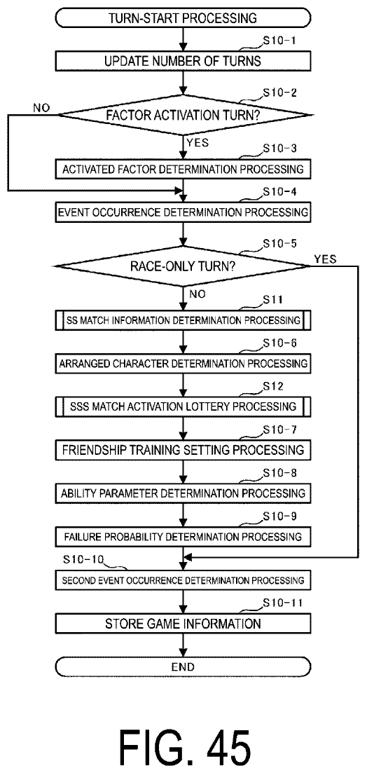

FIG. 45 is a flowchart for describing the turn-start processing in the server 1000. The nurture game execution unit 1101a in the server 1000 updates the current number of turns (S10-1). When the current turn is a factor activation turn (YES in S10-2), the nurture game execution unit 1101a executes activated factor determination processing (S10-3). Here, whether to activate the factor is determined for each registered inheritance character.

Next, the nurture game execution unit 1101a executes event occurrence determination processing (S10-4). Here, the nurture game execution unit 1101a determines an event to occur in the current turn, for the scenario event, the exclusive event, the first event, or the like.

When the current turn is not a race-limited turn (NO in S10-5), the nurture game execution unit 1101a executes SS match information determination processing (S11).

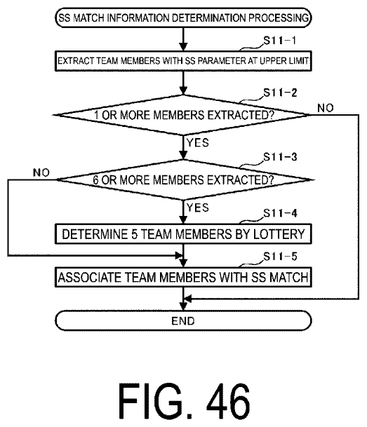

FIG. 46 is a flowchart for describing the SS match information determination processing in the server 1000. The nurture game execution unit 1101a extracts all team members whose SS parameters have reached the upper limit (S11-1). Next, the nurture game execution unit 1101a determines whether one or more team members have been extracted in S11-1 (S11-2). In a case where no team member is extracted (NO in S11-2), the nurture game execution unit 1101a ends the SS match information determination processing. In addition, in the S11-1, when six or more team members are extracted (YES in S11-3), the nurture game execution unit 1101a determines five team members from the extracted team members by lottery (S11-4). Then, the nurture game execution unit 1101a associates the extracted team members with the training item “SS match” (S11-5).

Referring back to FIG. 45, the nurture game execution unit 1101a executes arranged character determination processing (S10-6). Here, the nurture game execution unit 1101a determines whether or not to arrange, in a race, the remaining team members and the like excluding the team members associated with “SS match” in S11. Here, the nurture game execution unit 1101a determines whether to arrange and the training item to be arranged through a lottery based on the arrangement table (FIG. 34). At this time, when the race and training item to be arranged is determined, the nurture game execution unit 1101a stores the determined race and training item in association with the character.

Next, the nurture game execution unit 1101a executes SSS match activation lottery processing (S12).

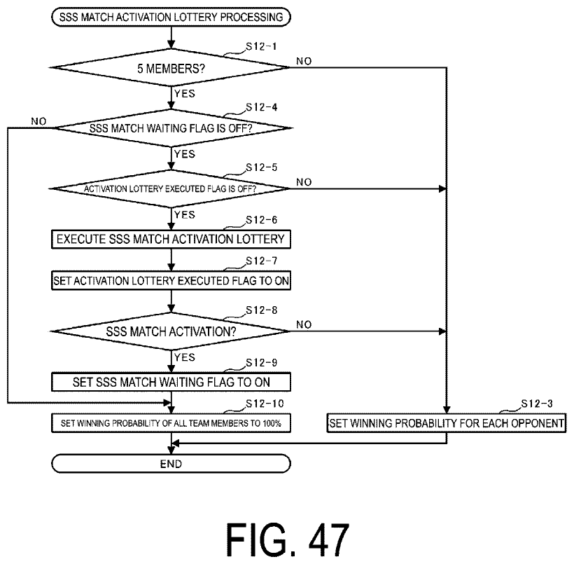

FIG. 47 is a flowchart for describing the SSS match activation lottery processing in the server. In the SS match information determination processing, when the number of team members associated with the “SS match” is not five (NO in S12-1), the nurture game execution unit 1101a determines a winning probability for each team member as an opponent (S12-3). Here, the nurture game execution unit 1101a determines the winning probability for each team member as an opponent based on the evaluation score of the nurture target character and all the team members associated with the “SS match” and the energy of the nurture target character.

On the other hand, when the number of team members associated with the “SS match” is five (YES in S12-1), the nurture game execution unit 1101a determines whether the SSS match waiting flag is off (S12-4). Note that the SSS match waiting flag is turned on when the SSS match activation lottery is successful and the activation of the SSS match is determined. Thus, in S12-4, the case where it is determined that the SSS match waiting flag is on is a case where the activation of the SSS match is determined before the current turn, but the SSS match is not yet executed.

When the SSS match waiting flag is off (YES in S12-4), the nurture game execution unit 1101a determines whether the activation lottery executed flag is off (S12-5). The SSS match activation lottery is executed only when the number of team members associated with the “SS match” has reached five for the first time after the activation of the SSS match. The activation lottery executed flag is turned on when the SSS match activation lottery is executed. That is, the on state of the activation lottery executed flag indicates that the SSS match activation lottery has already been executed once after the SSS match was activated last.

When the activation lottery executed flag is not off (NO in S12-5), the nurture game execution unit 1101a moves the processing to S12-3. When the activation lottery executed flag is off (YES in S12-5), the nurture game execution unit 1101a executes the SSS match activation lottery (S12-6). Here, the success probability is set based on the number of wins in the SS matches after the SSS match was activated last. The nurture game execution unit 1101a turns on the activation lottery executed flag (S12-7).

When the activation of the SSS match is determined by the SSS match activation lottery in S12-6 (YES in S12-8), the nurture game execution unit 1101a turns on the SSS match waiting flag (S12-9). In addition, in S12-5, when it is determined that the SSS match waiting flag is on (NO in S12-4), or when it is determined to activate the SSS match (YES in S12-8), the nurture game execution unit 1101a determines the winning probability of all team members associated with the “SS match” to be 100% (S12-10).

When the activation of the SSS match is not determined by the SSS match activation lottery (NO in S12-8), the nurture game execution unit 1101a moves the processing to S12-3.

Referring back to FIG. 45, the nurture game execution unit 1101a executes friendship training setting processing (S10-7). Here, the “Processing of setting the friendship training occurrence possible state” described using FIG. 33 is executed. That is, the nurture game execution unit 1101a extracts a support character arranged in any one of the training items. Then, whether the setting conditions for the friendship training occurrence possible state are satisfied is determined for each of the extracted support characters. The nurture game execution unit 1101a associates the support character that satisfies the setting conditions for the friendship training occurrence possible state with friendship training occurrence information. In addition, the training item in which the support character that satisfies the setting conditions for the friendship training occurrence possible state is arranged is also associated with friendship training occurrence possible information.

Next, the nurture game execution unit 1101a executes ability parameter determination processing (S10-8). Here, the “processing of determining the increase value of the ability parameter” described using FIG. 33 is executed. That is, the nurture game execution unit 1101a selects any one of five training items as a processing target. The nurture game execution unit 1101a obtains the training level of the ability parameter for the processing target and determines the fixed increase value.

The nurture game execution unit 1101a obtains the arrangement information of the arranged characters and determines the additional value. In addition, the nurture game execution unit 1101a determines whether other addition conditions such as the currently activated effects of expectation level bonuses or effects of the overseas aptitude are satisfied and determines the final increase value of the training item that is the processing target based on the satisfied addition condition. The determination on the final increase value of the ability parameter is performed for each training item. Although a detailed description is omitted, in the ability parameter determination processing, an energy consumption amount or an energy recovery amount when each training item is executed is determined.

The nurture game execution unit 1101a calculates a failure probability of training for each training item based on the energy of the nurture target character (S10-9). Here, the failure probability is calculated based on the currently activated effects of the expectation level bonus, effects of the overseas aptitude, or the like.

Next, the nurture game execution unit 1101a executes second event occurrence determination processing (S10-10). Here, the “Processing of setting the second event possible state” described using FIG. 33 is executed. That is, the nurture game execution unit 1101a determines whether to execute a support event set in advance for the support card associated with the training item through a lottery. Then, the nurture game execution unit 1101a stores the information determined in the above processing as the game information received by the player terminal 1 (S10-11).

Referring back to FIG. 44, when a skill acquire command indicating acquisition of any base skill is received from the player terminal 1 after the turn-start processing has ended (YES in S7-2), skill information such as the skill acquisition information is updated by the nurture game execution unit 1101a (S7-3). Here, the acquired skill is associated with the acquisition information. Here, the nurture game execution unit 1101a subtracts the skill points required to acquire the skill from the skill points currently possessed. Here, the nurture game execution unit 1101a causes the player terminal 1 to receive the updated skill information.

After the turn-start processing has ended, when an overseas aptitude acquire command indicating the acquisition of an overseas aptitude (of an aptitude level of “2” or more) is received from the player terminal 1 (YES in S7-4), the nurture game execution unit 1101a executes overseas aptitude acquisition processing (S7-5). Here, the acquisition information of the overseas aptitude is updated. Specifically, the acquisition information is associated with the acquired aptitude level of the overseas aptitude. Here, the nurture game execution unit 1101a subtracts the aptitude points required to acquire the overseas aptitude from the aptitude points currently possessed. Here, the updated overseas aptitude information is caused to be received by the player terminal 1 by the nurture game execution unit 1101a. Then, the nurture game execution unit 1101a waits until a selection command (information corresponding to the command selected by the player) is received from the player terminal 1 (NO in S7-6).

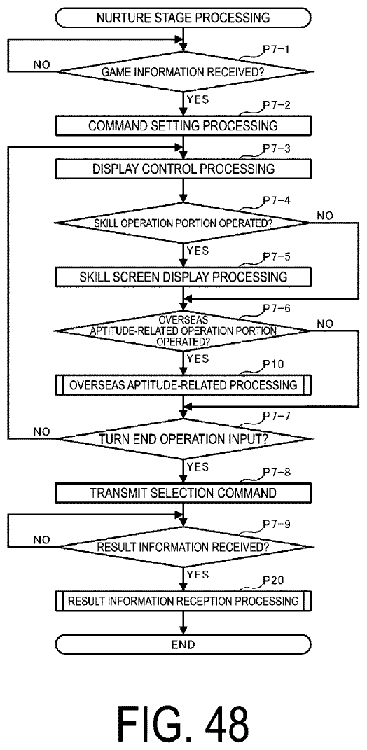

FIG. 48 is a flowchart for describing the nurture stage processing in the player terminal 1. The nurture game execution unit 701a in the player terminal 1 waits for receiving the game information from the server 1000 (P7-1). Then, the nurture game execution unit 701a, when receiving the game information (YES in P7-1), executes command setting processing (P7-2). Here, the processing of setting a command that can be selected by the player is executed based on the current number of turns. Here, when one or more team members are associated with the SS match, the nurture game execution unit 701a enables the training item “SS match”. On the other hand, when no team members are associated with the SS match, the nurture game execution unit 701a disables the training item “SS match”.

The nurture game execution unit 701a executes display control processing of displaying a game screen based on the received game information (P7-3). Here, the nurture game execution unit 701a displays the top screen 210, the training screen 220, and the like based on the received game information. To be specific, the nurture game execution unit 701a displays the arranged character icon 224 and the star gauge 225 for each training item on the training screen 220. The nurture game execution unit 701a controls the display of the stats display portion 213. Further, the nurture game execution unit 701a causes the operation portion corresponding to the training item set to the friendship training occurrence possible state and the training operation portion 215b of the top screen 210 to display an effect. In addition, when the SSS match can be activated, the nurture game execution unit 701a displays the effect on the training operation portion 215b of the top screen 210 and the SS match operation portion 221f of the training screen 220.

When the skill operation portion 215c is operated (YES in P7-4), the nurture game execution unit 701a executes skill screen display processing (P7-5). Here, a skill screen for acquiring a skill is displayed. Further, while the skill screen is displayed, processing of causing the nurture target character to acquire a skill is executed based on an operation input of the player.

When an overseas aptitude-related operation portion associated with acquiring overseas aptitude is operated (YES in P7-6), the nurture game execution unit 701a executes overseas aptitude-related processing (P10). The overseas aptitude-related operation portion includes, for example, the overseas aptitude operation portion 215f, the overseas aptitude icon 331, the left button 332L, the right button 332R, the confirm operation portion 336, the acquisition condition button 337, and the effect button 338.

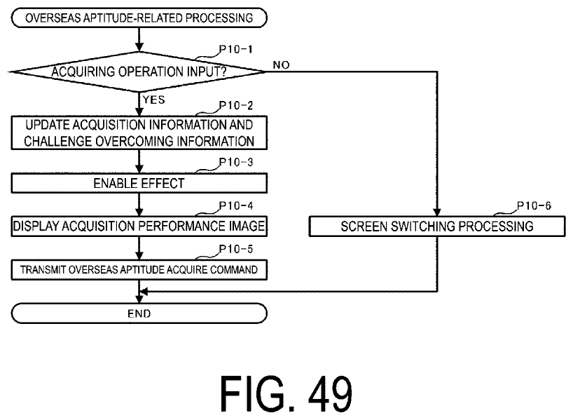

FIG. 49 is a flowchart for describing the overseas aptitude-related processing in the player terminal 1. When an operation of acquiring overseas aptitude (aptitude level “2” or higher), that is, an operation to the confirm operation portion 336 is input on the overseas aptitude acquisition screen 330 (YES in P10-1), the nurture game execution unit 701a updates the acquired acquisition information of the overseas aptitude (P10-2). Here, the nurture game execution unit 701a updates the challenge overcoming information indicating the overcoming status of the challenge set in the special race. The challenge overcoming information enables identification of whether each challenge has been overcome or not. The nurture game execution unit 701a enables the effect associated with the overseas aptitude acquired in P10-2 (P10-3).

The nurture game execution unit 701a displays an acquisition performance image suggesting that an overseas aptitude has been acquired (P10-4) and transmits an overseas aptitude acquire command to the server 1000 (P10-5). The overseas aptitude acquire command transmitted at this time is configured such that the type of overseas aptitude, the acquired aptitude level, and the challenge overcoming information can be identified. Thus, the acquisition information on the overseas aptitude and the challenge overcoming information are shared between the server 1000 and the player terminal 1 which have received the overseas aptitude acquire command. When an operation of the overseas aptitude-related operation portion other than the acquiring operation is input (NO in P10-1), the nurture game execution unit 701a switches the screen of the display 26 (P10-6).

Referring back to FIG. 48, the nurture game execution unit 701a switches the display screen of the display 26 based on the operation input by the player until the turn end operation is input (NO in P7-7). Here, the turn end operation is an operation of ending the current turn and includes an operation of the rest operation portion 215a, the infirmary operation portion 215d, the going out operation portion 215e, the speed operation portion 221a, the stamina operation portion 221b, the power operation portion 221c, the spirit operation portion 221d, the wisdom operation portion 221e, and the SS match operation portion 221f; an operation of determining a race event of a race; and the like.

When the turn end operation is input (YES in P7-7), the nurture game execution unit 701a transmits a selection command corresponding to the turn end operation input by the player to the server 1000 (P7-8). Thereafter, the player terminal 1 waits until the result information is received from the server 1000 (NO in P7-9).

Referring back to FIG. 44, when a selection command is received from the player terminal 1 (YES in S7-6), the nurture game execution unit 1101a executes selection command reception processing (S20).

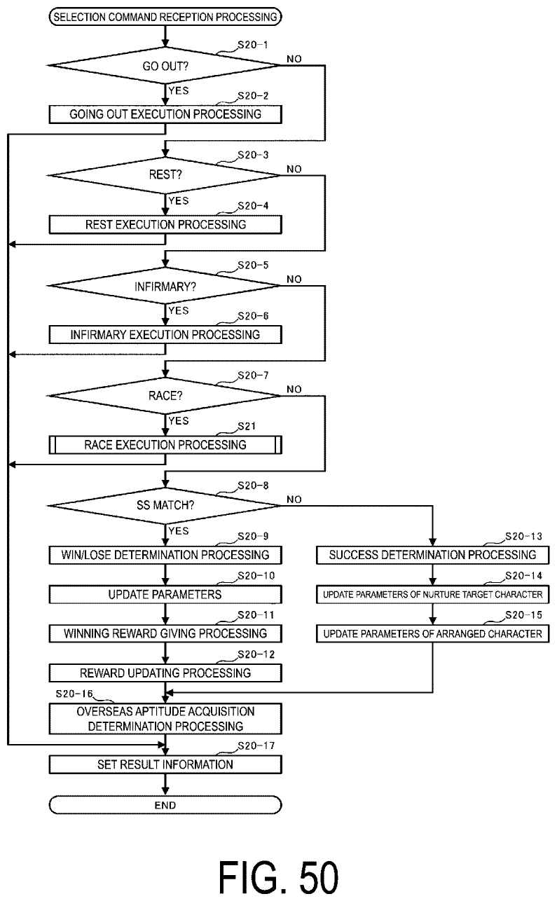

FIG. 50 is a flowchart for describing the selection command reception processing in the server 1000. When the selection command indicating an operation input of the going out operation portion 215e is received (YES in S20-1), the nurture game execution unit 1101a executes going out execution processing (S20-2). Here, a going out event is determined that increases the parameters of energy and mood. Further, the parameters of energy and mood are updated based on the determined going out event.

When the selection command indicating an operation input of the rest operation portion 215a is received (YES in S20-3), the nurture game execution unit 1101a executes rest execution processing (S20-4). Here, a rest event is determined that increases the parameter of energy. Further, the parameter of energy is updated based on the determined rest event.

When the selection command indicating an operation input of the infirmary operation portion 215d is received (YES in S20-5), the nurture game execution unit 1101a executes infirmary execution processing (S20-6). Here, an event that removes a minus parameter or the like is determined. Further, the parameter is updated based on the determined event.

The nurture game execution unit 1101a, when receiving a selection command indicating an operation input to start a race (YES in S20-7), executes race execution processing (S21).

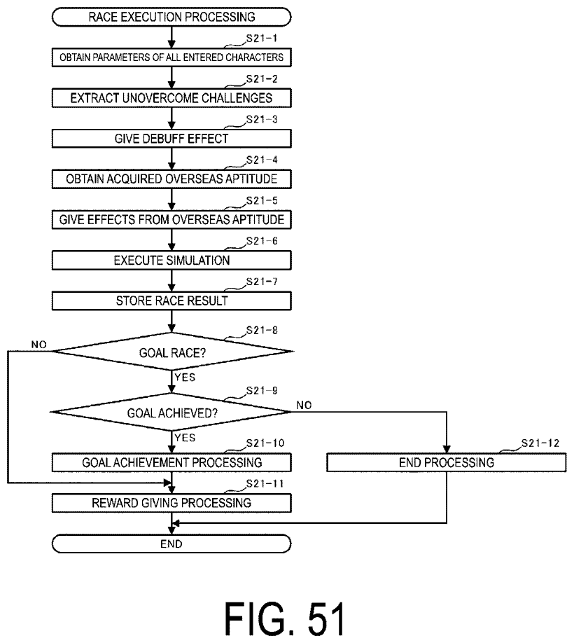

FIG. 51 is a flowchart for describing the race execution processing in the server 1000. The nurture game execution unit 1101a acquires parameters of the nurture target character entering the race and all of the entered NPC characters (S21-1). Here, the nurture game execution unit 1101a acquires parameters used when deriving the race result, such as the ability parameters, the aptitude parameters, and the acquired skills, for all of the entered characters.

Next, when the race to be executed is a special race, the nurture game execution unit 1101a extracts unovercome challenges from the challenges set in the race based on the challenge overcoming information (S21-2). Then, the nurture game execution unit 1101a gives the debuff effect set for the challenge extracted in S21-2 (S21-3).

For example, when the challenge “Unfamiliar turf” has not been overcome, the turf aptitude of the nurture target character is changed to “G”. Further, for example, in a case where the challenge “Foreign food” has not been overcome, all of the ability parameters of the nurture target character are set to “−100”. In this manner, here, the ability parameters and the aptitude parameters of the nurture target character are updated to be disadvantageous for each extracted unovercome challenge.

The nurture game execution unit 1101a acquires the acquired overseas aptitude (S21-4). Next, the nurture game execution unit 1101a gives an effect based on the overseas aptitude acquired in S21-4 (S21-5). For example, in a case where the overseas aptitude associated with an effect of “+200” for the power or stamina ability parameter has been acquired, processing of adding the ability parameter of the nurture target character acquired in S21-1 is executed. The ability parameters and the like that have been increased by the activation of the effect due to the overseas aptitude can be confirmed on the entry screen, the race screen, or the like.

Then, the nurture game execution unit 1101a executes a simulation of the race based on the various parameters acquired in S21-1 and the various parameters updated in S21-3 and S21-5 (S21-6).

Each race is divided into a plurality of phases from the start to the goal. In the simulation of the race, various parameters of the entered characters are input to the calculation formula provided for each phase, and calculations are performed.

Although the specific arithmetic expression is not particularly limited, the values of the ability parameters are input to the arithmetic expression for each phase and directly affect the calculated speed, stamina, and the like. Further, for example, the aptitude parameters may be used as a correction coefficient to be input to the arithmetic expression. Specifically, as described above, the aptitude parameters has seven levels of A to G as initial values. Further, for example, the aptitude parameters may increase to “S”, which is more advantageous than “A”, during the nurture game. In this case, the aptitude parameters used in the simulation of the race are eight levels of S to G.

In the simulation of the race, from among the aptitude parameters of the nurture target character, the aptitude parameters corresponding to the race are used. For example, when the racecourse is “turf”, the aptitude parameter of “turf” is used, from among the aptitude parameters of the track aptitude, and when the racecourse is “dirt”, the aptitude parameter of “dirt” is used, from among the aptitude parameters of the track aptitude.

When the distance of the race is “short distance”, the aptitude parameter of “short distance” is used, from among the aptitude parameters of the distance aptitude. Similarly, when the distance of the race is “mile”, “medium distance”, and “long distance”, the aptitude parameters of “mile”, “medium distance”, and “long distance” are used, respectively, from among the aptitude parameters of the distance aptitude.

In a predetermined phase, an expression by which the correction coefficient is multiplied is included in the arithmetic expression for calculating the speed. At this time, if the turf aptitude is “S”, 105% is applied as the correction coefficient, and if the track aptitude is “A”, 100% is applied as the correction coefficient. Further, if the track aptitude is “G”, 10% is applied as the correction coefficient. According to this arithmetic expression, the aptitude parameter is used as a parameter for calculating the speed.

In addition, for example, the aptitude parameters may be used for correction of the ability parameters. For example, take a case in which the ability parameter is corrected by the aptitude parameter before the calculation for each phase is performed. In this case, for example, if the aptitude parameter is “S”, the predetermined ability parameter is multiplied by 1.10, and if the aptitude parameter is “G”, the predetermined ability parameter is multiplied by 0.7. Then, the ability parameters after being corrected by the aptitude parameters are input to the arithmetic expression, and the simulation is executed. In this manner, the aptitude parameter may be used as a parameter for correcting the ability parameter.

As described above, the turf aptitude, the dirt aptitude, and the distance aptitude are provided for the nurture target character. The distance aptitude is set for each of short distance, mile, medium distance, and long distance. In the simulation, the result of the race is derived based on the ability parameters and the aptitude parameters set as parameters used for deriving the result of the race from among the plurality of aptitude parameters associated with the nurture target character.

The nurture game execution unit 1101a stores the race result by the simulation executed in S21-6 (S21-7). Then, when the executed race is a goal race (YES in S21-8), the nurture game execution unit 1101a determines whether the goal has been achieved (S21-9). Here, as the goal, for example, the nurture target character winning with a predetermined placing or higher is set.

When the goal is achieved (YES in S21-9), the nurture game execution unit 1101a executes goal achievement processing (S21-10). Here, for example, in a case where achieving a predetermined goal is set as the acquisition condition of the overseas aptitude, a predetermined event is generated at the time of the turn end, and processing of acquiring the overseas aptitude is executed. In addition, for example, in a case where a predetermined goal achievement reward is given by the achievement of a goal, the goal achievement reward is given. Further, the nurture game execution unit 1101a executes reward giving processing of giving a reward to the player (S21-11). Here, a reward is determined based on the result of the simulation, that is, the placing, the race development, and the like of the nurture target character, and the determined reward is given.

On the other hand, when the goal is not achieved (NO in S21-9), the nurture game execution unit 1101a executes end processing to end the nurture main game (S21-12).

Referring back to FIG. 50, when a selection command indicating an operation input of the SS match operation portion 221f is received (YES in S20-8), the nurture game execution unit 1101a executes win/lose determination processing (S20-9). Here, a lottery for determining whether the nurture target character wins or loses is executed based on the winning probability determined in S12-3 or S12-10. In a case where there are a plurality of opponents, winning or losing is determined for each opponent.

Next, the nurture game execution unit 1101a updates various parameters based on the result of S20-9 (S20-10). Specifically, the nurture game execution unit 1101a updates the aptitude points, the ability parameters, and the supporter points of the nurture target character based on whether the nurture target character wins or loses. Further, here, the nurture game execution unit 1101a updates the ability parameter of the nurture target character based on the bonus training of the team member. That is, here, a basic reward is given. The nurture game execution unit 1101a updates the evaluation score of the nurture target character in conjunction with the update of the ability parameters.

Here, the nurture game execution unit 1101a resets the SS parameter of the opponent team member and increases the SS level by “1”. Here, the number of wins and the number of executions of the SS match are updated. The nurture game execution unit 1101a may update the ability parameters and the evaluation score of the team members who are the opponents based on the win/lose result. However, the energy of the nurture target character is not updated here.

Next, the nurture game execution unit 1101a gives a winning reward to be given when the nurture target character wins (S20-11). Here, when the nurture target character wins against the opponent, the ability parameters and the evaluation score are increased as the winning reward. Thus, when the nurture target character wins, the increase value of the ability parameter is larger than when the nurture target character loses. Thus, when the nurture target character wins against an opponent, the evaluation score is increased more than when the nurture target character loses.

As described above, the winning reward includes an additional reward. Here, the additional reward set for the opponent against which the nurture target character has won is given. When the additional reward is given, the nurture game execution unit 1101a executes reward update processing of deleting the additional reward given to the nurture target character from the additional rewards associated with the team member (S20-12). Here, when the additional rewards of the team members are updated and result in two remaining, the nurture game execution unit 1101a determines the giving order of three new additional rewards through a lottery.

The nurture game execution unit 1101a, when receiving a selection command indicating that any training other than SS match is to be performed (NO in S20-8), executes success determination processing (S20-13). Here, the success or failure of the training is determined based on the failure probability calculated in S10-9. Then, the nurture game execution unit 1101a updates various parameters of the nurture target character based on the determination result of S20-13 (S20-14). Here, the ability parameters and the like are updated as determined in S10-8 upon the start of the turn.

Here, the energy of the nurture target character is updated in conjunction with the execution of the training. The evaluation score of the nurture target character is updated in conjunction with the update of the ability parameters. Then, the nurture game execution unit 1101a updates various parameters of the arranged characters (S20-15). Here, the nurture game execution unit 1101a updates the bond parameter, the SS parameter, the supporter points, and the like of the arranged character.

When the processing of S20-12 or S20-15 is executed, the nurture game execution unit 1101a executes overseas aptitude acquisition determination processing (S20-16). Here, it is determined whether the acquisition condition of the overseas aptitude is satisfied by executing the SS match or executing training other than the SS match. When the acquisition condition of the overseas aptitude is satisfied, a predetermined event is generated at the end of the turn, and processing for acquiring the overseas aptitude is executed.

Then, the nurture game execution unit 1101a sets the result information indicating the result of each processing described above and causes the player terminal 1 to receive it (S20-17).

Referring back to FIG. 48, when the player terminal 1 receives the result information from the server 1000 (YES in P7-9), the nurture game execution unit 701a executes result information reception processing (P20).

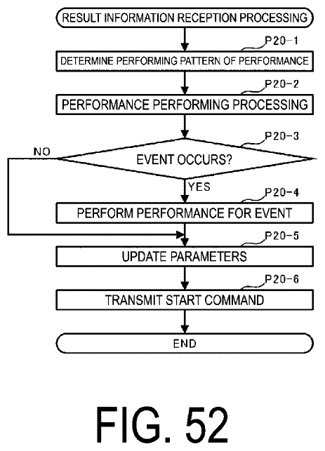

FIG. 52 is a flowchart for describing the result information reception processing in the player terminal 1. The nurture game execution unit 701a determines a performing pattern of the performance based on the received result information (P20-1). Then, the nurture game execution unit 701a performs the performance in the performing pattern determined in P20-1 (P20-2). Here, for example, different performances are executed depending on whether the goal is achieved or not. Here, for example, different performances are executed depending on whether the nurture target character wins or loses in the SS match.

When the second event occurs or an event in a case where the overseas aptitude acquisition condition is satisfied occurs (YES in P20-3), the nurture game execution unit 701a executes a performance for the occurring event (P20-4). Also, the nurture game execution unit 701a updates the parameters, based on the received result information (P20-5). Here, when the overseas aptitude acquisition condition is satisfied and the event is executed, the acquisition information on the overseas aptitude is updated.

When all the performances to be executed in the current turn are finished, the nurture game execution unit 701a transmits a start command to the server 1000 (P20-6). As a result, the current turn is finished in the player terminal 1. Then, when the server 1000 receives the start command, the processing related to the next turn is executed by the same processing as described above.

Although a detailed description is omitted, when the interleague representative race is executed after the turn is finished, the nurture game execution unit 701a may transmit a predetermined command to the server 1000 instead of the start command. In this case, the server 1000 derives the race result of the interleague representative race in the same manner as the race execution processing illustrated in FIG. 51. When the player terminal 1 receives the race result, processing such as reproduction of a race video related to the interleague representative race is executed. Then, after the processing related to the interleague representative race is completed, a start command may be transmitted to the server 1000.

Referring back to FIG. 41, in the server 1000, when the nurture stage processing (S7) ends, the nurture game end processing unit 1102a executes nurture game end processing (S8).

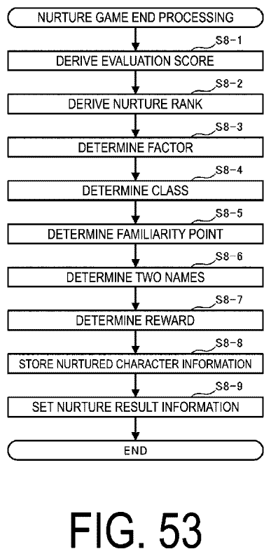

FIG. 53 is a flowchart for describing the nurture game end processing in the server 1000. The nurture game end processing unit 1102a derives the evaluation score based on various parameters for the nurture target character (S8-1). The nurture game end processing unit 1102a derives the nurture rank based on the derived evaluation score (S8-2).

In addition, the nurture game end processing unit 1102a determines the factor to be obtained by the nurtured character (S8-3). The nurture game end processing unit 1102a determines the class based on the number of obtained fans (S8-4). The nurture game end processing unit 1102a determines a familiarity point based on a predetermined parameter such as the nurture rank or the number of fans (S8-5). Note that the familiarity point is a point given not to the nurtured character but to a character that is a source of the nurtured character although a detailed description is omitted.

A plurality of story screens are provided for each character, and an unlock condition is set for some of the story screens. Some story screens have the familiarity point set as the unlock condition, and the player can watch the story screen when the familiarity point is equal to or greater than a threshold value.

The nurture game end processing unit 1102a determines two names (S8-6). Here, the condition achieved in the nurture main game is confirmed, and two names to be obtained by the nurtured character are determined. Further, the nurture game end processing unit 1102a determines a reward to be given to the player (S8-7). The nurture game end processing unit 1102a stores, in the game information storage unit 1151, the nurtured character information including the evaluation score, the nurture rank, the ability parameter, the aptitude parameter, the acquired skill, the inheritance information, the factor information, the class, the two names, and the like in association with the player ID of the player (S8-8). The nurture game end processing unit 1102a sets nurture result information and causes the player terminal 1 to receive the nurture result information (S8-9).

Referring back to FIG. 41, when the player terminal 1 receives the nurture result information, the nurture completion processing unit 702a executes the nurture game end processing (P8). Here, the nurture completion processing unit 702a stores the received nurture result information in the game information storage unit 751. The nurture completion processing unit 702a displays the nurture completion screen 360 (see FIGS. 38A, 38B, and 38C) on the display 26 based on the nurture result information.

The above-described nurture game is achieved in the above-described processing. In addition, the nurtured character information relating to the nurtured character nurtured (created) in the nurture game is stored in association with the player ID. The above-described processing in the player terminal 1 and the server 1000 is merely an example. Further, each of the processing operations described above may be executed only by the player terminal 1 or only by the server 1000.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it is to be understood that such modifications and corrections also obviously fall within the technical scope of the present disclosure.

For example, in the above embodiment, the team member whose Ss parameter has reached the upper limit is associated with the training item “SS match”. However, the association of the team member with the “SS match” is not essential. For example, when there is a team member whose SS parameter has reached a predetermined value, “SS match” may be enabled. In this case, the team member may be arranged in another training item.

In the above embodiment, the “SS match” is content corresponding to a match between the nurture target character and the team member, but the content of the “SS match” is not particularly limited. For example, when no team member is associated with the “SS match”, a predetermined event may occur at random by the execution of the “SS match”.

As described above, the contents of the nurture game described in the above embodiment are merely examples. In any case, the information processing program causes a computer to execute the following processing.

### Processing Executed by Computer

Processing of associating an assist character (in the embodiment, as an example, a team member) with a first command (in the embodiment, as an example, a training command of speed, stamina, power, spirit, and wisdom) among a plurality of types of commands for designating an action of a nurture target character (in the embodiment, as an example, S10-6).

Processing of receiving an operation by a player for selecting a command from among the plurality of types of commands including at least the first command (in the embodiment, as an example, P7-2), and acquiring information corresponding to the command selected by the player (in the embodiment, as an example, S7-6).

Processing of updating a first nurture parameter (in the embodiment, as an example, an evaluation score) associated with the nurture target character (in the embodiment, as an example, S20-14) in a case where information corresponding to the first command is acquired.

Processing of updating a first assist parameter (in the embodiment, as an example, an SS parameter) associated with the assist character according to a predetermined update condition (in the embodiment, as an example, success in the arranged training) (in the embodiment, as an example, S20-15).

Processing of determining whether or not the first assist parameter has reached a predetermined value (in the embodiment, as an example, S11-2).

Processing of enabling a second command (in the embodiment, as an example, an SS match) from among the plurality of types of commands in a case where the assist character with the first assist parameter that has reached a predetermined value exists (in the embodiment, as an example, P7-2).

Processing of updating the first nurture parameter in a case where the enabled second command is selected (in the embodiment, as an example, S20-10).

Further, processing of associating the assist character with the first assist parameter that has reached a predetermined value (in the embodiment, as an example, level “3”) with the second command may be executed (in the embodiment, as an example, S11-5).

Also, processing of updating the first nurture parameter in a case where information corresponding to the second command is acquired may include updating the first nurture parameter based on the first nurture parameter and a second assist parameter associated with the assist character (in the embodiment, as an example, the team member evaluation score and the bonus training).

The second command may be a command for designating a match between the nurture target character and the assist character associated with the second command.

Further, a processing of determining a winning probability of the nurture target character to win based on the first nurture parameter and the second assist parameter may be executed (in the embodiment, as an example, S12-3).

Further, when the second command is selected, a processing of determining whether the nurture target character wins or loses based on the winning probability may be executed (in the embodiment, as an example, S20-9).

In addition, processing of updating the first nurture parameter in a case where the second command is selected may include updating the first nurture parameter based on whether the nurture target character wins or loses.

Also, processing of updating the first nurture parameter in a case where information corresponding to the second command is acquired may include updating the first nurture parameter based on a second nurture parameter associated with the nurture target character (in the embodiment, as an example, energy).

Further, processing of determining a winning probability for the nurture target character to win based on the second nurture parameter may be executed.

A reward may be associated with the assist character.

Processing of giving the reward to the nurture target character in a case where the nurture target character wins against the assist character may be executed (in the embodiment, as an example, S20-11).

Further, a plurality of the assist characters with the first assist parameter that has reached the predetermined value may be associated with the second command.

In addition, processing of determining whether or not a special state (in the embodiment, as an example, an SSS match) occurs in a case where one or more of a predetermined number of the assist characters are associated with the second command may be executed (in the embodiment, as an example, S12-6).

Also, at least one of the winning probability, an update value of the first nurture parameter, or the reward may become more advantageous in a case where the special state has occurred compared to when the special state has not occurred.

Further, a processing of performing a success determination of the action of the nurture target character corresponding to the first command selected by a player may be executed (in the embodiment, as an example, S20-13). The first nurture parameter may be updated based on a result of the success determination.

Note that some of the functions of the nurture game described in the above embodiment may not be provided. Further, a part or all of the processing in the player terminal 1 described above may be executed in the server 1000. Similarly, a part or all of the processing in the server 1000 described above may be executed in the player terminal 1. Therefore, communication between the player terminal 1 and the server 1000 is not essential, and, for example, all the programs for executing the game may be stored in the player terminal 1 or the game apparatus G.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method of implementing each function and the steps illustrated in the flowcharts.

What is claimed is:

1. A non-transitory computer readable medium storing a program that causes a computer to execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

2. The non-transitory computer readable medium according to claim 1, wherein the program further causes a computer to execute:
processing of associating the assist character with the first assist parameter that has reached a predetermined value with the second command, wherein
the processing of updating the first nurture parameter in a case where information corresponding to the second command is acquired includes updating the first nurture parameter based on the first nurture parameter and a second assist parameter associated with the assist character.

3. The non-transitory computer readable medium according to claim 2, wherein
the second command is a command for designating a match between the nurture target character and the assist character associated with the second command,
the program further causes a computer to execute:
processing of determining a winning probability for the nurture target character to win based on the first nurture parameter and the second assist parameter, and
processing of determining whether the nurture target character wins or loses based on the winning probability in a case where information corresponding to the second command is acquired, and
the processing of updating the first nurture parameter in a case where information corresponding to the second command is acquired includes updating the first nurture parameter based on whether the nurture target character wins or loses.

4. The non-transitory computer readable medium according to claim 1, wherein the program further causes a computer to execute:
processing of associating the assist character with the first assist parameter that has reached a predetermined value with the second command, wherein
the processing of updating the first nurture parameter in a case where information corresponding to the second command is acquired includes updating the first nurture parameter based on a second nurture parameter associated with the nurture target character.

5. The non-transitory computer readable medium according to claim 4, wherein
the second command is a command for designating a match between the nurture target character and the assist character associated with the second command,
the program further causes a computer to execute:
processing of determining a winning probability for the nurture target character to win based on the second nurture parameter, and
processing of determining whether the nurture target character wins or loses based on the winning probability in a case where information corresponding to the second command is acquired, and
the processing of updating the first nurture parameter in a case where information corresponding to the second command is acquired includes updating the first nurture parameter based on whether the nurture target character wins or loses.

6. The non-transitory computer readable medium according to claim 3, wherein
the assist character is associated with a reward, and
the program further causes a computer to execute:
processing of giving the reward to the nurture target character in a case where the nurture target character wins against the assist character.

7. The non-transitory computer readable medium according to claim 5, wherein
the assist character is associated with a reward, and
the program further causes a computer to execute:
processing of giving the reward to the nurture target character in a case where the nurture target character wins against the assist character.

8. The non-transitory computer readable medium according to claim 6, wherein
the processing of associating the assist character to the second command includes enabling a plurality of the assist characters with the first assist parameter that has reached the predetermined value to be associated with the second command,
the program further causes a computer to execute:
processing of determining whether or not a special state occurs in a case where one or more of a predetermined number of the assist characters are associated with the second command, and
at least one of the winning probability or the reward becomes more advantageous in a case where the special state has occurred, compared to when the special state has not occurred.

9. The non-transitory computer readable medium according to claim 7, wherein
the processing of associating the assist character to the second command includes enabling a plurality of the assist characters with the first assist parameter that has reached the predetermined value to be associated with the second command,
the program further causes a computer to execute:
processing of determining whether or not a special state occurs in a case where one or more of a predetermined number of the assist characters are associated with the second command, and
at least one of the winning probability or the reward becomes more advantageous in a case where the special state has occurred, compared to when the special state has not occurred.

10. The non-transitory computer readable medium according to claim 2, wherein
the processing of associating the assist character to the second command includes enabling a plurality of the assist characters with the first assist parameter that has reached the predetermined value to be associated with the second command,
the program further causes a computer to execute:
processing of determining whether or not a special state occurs in a case where one or more of a predetermined number of the assist characters are associated with the second command, and
an update value of the first nurture parameter becomes more advantageous in a case where the special state has occurred, compared to when the special state has not occurred.

11. The non-transitory computer readable medium according to claim 4, wherein
the processing of associating the assist character to the second command includes enabling a plurality of the assist characters with the first assist parameter that has reached the predetermined value to be associated with the second command,
the program further causes a computer to execute:
processing of determining whether or not a special state occurs in a case where one or more of a predetermined number of the assist characters are associated with the second command, and
an update value of the first nurture parameter becomes more advantageous in a case where the special state has occurred, compared to when the special state has not occurred.

12. The non-transitory computer readable medium according to claim 1, wherein the program further causes a computer to execute:
processing of performing a success determination of the action of the nurture target character corresponding to the first command selected by a player, wherein
the processing of updating the first nurture parameter in a case where information corresponding to the first command is acquired includes updating the first nurture parameter based on a result of the success determination.

13. An information processing method executed by one or more computers, comprising:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

14. An information processing system, comprising:
one or more computers, wherein the one or more computers execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.

15. A game apparatus comprising:
one or more computers, wherein the one or more computers execute:
processing of associating an assist character with a first command from among a plurality of types of commands for designating an action of a nurture target character;
processing of receiving an operation by a player for selecting a command from among the plurality of types of commands including at least the first command and acquiring information corresponding to the command selected by a player;
processing of updating a first nurture parameter associated with the nurture target character in a case where information corresponding to the first command is acquired;
processing of updating a first assist parameter associated with the assist character according to a predetermined update condition;
processing of determining whether or not the first assist parameter has reached a predetermined value;
processing of enabling a second command from among a plurality of types of commands in a case where the assist character with the first assist parameter that has reached a predetermined value exists; and
processing of updating the first nurture parameter in a case where information corresponding to the enabled second command is acquired.
